(19) United States
(12) Patent Application Publication
(10) Pub. No.: US 2025/0096880 A1
(43) Pub. Date: Mar. 20, 2025

(54) BEAM MEASUREMENT AND REPORTING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/827,410

(22) Filed: Sep. 6, 2024

Related U.S. Application Data
(60) Provisional application No. 63/539,499, filed on Sep. 20, 2023.
(60) Provisional application No. 63/554,763, filed on Feb. 16, 2024.

(51) Int. Cl. H04B 7/06; H04L 5/00; H04W 24/10; H04W 72/044

(52) U.S. Cl. CPC H04B 7/06966; H04L 5/0051; H04L 5/0053; H04W 24/10; H04W 72/046

(57) ABSTRACT

Methods and apparatuses for beam measurement and reporting. A method performed by a user equipment (UE) is provided. The method includes receiving first information related to inclusion in a report of at least one first report quantity associated with a first reference signal (RS) resource and receiving second information related to at least one second RS resource. The method further includes determining, based on the first RS resource, the at least one first report quantity and determining, based on the at least one second RS resource, at least one second report quantity. The method further includes determining, based on (i) the first information and (ii) the at least one second report quantity, the report and transmitting the report.

### CROSS-REFERENCE TO RELATED AND CLAIM OF PRIORITY

The present application claims priority under 35 U.S.C. § 119 (e) to U.S. Provisional Patent Application No. 63/539,499 filed on Sep. 20, 2023, and U.S. Provisional Patent Application No. 63/554,763 filed on Feb. 16, 2024, which are hereby incorporated by reference in their entirety.

### TECHNICAL FIELD

The present disclosure relates generally to wireless communication systems and, more specifically, the present disclosure relates to methods and apparatuses for beam measurement and reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam measurement and reporting.

In one embodiment, a user equipment (UE) is provided. The UE includes a transceiver configured to receive first information related to inclusion in a report of at least one first report quantity associated with a first reference signal (RS) resource and receive second information related to at least one second RS resource. The UE further includes a processor operably coupled with the transceiver. The processor is configured to determine, based on the first RS resource, the at least one first report quantity; determine, based on the at least one second RS resource, at least one second report quantity; and determine, based on (i) the first information and (ii) the at least one second report quantity, the report. The transceiver is further configured to transmit the report.

In another embodiment, a base station (BS) is provided. The BS includes a processor and a transceiver operably coupled with the processor. The transceiver is configured to transmit first information related to inclusion in a report of at least one first report quantity associated with a first RS resource, and transmit second information related to at least one second RS resource, and receive the report that is based on (i) the first information and (ii) at least one second report quantity associated with the at least one second RS resource.

In yet another embodiment, a method performed by a UE is provided. The method includes receiving first information related to inclusion in a report of at least one first report quantity associated with a first RS resource and receiving second information related to at least one second RS resource. The method further includes determining, based on the first RS resource, the at least one first report quantity and determining, based on the at least one second RS resource, at least one second report quantity. The method further includes determining, based on (i) the first information and (ii) the at least one second report quantity, the report and transmitting the report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example of using reported resource indicator(s) to trigger/initiate a beam/transmission configuration indication (TCI) state switching/change according to embodiments of the present disclosure;

FIG. 8 illustrates an example of using reported resource indicator(s) to trigger/initiate beam(s)/TCI state(s) activation/sub-selection and beam/TCI state switching/change according to embodiments of the present disclosure;

FIG. 9 illustrates an example of using reported resource indicator(s) to trigger/initiate beam(s)/TCI state(s) activation/sub-selection according to embodiments of the present disclosure;

FIG. 10 illustrates a diagram of an example two-part channel state information (CSI)/beam report for indicating/providing first and second resource indicators according to embodiments of the present disclosure; and

FIG. 11 illustrates an example method performed by a UE in a wireless communication system according to embodiments of the present disclosure.

### DETAILED DESCRIPTION

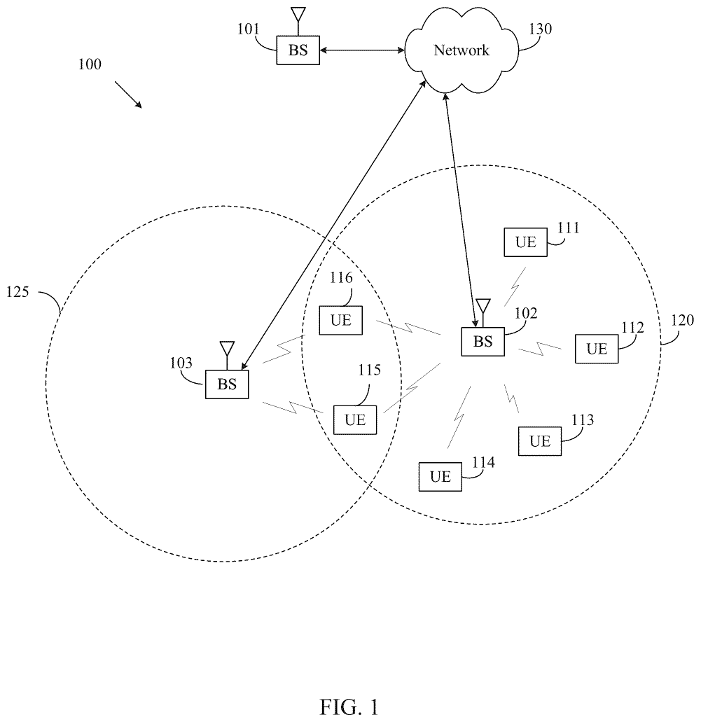

FIGS. 1-11, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3] 3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for beam measurement and reporting. In certain embodiments, one or more of the BSs 101-103 include circuitry, programing, or a combination thereof to support beam measurement and reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

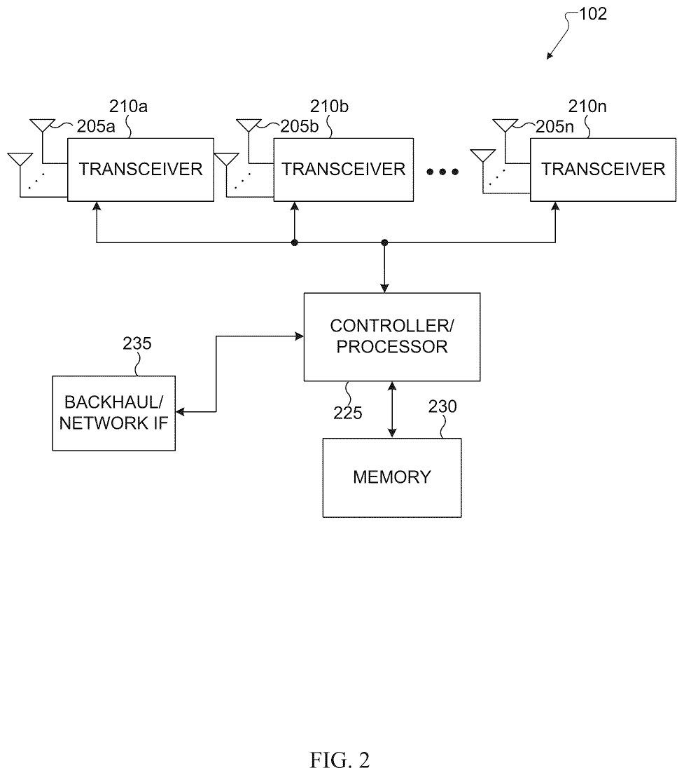

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting beam measurement and reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

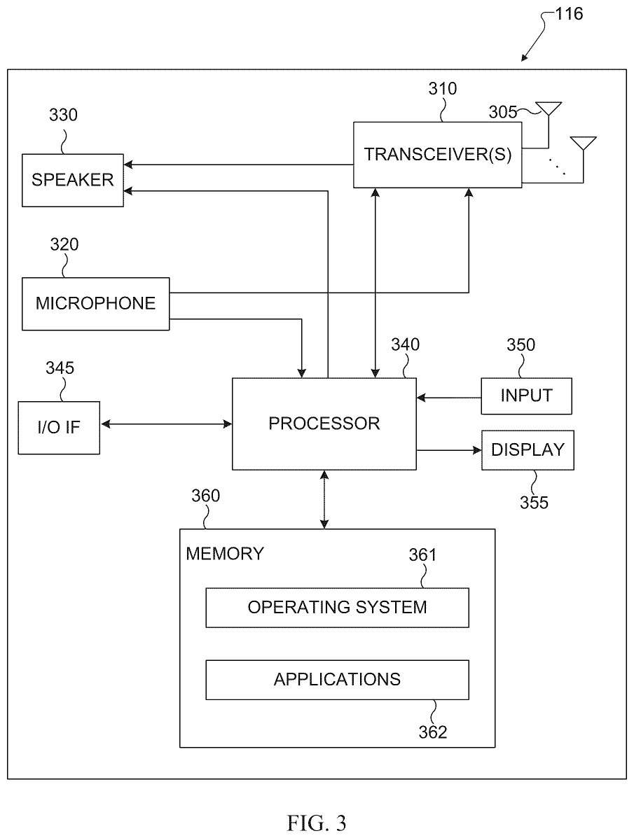

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform beam measurement and reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

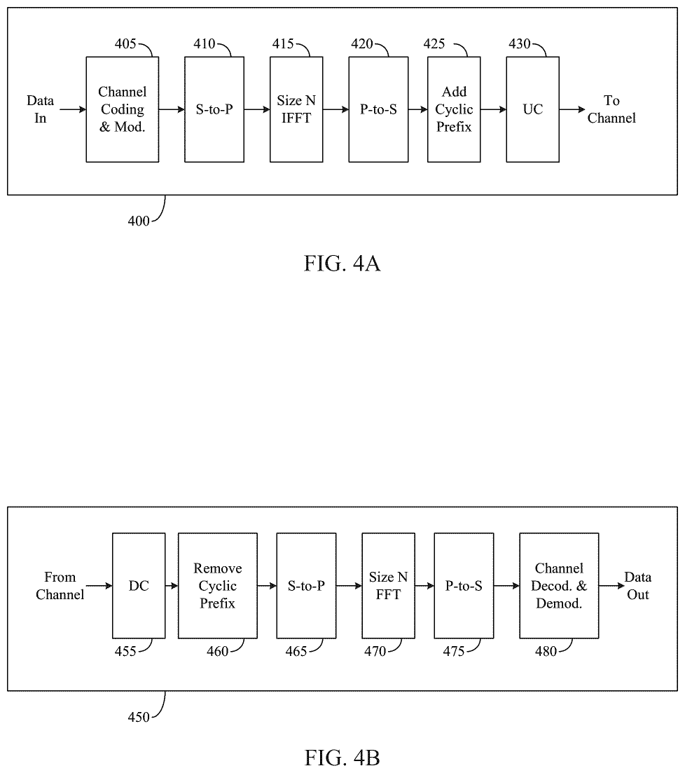

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support beam measurement and reporting as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

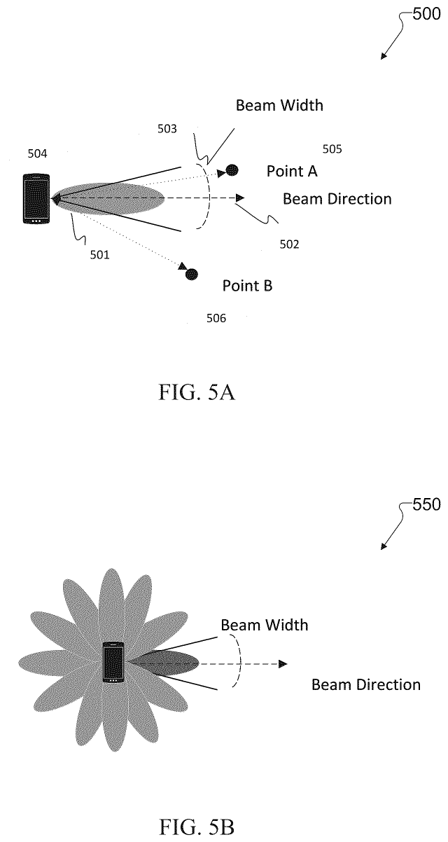

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

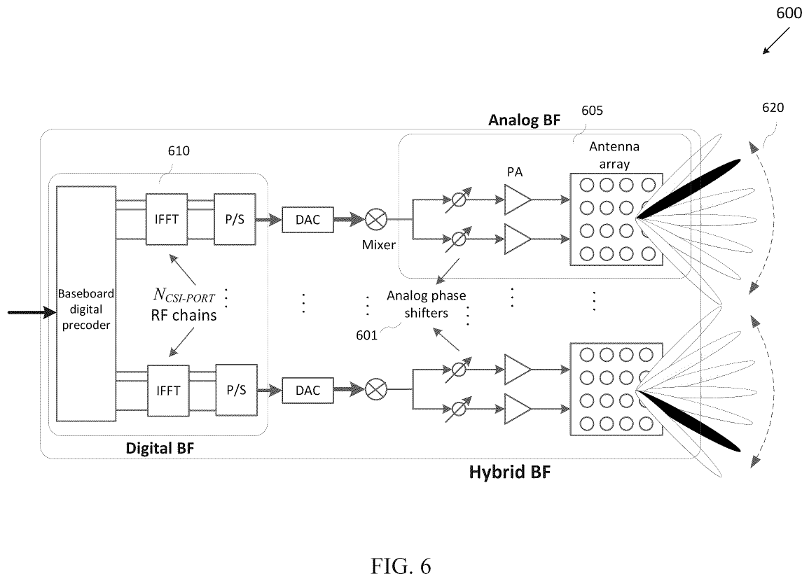

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication reference signal (CSI-RS) antenna ports which enable an eNB or a gNB to be equipped with a large number of antenna elements (such as 64 or 128). A plurality of antenna elements can then be mapped onto one CSI-RS port. For mm Wave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of;
A TCI state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Therefore, embodiments of the present disclosure recognize that there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate). This disclosure provides example embodiments on the mentioned UE-initiated beam management herein including CSI/beam reporting and beam switching and beam activation/sub-selection. Furthermore, this disclosure also provides various design options and resource allocation strategies for sending the beam/CSI report(s) under the UE-initiated and/or event-based beam management framework.

The present disclosure provides various novel and detailed design examples on the UE-initiated beam management framework including UE-initiated/triggered beam/CSI reporting and/or UE-initiated/triggered beam switching and/or UE-initiated/triggered beam activation/deactivation/sub-selection. This disclosure also covers various design aspects including signaling support, UL signaling contents, etc., related to the UE-initiated/triggered and/or event-based/driven beam operation, in particular, under unified TCI framework. To better support/enable the UE-initiated and the event-based beam operations, this disclosure presents detailed uplink resource allocation and/or content(s) designs for sending the CSI/beam report(s).

In the present disclosure, a UE detects (or determines) a need for transmitting a UE-initiated/UE-triggered report (or initiation/triggering) of a (report-) type (A), (B), or (C), where
(A) includes an initiator/trigger/pre-notification (PN) message
(B) includes a report/content (comprising one or multiple report quantities)
(C) includes both a trigger/pre-notification (PN) message and a (corresponding) report/content

The report is to facilitate/enable efficient/timely/fast/reliable communication over the link/channel between a target entity (e.g. NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ, Jᵢ)}, where Iᵢ is an beam (source RS) indicator (e.g. channel quality indicator report interval (CRI), SSB resource indicator (SSBRI)) and Jᵢ is a beam metric (e.g. layer 1 reference signal received powers (L1-RSRP), layer 1 Signal-to-Interference-plus-Noise Ratios (L1-SINR).
In one example, the content includes CSI-related quantity/quantities. For example, at least one of (rank indicator (RI), precoding matrix indicator (PMI), channel quality indicator (CQI), CQI report interval (CRI), layer index (LI)).
In one example, the content includes time-domain channel property (TDCP)-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-) correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception or/and UL transmission), or antenna (e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (examples herein) and at least one other quantity/quantities (examples herein).
In one example, the content includes CSI-related quantity/quantities (examples herein) and at least one other quantity/quantities (examples herein).
In one example, the content includes TDCP-related quantity/quantities (examples herein) and at least one other quantity/quantities (examples herein).
In one example, the content includes beam-related quantity/quantities (examples herein) and CSI-related quantity/quantities (examples herein).
In one example, the content includes beam-related quantity/quantities (examples herein) and TDCP-related quantity/quantities (examples herein).
In one example, the content includes TDCP-related quantity/quantities (examples herein) and CSI-related quantity/quantities (examples herein).

In one example, the report is targeting a physical layer (L1) communication (e.g. L1 DL/UL, or L1 SL), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 (direct communication) interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-) type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| Event type | Type | Trigger/pre-notification message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/ | (A) | Yes (e.g. non-CSI-related event) | No |
| beam/TDCP | (B) | No | Yes |
| | (C) | Yes (e.g. non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), content-specific or | No |
| | event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one embodiment, a UE (e.g., the UE 116) could send to the network one or more indicators to indicate, initiate or trigger update(s)/change(s) of one or more beams and/or transmission configuration indication (TCI) states (and therefore, quasi-co-location (QCL) settings including QCL source RS(s) and the corresponding QCL type(s) provided/configured therein) and/or spatial relation settings for receiving/transmitting one or more DL/UL channels and/or signals. Throughout this disclosure, a TCI state can also be referred to as a beam or a spatial relation setting; i.e., they can be used/applied to various design examples throughout the present disclosure interchangeably; for instance, a spatial relation or spatial relation setting for determining an UL Tx spatial filter can be with a reference to an RS in the indicated TCI state. Furthermore, throughout the present disclosure, “trigger” can also be referred to as “initiate” or “indicate”; i.e., they can be used/applied to various design examples throughout the present disclosure interchangeably. For instance, the UE could send to the network (e.g., the network 130) an indicator to trigger a TCI state change/update/switch for one or more channels or signals. The indicator could comprise/include/contain or correspond to one or more of:
An identity (ID) of the TCI state.
An index/ID of a higher layer RRC configured list/set/pool of TCI states that comprises/indicates/provides the TCI state.
An index of the TCI state in a list/set/pool of TCI states higher layer RRC configured to the UE.
An index of the TCI state in a set of TCI states activated by a (unified) TCI state(s) activation/deactivation medium access control (MAC) control element (CE)
An index/ID of a set of TCI states—e.g., among sets of TCI states activated/provided by a (unified) TCI state(s) activation/deactivation MAC CE—that comprises/indicates/provides the TCI state
An index of the TCI state among TCI states mapped to a TCI codepoint activated/provided by a (unified) TCI state(s) activation/deactivation MAC CE
A TCI codepoint activated/provided by a (unified) TCI state(s) activation/deactivation MAC CE that comprises/indicates/provides the TCI state
An index/ID of a TCI codepoint—e.g., among TCI codepoints activated/provided by a (unified) TCI state(s) activation/deactivation MAC CE—that comprises/indicates/provides the TCI state.
An index of the TCI state among TCI states indicated by a TCI codepoint of a TCI field in a beam indication DCI (e.g., DCI format 1_1/1_2 with or without DL assignment)
An index/ID of information related to a (unified) TCI state(s) activation/deactivation MAC CE that activates the TCI state or a TCI codepoint that comprises/indicates/provides the TCI state; the information could include/comprise/contain/indicate when (e.g., reception time in form of slot/slot index/etc.) the (unified) TCI state(s) activation/deactivation MAC CE was received
An index/ID of information related to a beam indication DCI that provides/indicates the TCI state or a TCI codepoint that comprises/indicates/provides the TCI state; the information could include/comprise/contain/indicate when (e.g., reception time in form of slot/slot index/etc.) the beam indication DCI was received
An index/ID of a CORESET or a coresetPoolIndex/coresetGroupIndex associated to a CORESET, in which a beam indication DCI that provides/indicates the TCI state or a TCI codepoint that comprises/indicates/provides the TCI state was received
RS index(es)/ID(s) such as SSB index(es)/ID(s) and/or CSI-RS resource index(es)/ID(s) provided/indicated in the TCI state along with the corresponding QCL-type(s)
Resource indicator(s) such as SSBRI(s) and/or CRI(s) reported in one or more CSI/beam reports
Beam metric(s) such as L1-RSRP(s) and/or L1-SINR(s) reported in one or more CSI/beam reports
Index(es)/ordering(s) of resource indicator(s) such as SSBRI(s) and/or CRI(s) among resource indicators such as SSBRIs and/or CRIs reported in one or more CSI/beam reports
Index(es)/ordering(s) of resource indicator(s) such as SSBRI(s) and/or CRI(s) among resource indicators such as SSBRIS and/or CRIs reported for TCI state(s)/beam(s) activation/deactivation/sub-selection as specified herein in the present disclosure in one or more CSI/beam reports
Index(es)/ordering(s) of resource indicator(s) such as SSBRI(s) and/or CRI(s) among candidate resource indicators such as SSBRIs and/or CRIs—as specified herein in the present disclosure-reported in one or more CSI/beam reports
Index(es)/ordering(s) of beam metric(s) such as L1-RSRP(s) and/or L1-SINR(s) among beam metrics such as L1-RSRPs and/or L1-SINRs reported in one or more beam/CSI reports
Index(es)/ordering(s) of beam metric(s) such as L1-RSRP(s) and/or L1-SINR(s) among beam metrics such as L1-RSRPs and/or L1-SINRs corresponding to resource indicators such as SSBRIs and/or CRIs reported for TCI state(s)/beam(s) activation/deactivation/sub-selection as specified herein in the present disclosure in one or more CSI/beam reports
Index(es)/ordering(s) of beam metric(s) such as L1-RSRP(s) and/or L1-SINR(s) among beam metrics such as L1-RSRPs and/or L1-SINRs corresponding to candidate resource indicators such as SSBRIs and/or CRIs—as specified herein in the present disclosure-reported in one or more CSI/beam reports
Group(s)/pair(s) of resource indicators such as SSBRIs and/or CRIs reported in one or more CSI/beam reports
Index(es)/ordering(s) of group(s)/pair(s) of resource indicators among groups/pairs of resource indicators such as SSBRIs and/or CRIs reported in one or more CSI/beam reports
Index(es)/ordering(s) of group(s)/pair(s) of resource indicators among groups/pairs of resource indicators such as SSBRIs and/or CRIs reported for TCI state(s)/beam(s) activation/deactivation/sub-selection as specified herein in the present disclosure in one or more CSI/beam reports
Index(es)/ordering(s) of group(s)/pair(s) of resource indicators among groups/pairs of candidate resource indicators such as SSBRIs and/or CRIs—as specified herein in the present disclosure-reported in one or more CSI/beam reports
Group(s)/pair(s) of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of resource indicators such as SSBRIs and/or CRIs reported for TCI state(s)/beam(s) activation/deactivation/sub-selection as specified herein in the present disclosure in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of candidate resource indicators such as SSBRIs and/or CRIs—as specified herein in the present disclosure-reported in one or more CSI/beam reports
A bitmap with each bit position of the bitmap corresponding to a candidate TCI state/TCI state ID/TCI state index/RS index or ID/resource indicator/etc. according to those specified herein in the present disclosure; for this case, when/if a bit position of the bitmap is set to ‘1’ (or ‘0’), the TCI state/TCI state ID/TCI state index/RS index or ID/resource indicator/etc. corresponding to the bit position could be for the UE-initiated beam(s)/TCI state(s) switching/update/change as specified herein in the present disclosure.

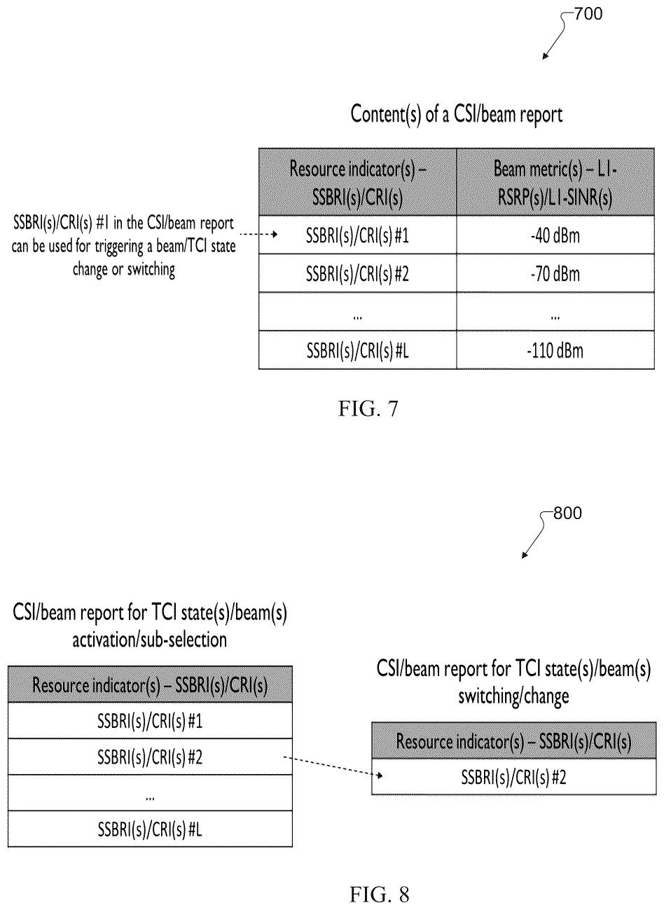

FIG. 7 illustrates an example of using reported resource indicator(s) 700 to trigger/initiate a beam/transmission configuration indication (TCI) state switching/change according to embodiments of the present disclosure. For example, using the reported resource indicator(s) 700 to trigger/initiate a beam/TCI state switching/change can be utilized by any of the UEs 111-116 of FIG. 1, such as the UE 111. This example is for illustration only and other embodiments can be used without departing from the scope of the present disclosure.

Throughout the present disclosure, an index could correspond to the “first”, the “second”, etc. With reference to FIG. 7, a conceptual example depicting the use of a resource indicator reported in a CSI/beam report to trigger/initiate a beam/TCI state switch/change is provided. As illustrated in FIG. 7, as the beam metric (e.g., L1-RSRP or L1-SINR) associated/corresponding to the resource indicator SSBRI/CRI #1 is the highest, the SSBRI/CRI #1 reported in the CSI/beam report could be used for triggering or initiating a beam/TCI state change/switching. That is:
When/if applicable, the UE could set their (spatial domain) receive filter(s) according to at least the RS corresponding to the reported resource indicator(s) such as SSBRI(s)/CRI(s) for TCI state(s)/beam(s) change/switching (SSBRI/CRI #1 in this case) to receive one or more DL channels/signals.
When/if applicable, the UE could determine their (spatial domain) transmit filter(s) or UL TX (spatial) filter(s), from/according to at least the RS corresponding to the reported resource indicator(s) such as SSBRI(s)/CRI(s) for TCI state(s)/beam(s) change/switching (SSBRI/CRI #1 in this case), to transmit one or more UL channels/signals.

Furthermore, as described herein in the present disclosure, the indicator could be for one or more DL/UL channels and/or signals. Specifically, for transmitting/receiving DL/UL channel(s):
In one example, the indicator could trigger a TCI state change/update/switch for applicable DL and UL channels including, e.g., UE-dedicated physical downlink shared channel (PDSCH)/physical downlink control channel (PDCCH) and dynamic-grant/configured-grant based physical uplink shared channel (PUSCH) and dedicated physical uplink control channel (PUCCH) resources.
In another example, the indicator could trigger a TCI state change/update/switch for one or more of applicable DL and/or UL channels including, e.g., UE-dedicated PDSCH and/or UE-dedicated PDCCH and/or dynamic-grant/configured-grant based PUSCH and/or dedicated PUCCH resources.
In yet another example, the indicator could trigger a TCI state change/update/switch only for applicable DL channel(s) including, e.g., UE-dedicated PDSCH and/or PDCCH.
   For example, the indicator could trigger a TCI state change/update/switch only for PDCCH and PDSCH receptions including, e.g., UE-dedicated reception(s) of PDSCH(s) and PDCCH(s).
   For another example, the indicator could trigger a TCI state change/update/switch only for PDSCH(s) reception including, e.g., UE-dedicated reception(s) of PDSCH(s).
   Yet for another example, the indicator could trigger a TCI state change/update/switch only for PDCCH(s) reception including, e.g., UE-dedicated reception(s) of PDCCH(s).
In yet another example, the indicator could trigger a TCI state change/update/switch only for applicable UL channel(s) including, e.g., dynamic-grant/configured-grant based PUSCH and/or dedicated PUCCH resources.
   For example, the indicator could trigger a TCI state change/update/switch only for PUSCH and PUCCH transmissions including, e.g., dynamic-grant/configured-grant based PUSCH and dedicated PUCCH resources.
   For another example, the indicator could trigger a TCI state change/update/switch only for PUSCH(s) transmission, including, e.g., dynamic-grant/configured-grant based PUSCH.
   Yet for another example, the indicator could trigger a TCI state change/update/switch only for PUCCH(s) transmission, including, e.g., dedicated PUCCH resources.
In yet another example, the indicator could trigger a TCI state change/update/switch only for applicable DL/UL control channel(s) including, e.g., UE-dedicated PDCCH and/or dedicated PUCCH resources.
   For example, the indicator could trigger a TCI state change/update/switch only for DL and UL control channels including, e.g., UE-dedicated PDCCH and dedicated PUCCH resources.
   For another example, the indicator could trigger a TCI state change/update/switch only for DL control channel(s) reception including, e.g., UE-dedicated reception(s) of PDCCH(s).
   Yet for another example, the indicator could trigger a TCI state change/update/switch only for UL control channel(s) transmission including, e.g., dedicated PUCCH resources.
In yet another example, the indicator could trigger a TCI state change/update/switch only for applicable DL/UL shared data channel(s) including, e.g., UE-dedicated PDSCH and/or dynamic-grant/configured-grant based PUSCH.
   For example, the indicator could trigger a TCI state change/update/switch only for DL and UL shared data channels including, e.g., UE-dedicated PDSCH and dynamic-grant/configured-grant based PUSCH.
   For another example, the indicator could trigger at TCI state change/update/switch only for DL shared data channel(s) reception including, e.g., UE-dedicated reception(s) of PDSCH(s).
   Yet for another example, the indicator could trigger a TCI state change/update/switch only for UL shared data channel(s) transmission including, e.g., dynamic-grant/configured-grant based PUSCH.

Furthermore, for transmitting/receiving DL/UL signal(s):
In one example, the indicator could trigger a TCI state change/update/switch for applicable DL and UL signals including, e.g., (aperiodic) CSI-RS resources and (aperiodic) SRS resources.
In another example, the indicator could trigger a TCI state change/update/switch for one or more of applicable DL and/or UL signals including, e.g., (aperiodic) CSI-RS resources and/or (aperiodic) SRS resources.
In yet another example, the indicator could trigger a TCI state change/update/switch only for DL signal(s) reception including, e.g., (aperiodic) CSI-RS resources.
In yet another example, the indicator could trigger a TCI state change/update/switch only for UL signal(s) transmission including, e.g., (aperiodic) SRS resources.

In the present disclosure, a UE could send to the network, e.g., in part of CSI/beam report and/or the indicator(s) as described herein in the present disclosure, one or more channel/signal indicators to indicate which one or more of the DL and UL channels and signals the TCI state(s) change/update/switch triggered/indicated/initiated by the indicator(s) as described herein in the present disclosure is applied to, according to one or more of the design examples (e.g., according to one or more examples described herein) specified herein in the present disclosure.
In one example, the channel/signal indicator(s) could be a one-bit indicator. For instance, the one-bit channel/signal indicator could be applied to one or more examples described herein; for this case, when/if the one-bit channel/signal indicator is set to ‘0’ (or ‘1’), the one-bit channel/signal indicator could indicate that the indicator(s) as specified herein in the present disclosure could trigger a TCI state change/update/switch only for applicable DL channel(s) including, e.g., UE-dedicated PDSCH and/or PDCCH (i.e., according to one or more examples described herein); when/if the one-bit channel/signal indicator is set to ‘1’ (or ‘0’), the one-bit channel/signal indicator could indicate that the indicator(s) as specified herein in the present disclosure could trigger a TCI state change/update/switch only for applicable UL channel(s) including, e.g., dynamic-grant/configured-grant based PUSCH and/or dedicated PUCCH resources; optionally, when/if the one-bit channel/signal indicator is not present/reported, the indicator(s) as specified herein in the present disclosure could trigger a TCI state change/update/switch for applicable DL and UL channels including, e.g., UE-dedicated PDSCH/PDCCH and dynamic-grant/configured-grant based PUSCH and dedicated PUCCH resources. The one-bit channel/signal indicator as described herein in the present disclosure could be applied to other design examples specified herein in the present disclosure.
In another example, the channel/signal indicator(s) could be a bitmap with each entry/bit position of the bitmap corresponding to a DL or UL channel or signal. For this case, when/if an entry/bit position of the bitmap is set to ‘1’ (or ‘0’), the TCI state change/update/switch triggered by the indicator(s) as specified herein in the present disclosure could apply to the DL or UL channel or signal corresponding to the entry/bit position of the bitmap.
In yet another example, the channel/signal indicator(s) could be a bitmap with each entry/bit position of the bitmap corresponding to one or more DL and/or UL channels and/or signals. For this case, when/if an entry/bit position of the bitmap is set to ‘1’ (or ‘0’), the TCI state change/update/switch triggered by the indicator(s) as specified herein in the present disclosure could apply to the one or more DL and/or UL channels and/or signals corresponding to the entry/bit position of the bitmap according to one or more of the design examples specified herein in the present disclosure.

One or more channels and/or signals could be configured/indicated by the network, e.g., via higher layer RRC signaling/parameter and/or MAC CE command and/or dynamic DCI based L1 signaling, to follow the TCI state(s), when/if applicable, indicated by the indicator(s) as specified herein in the present disclosure.
In one example, when/if a higher layer parameter, denoted by ‘followUEInitiatedTCIstate’, is configured/provided or set to enabled for a channel or a signal (e.g., the higher layer parameter ‘followUEInitiatedTCIstate’ could be configured/provided or set to enabled in higher layer parameter(s) that configures/provides the channel or the signal), and when/if the TCI state(s) indicated by the indicator(s) as specified herein in the present disclosure-sent by the UE to the network for the UE-initiated beam switching—has become applicable, the UE could apply/use the TCI state(s) indicated by the indicator(s) as specified herein in the present disclosure for the channel or the signal described/specified herein.
   For example, a SRS resource set or a SRS resource could be configured/provided with/by the higher layer parameter ‘followUEInitiatedTCIstate’ or the higher layer parameter ‘followUEInitiatedTCIstate’ set to enabled; for this case, when/if the higher layer parameter ‘followUEInitiatedTCIstate’ is configured/provided or is set to enabled for a SRS resource set or a SRS resource (e.g., in the higher layer parameter(s)/signaling(s) that configures/activates/triggers/indicates/provides the SRS resource set or the SRS resource), the UE could transmit the SRS resources(s) in the SRS resource set or the SRS resource applying/using the TCI state(s), if applicable, indicated by the indicator(s) as specified herein in the present disclosure (the indicator(s) is sent by the UE to the network for UE-initiated beam switching).
   For another example, a CSI resource set such as a SSB resource set provided by CSI-SSB-ResourceSet or a nonzero power (NZP) CSI-RS resource set provided by nzp-CSI-RS-ResourceSet or a CSI(-RS) resource such as a SSB resource or a NZP CSI-RS resource could be configured/provided with/by the higher layer parameter ‘followUEInitiatedTCIState’ or the higher layer parameter ‘followUEInitiatedTCIState’ set to enabled; for this case, when/if the higher layer parameter ‘followUEInitiatedTCIstate’ is configured/provided or is set to enabled for a CSI resource set or a CSI(-RS) resource (e.g., in the higher layer parameter(s)/signaling(s) that configures/activates/triggers/indicates/provides the CSI resource set or the CSI(-RS) resource), the UE could receive the CSI(-RS) resource(s) in the CSI resource set or the CSI(-RS) resource applying/using the TCI state(s), if applicable, indicated by the indicator(s) as specified herein in the present disclosure (the indicator(s) is sent by the UE to the network for UE-initiated beam switching).
In another example, when/if a higher layer parameter, denoted by ‘followUnifiedTCIstate’ or ‘followUnifiedTCIstateSRS’ specified under the unified TCI framework in the 3GPP Rel-17, is configured/provided or set to enabled for a channel or a signal (e.g., the higher layer parameter ‘followUnifiedTCIstate’ or ‘followUnifiedTCIstateSRS’ could be configured/provided or set to enabled in higher layer parameter(s) that configures/provides the channel or the signal), and when/if the TCI state(s) indicated by the indicator(s) as specified herein in the present disclosure—sent by the UE to the network for the UE-initiated beam switching—has become applicable, the UE could apply/use the TCI state(s) indicated by the indicator(s) as specified herein in the present disclosure for the channel or the signal described/specified herein.
   For example, a SRS resource set or a SRS resource could be configured/provided with/by the higher layer parameter ‘followUnifiedTCIstateSRS’ or the higher layer parameter ‘followUnifiedTCIstateSRS’ set to enabled; for this case, when/if the higher layer parameter ‘followUnifiedTCIstateSRS’ is configured/provided or is set to enabled for a SRS resource set or a SRS resource (e.g., in the higher layer parameter(s)/signaling(s) that configures/activates/triggers/indicates/provides the SRS resource set or the SRS resource), the UE could transmit the SRS resources(s) in the SRS resource set or the SRS resource applying/using the TCI state(s), if applicable, indicated by the indicator(s) as specified herein in the present disclosure (the indicator(s) is sent by the UE to the network for UE-initiated beam switching).
   For another example, a CSI resource set such as a SSB resource set provided by CSI-SSB-ResourceSet or a NZP CSI-RS resource set provided by nzp-CSI-RS-ResourceSet or a CSI(-RS) resource such as a SSB resource or a NZP CSI-RS resource could be configured/provided with/by the higher layer parameter ‘followUnifiedTCIState’ or the higher layer parameter ‘followUnifiedTCIState’ set to enabled; for this case, when/if the higher layer parameter ‘followUnifiedTCIstate’ is configured/provided or is set to enabled for a CSI resource set or a CSI(-RS) resource (e.g., in the higher layer parameter(s)/signaling(s) that configures/activates/triggers/indicates/provides the CSI resource set or the CSI(-RS) resource), the UE could receive the CSI(-RS) resource(s) in the CSI resource set or the CSI(-RS) resource applying/using the TCI state(s), if applicable, indicated by the indicator(s) as specified herein in the present disclosure (the indicator(s) is sent by the UE to the network for UE-initiated beam switching).
In yet another example, for a CORESET with index 0, when/if a higher layer parameter, denoted by ‘followUEInitiatedTCIstate’, is configured/provided or set to enabled for the CORESET (e.g., the higher layer parameter ‘followUEInitiatedTCIstate’ could be configured/provided or set to enabled in the higher layer parameter such as ControlResourceSet that configures the CORESET), and when/if the TCI state(s) indicated by the indicator(s) as specified herein in the present disclosure—sent by the UE to the network for the UE-initiated beam switching—has become applicable, the UE could expect that a demodulation reference signal (DM-RS) antenna port for PDCCH receptions in the CORESET and a DM-RS antenna port for PDSCH receptions scheduled by DCI formats provided by PDCCH receptions in the CORESET are quasi co-located with the reference signals provided by the TCI state(s) indicated by the indicator(s). Furthermore, for a CORESET other than a CORESET with index 0, associated at least with common search space (CSS) sets other than Type3-PDCCH CSS sets, when/if a higher layer parameter, denoted by ‘followUEInitiatedTCIstate’, is configured/provided or set to enabled for the CORESET (e.g., the higher layer parameter ‘followUEInitiatedTCIstate’ could be configured/provided or set to enabled in the higher layer parameter such as ControlResourceSet that configures the CORESET), and when/if the TCI state(s) indicated by the indicator(s) as specified herein in the present disclosure—sent by the UE to the network for the UE-initiated beam switching—has become applicable, the UE could expect that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the TCI state(s) indicated by the indicator(s).
In yet another example, for a CORESET with index 0, when/if a higher layer parameter, denoted by ‘followUnifiedTCIstate’ specified under the unified TCI framework in the 3GPP Rel-17, is configured/provided or set to enabled for the CORESET (e.g., the higher layer parameter ‘followUnifiedTCIstate’ could be configured/provided or set to enabled in the higher layer parameter such as ControlResourceSet that configures the CORESET), and when/if the TCI state(s) indicated by the indicator(s) as specified herein in the present disclosure-sent by the UE to the network for the UE-initiated beam switching—has become applicable, the UE could expect that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the TCI state(s) indicated by the indicator(s). Furthermore, for a CORESET other than a CORESET with index 0, associated at least with CSS sets other than Type3-PDCCH CSS sets, when/if a higher layer parameter, denoted by ‘followUnifiedTCIstate’ specified under the unified TCI framework in the 3GPP Rel-17, is configured/provided or set to enabled for the CORESET (e.g., the higher layer parameter ‘followUnifiedTCIstate’ could be configured/provided or set to enabled in the higher layer parameter such as ControlResourceSet that configures the CORESET), and when/if the TCI state(s) indicated by the indicator(s) as specified herein in the present disclosure-sent by the UE (e.g., the UE 116) to the network (e.g., the network 130) for the UE-initiated beam switching—has become applicable, the UE could expect that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the TCI state(s) indicated by the indicator(s).

The indicator(s) described herein in the present disclosure could correspond to the trigger/pre-notification (PN) message in a (report-) type (A) based report or a (report-) type (C) based report, or part of the (corresponding) content in a (report-) type (B) based report or a (report-) type (C) based report. Furthermore, the signaling medium/container for reporting the indicator(s) as specified herein in the present disclosure (or equivalently, the trigger/pre-notification (PN) message in a (report-) type (A) based report or a (report-) type (C) based report, or part of the (corresponding) content in a (report-) type (B) based report or a (report-) type (C) based report) could be PUCCH, PUSCH, physical random access channel (PRACH), MAC CE, uplink control information (UCI), etc. The UE may expect to receive from the network an acknowledgement (ACK) (or negative ACK (NACK)) for the indicator(s) specified herein in the present disclosure within a first time window/offset (e.g., in terms of the number of slots/symbols/etc.) starting from the transmission of the indicator(s) (e.g., starting from the corresponding slot/symbol/etc.). The value of the first time window/offset could be: (i) fixed in the system specification(s), (ii) configured/provided/indicated by the network, e.g., via higher layer RRC signaling/parameter and/or MAC CE command and/or dynamic DCI based L1 signaling, or (iii) autonomously determined by the UE and sent to the network via uplink channels such as PUCCH/PUSCH.
When/if the UE does not receive from the network an ACK for the indicator(s) within the first time window/offset starting from the transmission of the indicator(s) or receives a NACK for the indicator(s) within the first time window/offset starting from the transmission of the indicator(s), the UE could (re-)send the indicator(s).
When/if the UE receives from the network an ACK for the indicator(s) within the first time window/offset starting from the transmission of the indicator(s), the UE may perform the behaviors/operations and/or expect the corresponding network's operations according to the indicator(s) X duration/offset/time (e.g., X symbols/slots/etc.) starting from the reception of the ACK message for the indicator(s). The value of X could be: (i) fixed in the system specification(s), (ii) configured/provided/indicated by the network, e.g., via higher layer RRC signaling/parameter and/or MAC CE command and/or dynamic DCI based L1 signaling, or (iii) autonomously determined by the UE and sent to the network via uplink channels such as PUCCH/PUSCH.

The UE could be indicated/configured/provided by the network, e.g., via higher layer RRC signaling/parameter and/or MAC CE command and/or dynamic DCI based L1 signaling, the ACK (or NACK) for the indicator(s) specified herein in the present disclosure for the UE-initiated beam switching. For instance, the UE could be indicated/configured/provided by the network, e.g., via higher layer RRC signaling/parameter and/or MAC CE command and/or dynamic DCI based L1 signaling, a one-bit indicator to indicate ACK or NACK for the indicator(s) specified herein in the present disclosure for the UE-initiated beam switching; when/if the one-bit indicator is set to ‘1’ (or ‘0’), the one-bit indicator could indicate an ACK for the indicator(s) sent by the UE for the UE-initiated TCI state(s)/beam(s) switching/update/change; when/if the one-bit indicator is not present/configured or is set to ‘0’ (or ‘1’), the one-bit indicator could indicate a NACK for the indicator(s) sent by the UE for the UE-initiated TCI state(s)/beam(s) switching/update/change. Furthermore, when/if provided/indicated in a DCI, the ACK (or NACK)—e.g., the one-bit indicator as described herein—for the indicator(s) sent by the UE for the UE-initiated TCI state(s)/beam(s) switching/update/change could be indicated/provided via one or more new/dedicated DCI fields—e.g., denoted by ‘ACK/NACK for UE-initiated beam switching’ field(s)—in the DCI. Alternatively, when/if provided/indicated in a DCI, the ACK (or NACK)—e.g., the one-bit indicator as described herein—for the indicator(s) sent by the UE for the UE-initiated TCI state(s)/beam(s) switching/update/change could be indicated/provided via/by repurposing one or more bits of one or more existing DCI fields in the DCI. For instance, the ‘New Data Indicator’ (NDI) field in a DCI could be repurposed/used to indicate the ACK (or NACK) for the indicator(s) sent by the UE for the UE-initiated TCI state(s)/beam(s) switching/update/change; when/if the NDI field is toggled or is set to ‘1’ (or ‘0’), the NDI could indicate an ACK for the indicator(s) sent by the UE for the UE-initiated TCI state(s)/beam(s) switching/update/change; otherwise, the NDI could indicate a NACK for the indicator(s) sent by the UE for the UE-initiated TCI state(s)/beam(s) switching/update/change.

As specified herein in the present disclosure, a UE could send to the network, e.g., in one or more CSI/beam reports (e.g., via UCI and/or MAC CE), one or more resource indicators such as SSBRIs and/or CRIs (along with their corresponding/associated beam metrics such as L1-RSRPs and/or L1-SINRs) for TCI state(s)/beam(s) reporting. A CSI/beam report could be for TCI state(s)/beam(s) reporting and/or a resource indicator (and/or the corresponding beam metric) could be for TCI state(s)/beam(s) reporting as specified herein in the present disclosure, when/if, e.g., a UE is provided/indicated/configured by the network, e.g., in/via higher layer RRC parameter/signaling (SI-ReportConfig, groupBasedBeamReporting (e.g., set to ‘enabled’ or ‘disabled’) and/or groupBasedBeamReporting-r17 (e.g., set to ‘enabled’ or ‘disabled’) and/or groupBasedBeamReporting-r18 (e.g., set to ‘enabled’ or ‘disabled’). In addition, a CSI/beam report could be for TCI state(s)/beam(s) reporting and/or a resource indicator (and/or the corresponding beam metric) could be for TCI state(s)/beam(s) reporting as specified herein in the present disclosure, when/if, e.g., a UE is provided/indicated/configured by the network, e.g., in/via higher layer RRC parameter/signaling CSI-ReportConfig, reportQuantity set to one or more of: cri-RSRP, ssb-index-RSRP, cri-SINR, ssb-index-SINR. Optionally, a CSI/beam report could be for TCI state(s)/beam(s) reporting and/or a resource indicator (and/or the corresponding beam metric) could be for TCI state(s)/beam(s) reporting, when/if, e.g., the CSI/beam report and/or the resource indicator (and/or the corresponding beam metric) in the CSI/beam report is for TCI state(s)/beam(s) activation/deactivation and/or TCI state(s)/beam(s) switching/change/update according to those specified herein in the present disclosure.

FIG. 8 illustrates an example of using reported resource indicator(s) 800 to trigger/initiate beam(s)/TCI state(s) activation/sub-selection and beam/TCI state switching/change according to embodiments of the present disclosure. For example, using the reported resource indicator(s) 800 to trigger/initiate beam(s)/TCI state(s) activation/sub-selection and beam/TCI state switching/change can be identified by any of the UEs 111-116 of FIG. 1, such as the UE 112. This example is for illustration only and other embodiments can be used without departing from the scope of the present disclosure.

As specified herein in the present disclosure, a UE could send to the network, e.g., in one or more CSI/beam reports (e.g., via UCI and/or MAC CE), one or more first resource indicators such as SSBRIs and/or CRIs (along with their corresponding/associated beam metrics such as L1-RSRPs/L1-SINRs) for TCI state(s)/beam(s) activation/deactivation/sub-selection. When/if a first resource indicator such as a SSBRI or a CRI (and/or the corresponding beam metric such as L1-RSRP or L1-SINR) is for TCI state(s)/beam(s) activation/deactivation/sub-selection, the TCI state/beam corresponding to the first resource indicator or the TCI state/beam that has/comprises/contains/provides/indicates/includes at least the (QCL source) RS (e.g., with QCL-TypeD) corresponding to the first resource indicator could be for TCI state(s)/beam(s) activation/deactivation/sub-selection.
In one example, with reference to FIG. 8, as specified herein in the present disclosure, a UE could send to the network, e.g., in a CSI/beam report, one or more second resource indicators for TCI state(s)/beam(s) switching/change. For this case, the one or more second resource indicators for TCI state(s)/beam(s) switching/change could be from the one or more first resource indicators reported for TCI state(s)/beam(s) activation/deactivation/sub-selection according to those specified herein in the present disclosure.
In another example, as specified herein in the present disclosure, a UE could send to the network, e.g., in a CSI/beam report, index(es) of one or more first resource indicators among the first resource indicators reported in a/the CSI/beam report for TCI state(s)/beam(s) activation/deactivation/sub-selection as specified herein in the present disclosure. For this case, the first resource indicator(s) corresponding to the reported index(es) could be used as one or more second resource indicators for TCI state(s)/beam(s) switching/change according to those specified herein in the present disclosure.
In yet another example, a UE could send to the network, e.g., in a CSI/beam report, one or more sets of first resource indicators with each set comprising/providing/indicating/including/containing one or more first resource indicators for TCI state(s)/beam(s) activation/deactivation/sub-selection according to those specified herein in the present disclosure. The (maximum) number of the one or more sets and/or the (maximum) number of first resource indicators in each set could be: (1) determined according to value(s) in fixed system specification(s), (2) configured/indicated/provided by the network, e.g., via higher layer RRC signaling(s)/parameter(s) and/or MAC CE command(s) and/or dynamic DCI based L1 signaling(s), and/or (3) autonomously determined by the UE, which could be further reported to the network, e.g., via/in part of a/the CSI/beam report and/or UE's capability signaling(s). Furthermore, the UE could send to the network, e.g., in a CSI/beam report, index(es) of one or more sets of first resource indicators among the sets of first resource indicators reported in a/the CSI/beam report for TCI state(s)/beam(s) activation/deactivation/sub-selection as specified herein in the present disclosure. For this case, the set(s) of first resource indicator(s) corresponding to the reported set index(es) could be used as one or more second resource indicators for TCI state(s)/beam(s) switching/change according to those specified herein in the present disclosure.

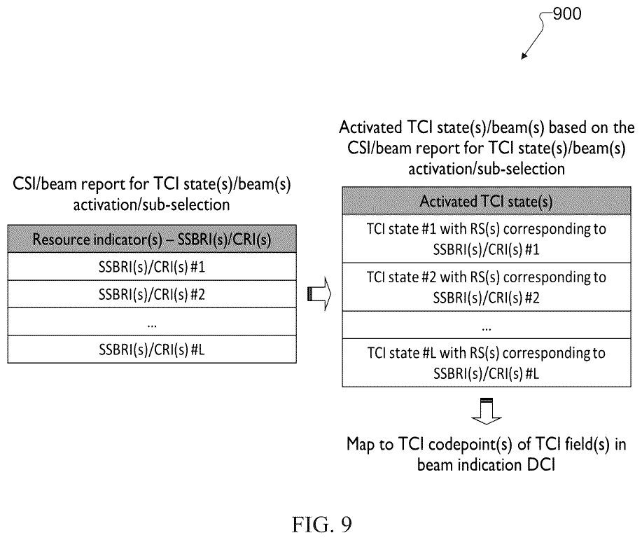

FIG. 9 illustrates an example of using reported resource indicator(s) 900 to trigger/initiate beam(s)/TCI state(s) activation/sub-selection according to embodiments of the present disclosure. For example, using the reported resource indicator(s) 900 to trigger/initiate beam(s)/TCI state(s) activation/sub-selection can be referenced by any of the UEs 111-116 of FIG. 1, such as the UE 116 of FIG. 3. This example is for illustration only and other embodiments can be used without departing from the scope of the present disclosure.
In yet another example, the UE could be indicated/provided/activated by the network, e.g., via/in a TCI state(s) activation/deactivation MAC CE, one or more sets of joint/DL/UL TCI states, e.g., with each set used to map to a TCI codepoint of a TCI field in a beam indication DCI (e.g., DCI format 1_1/1_2 with or without DL assignment). For this design example, the activated joint/DL/UL TCI state(s) or the activated TCI codepoint(s) corresponding to/comprising the joint/DL/UL TCI state(s) could be from the TCI state(s) corresponding to the one or more first resource indicators reported in the CSI/beam report—e.g., the TCI state(s) that has/comprises/includes/contains/indicates/provides at least the (QCL source) RS(s) (e.g., with QCL-TypeD) corresponding to the first resource indicator(s).
In yet another example, a UE could send to the network, e.g., in a CSI/beam report, one or more sets of first resource indicators with each set comprising/providing/indicating/including/containing one or more first resource indicators for TCI state(s)/beam(s) activation/deactivation/sub-selection according to those specified herein in the present disclosure. The (maximum) number of the one or more sets and/or the (maximum) number of first resource indicators in each set could be: (1) determined according fixed to value(s) system specification(s), (2) in configured/indicated/provided by the network, e.g., via higher layer RRC signaling(s)/parameter(s) and/or MAC CE command(s) and/or dynamic DCI based L1 signaling(s), and/or (3) autonomously determined by the UE, which could be further reported to the network, e.g., via/in part of a/the CSI/beam report and/or UE's capability signaling(s). The UE could also be indicated/provided/activated by the network, e.g., via/in a TCI state(s) activation/deactivation MAC CE, one or more sets of joint/DL/UL TCI states, e.g., with each set used to map to a TCI codepoint of a TCI field in a beam indication DCI (e.g., DCI format 1_1/1_2 with or without DL assignment). For this design example, the activated joint/DL/UL TCI state(s) in each set or the activated joint/DL/UL TCI state(s) of each activated TCI codepoint could be or could correspond to the TCI state(s) corresponding to a set of one or more first resource indicators reported in the CSI/beam-report e.g., the TCI state(s) that has/comprises/includes/contains/indicates/provides at least the (QCL source) RS(s) (e.g., with QCL-TypeD) corresponding to the reported first resource indicator(s) in the set.
In yet another example, with reference to FIG. 9, the UE could be indicated/provided/activated by the network, e.g., via/in a beam indication DCI (e.g., DCI format 1_1/1_2 with or without DL assignment), one or more joint/DL/UL TCI states by a TCI codepoint of a TCI field. For this design example, the indicated joint/DL/UL TCI state(s) could be from the TCI state(s) corresponding to the one or more first resource indicators reported in the CSI/beam report—e.g., the TCI state(s) that has/comprises/includes/contains/indicates/provides at least the (QCL source) RS(s) (e.g., with QCL-TypeD) corresponding to the reported first resource indicator(s). Or, the TCI state(s) corresponding to the one or more first resource indicators reported in the CSI/beam report—e.g., the TCI state(s) that has/comprises/includes/contains/indicates/provides at least the (QCL source) RS(s) (e.g., with QCL-TypeD) corresponding to the reported first resource indicator(s) could be used to map to one or more (e.g., up to Ntci, wherein Ntci=8, 16, . . . ) TCI codepoints of a TCI field in a beam indication DCI (e.g., DCI format 1_1/1_2 with or without DL assignment).
In yet another example, a UE could send to the network, e.g., in a CSI/beam report, one or more sets of first resource indicators with each set comprising/providing/indicating/including/containing one or more first resource indicators for TCI state(s)/beam(s) activation/deactivation/sub-selection according to those specified herein in the present disclosure. The (maximum) number of the one or more sets and/or the (maximum) number of first resource indicators in each set could be: (1) determined according to fixed value(s) in system specification(s), (2) configured/indicated/provided by the network, e.g., via higher layer RRC signaling(s)/parameter(s) and/or MAC CE command(s) and/or dynamic DCI based L1 signaling(s), and/or (3) autonomously determined by the UE, which could be further reported to the network, e.g., via/in part of a/the CSI/beam report and/or UE's capability signaling(s). The UE could also be indicated/provided/activated by the network, e.g., via/in a beam indication DCI (e.g., DCI format 1_1/1_2 with or without DL assignment), one or more joint/DL/UL TCI states by a TCI codepoint of a TCI field; for this design example, the indicated joint/DL/UL TCI state(s) could be or could correspond to the TCI state(s) corresponding to a set of one or more first resource indicators reported in the CSI/beam report—e.g., the TCI state(s) that has/comprises/includes/contains/indicates/provides at least the (QCL source) RS(s) (e.g., with QCL-TypeD) corresponding to the reported first resource indicator(s) in the set. Or, the TCI state(s) corresponding to a set of one or more first resource indicators reported in the CSI/beam report—e.g., the TCI state(s) that has/comprises/includes/contains/indicates/provides at least the (QCL source) RS(s) (e.g., with QCL-TypeD) corresponding to the reported first resource indicator(s) in the set could be used to map to a TCI codepoint of a TCI field in a beam indication DCI (e.g., DCI format 1_1/1_2 with or without DL assignment), i.e., the TCI state(s) corresponding to the one or more sets of first resource indicators reported in the CSI/beam report—e.g., the TCI state(s) that has/comprises/includes/contains/indicates/provides at least the (QCL source) RS(s) (e.g., with QCL-TypeD) corresponding to the reported first resource indicators in the one or more sets could be used to map to up to Ntci (e.g., Ntci=8, 16, . . . ) TCI codepoints of a TCI field in a beam indication DCI (e.g., DCI format 1_1/1_2 with or without DL assignment).

The UE could use/apply the reported resource indicator(s) for TCI state(s)/beam(s) activation/deactivation/sub-selection until the UE (i) provides/indicates/sends to the network, e.g., in a/the CSI/beam report, that the used/applied resource indicator(s) for TCI state(s)/beam(s) activation/deactivation/sub-selection could be deactivated, (ii) provides/indicates/sends to the network, e.g., in a/the CSI/beam report, one or more new resource indicators for TCI state(s)/beam(s) activation/deactivation/sub-selection, (iii) receives from or is indicated/provided/configured by the network, e.g., via/in higher layer RRC signaling(s)/parameter(s) and/or MAC CE command(s) and/or dynamic DCI based L1 signaling(s), that the used/applied resource indicator(s) for TCI state(s)/beam(s) activation/deactivation/sub-selection could be deactivated, and/or (iv) receives or is indicated/provided/configured by the network, e.g., in/via a TCI state(s) activation/deactivation MAC CE, one or more sets of joint/DL/UL TCI states used to map to one or more TCI codepoints of one or more TCI fields in beam indication DCI(s)—e.g., DCI format(s) 1_1/1_2 with or without DL assignment. Furthermore, in one example, the UE could be indicated/provided/activated by the network, e.g., in/via a TCI state(s) activation/deactivation MAC CE, one or more sets of first joint/DL/UL TCI states used to map to one or more TCI codepoints of one or more TCI fields in beam indication DCI(s)—e.g., DCI format(s) 1_1/1_2 with or without DL assignment. In addition, the UE could also send to the network, e.g., in a/the CSI/beam report, one or more resource indicators for TCI state(s)/beam(s) activation/deactivation/sub-selection according to those specified herein in the present disclosure, wherein the TCI state(s) corresponding to the one or more resource indicators reported in the CSI/beam report for TCI state(s)/beam(s) activation/deactivation/sub-selection—e.g., the TCI state(s) that has/comprises/includes/contains/indicates/provides at least the (QCL source) RS(s) (e.g., with QCL-TypeD) corresponding to the reported resource indicator(s) could be referred to as one or more second joint/DL/UL TCI states. For this case, one or more of the first joint/DL/UL TCI states and one or more of the second joint/DL/UL TCI states could be used to map up to Ntci (e.g., Ntci=8, 16, . . . ) TCI codepoints of a TCI field in a beam indication DCI (e.g., DCI format 1_1/1_2 with or without DL assignment), according to (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous selection/determination, which could be further reported to the network, e.g., via/in part of the beam/CSI report and/or UE's capability signaling(s).

As specified herein in the present disclosure, a UE could send to the network, e.g., in one or more CSI/beam reports (e.g., via UCI and/or MAC CE), one or more resource indicators such as SSBRIs and/or CRIs (along with their corresponding/associated beam metrics such as L1-RSRPs and/or L1-SINRs) for beam(s) reporting, beam(s)/TCI state(s) activation(s) and/or beam(s)/TCI state(s) change/switching. For instance, the UE could send to the network, e.g., in a CSI/beam report (e.g., via UCI and/or MAC CE), a set of L≥1 resource indicators (SSBRIs and/or CRIs) and their associated/corresponding beam metrics such as L1-RSRPs and/or L1-SINRs for beam(s) reporting, beam(s)/TCI state(s) activation(s) and/or beam(s)/TCI state(s) change/switching.
In one example, the first (or last) or k-th reported resource indicator SSBRI/CRI, e.g., among the resource indicators SSBRIs/CRIs or the components comprising/indicating at least the resource indicators and their corresponding/associated beam metrics reported in the CSI/beam report, could be used as the indicator(s) as specified herein in the present disclosure to trigger or initiate a TCI state/beam change/switch (i.e., used as a resource indicator for TCI state(s)/beam(s) switching/change) and/or a resource indicator for TCI state(s)/beam(s) reporting and/or a resource indicator for TCI state(s)/beam(s) activation/deactivation and/or a resource indicator for TCI state(s)/beam(s) switching/change and/or a candidate resource indicator among one or more candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)). In the present disclosure, the value of k could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In another example, the reported resource indicator SSBRI/CRI with the highest (or lowest) measured beam metric L1-RSRP/L1-SINR, e.g., among the resource indicators SSBRIs/CRIs or the components comprising/indicating resource indicators and their corresponding/associated beam metrics reported in the CSI/beam report, could be used as the indicator(s) as specified herein in the present disclosure to trigger or initiate a TCI state/beam change/switch (i.e., used as a resource indicator for TCI state(s)/beam(s) switching/change) and/or a resource indicator for TCI state(s)/beam(s) reporting and/or a resource indicator for TCI state(s)/beam(s) activation/deactivation and/or a resource indicator for TCI state(s)/beam(s) switching/change and/or a candidate resource indicator among one or more candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)).
In yet another example, the reported resource indicator SSBRI/CRI with the k-th highest (or lowest) measured beam metric L1-RSRP/L1-SINR, e.g., among the resource indicators SSBRIs/CRIs or the components comprising/indicating at least the resource indicators and their corresponding/associated beam metrics reported in the CSI/beam report, could be used as the indicator(s) as specified herein in the present disclosure to trigger or initiate a TCI state/beam change/switch (i.e., used as a resource indicator for TCI state(s)/beam(s) switching/change) and/or a resource indicator for TCI state(s)/beam(s) reporting and/or a resource indicator for TCI state(s)/beam(s) activation/deactivation and/or a resource indicator for TCI state(s)/beam(s) switching/change and/or a candidate resource indicator among one or more candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)). In the present disclosure, the value of k could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the resource indicator SSBRI/CRI reported in the first (or last) or k-th CSI field, e.g., among the CSI fields or the CSI fields that comprise/indicate at least resource indicators SSBRIs/CRIs in the CSI/beam report, could be used as the indicator(s) as specified herein in the present disclosure to trigger or initiate a TCI state/beam change/switch (i.e., used as a resource indicator for TCI state(s)/beam(s) switching/change) and/or a resource indicator for TCI state(s)/beam(s) reporting and/or a resource indicator for TCI state(s)/beam(s) activation/deactivation and/or a resource indicator for TCI state(s)/beam(s) switching/change and/or a candidate resource indicator among one or more candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)). In the present disclosure, the value of k could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the reported resource indicator SSBRI/CRI corresponding to the lowest/first (or highest/last) or k-th or k-th lowest/highest CSI report number, e.g., among the CSI reports/CSI report numbers or the CSI reports/CSI report numbers corresponding to at least resource indicators SSBRIs/CRIs in the CSI/beam report, could be used as the indicator(s) as specified herein in the present disclosure to trigger or initiate a TCI state/beam change/switch (i.e., used as a resource indicator for TCI state(s)/beam(s) switching/change) and/or a resource indicator for TCI state(s)/beam(s) reporting and/or a resource indicator for TCI state(s)/beam(s) activation/deactivation and/or a resource indicator for TCI state(s)/beam(s) switching/change and/or a candidate resource indicator among one or more candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)). In the present disclosure, the value of k could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE (e.g., the UE 116) capability signaling.
In yet another example, the first (or last) K (1≤K≤L) reported resource indicators SSBRIs/CRIs, e.g., among the resource indicators SSBRIs/CRIs or the components comprising/indicating at least the resource indicators and their corresponding/associated beam metrics reported in the CSI/beam report, could be used as (1) the indicator(s) as specified herein in the present disclosure to trigger or initiate TCI state(s)/beam(s) change/switch (i.e., resource indicators for TCI state(s)/beam(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network (e.g., the network 130), e.g., via/in part of a/the CSI/beam report and/or UE's capability signaling(s)). In the present disclosure, the value of K could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the K (1≤K≤L) reported resource indicators SSBRIs/CRIs with the highest (or lowest) K measured beam metrics L1-RSRPs/L1-SINRs, e.g., among the resource indicators SSBRIs/CRIs or the components comprising/indicating at least the resource indicators and their corresponding/associated beam metrics reported in the CSI/beam report, could be used as (1) the indicator(s) as specified herein in the present disclosure to trigger or initiate TCI state(s)/beam(s) change/switch (i.e., resource indicators for TCI state(s)/beam(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)). In the present disclosure, the value of K could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the reported resource indicators SSBRIs/CRIs with the measured beam metrics L1-RSRPs/L1-SINRs—e.g., among the resource indicators SSBRIs/CRIs or the components comprising/indicating at least the resource indicators and their corresponding/associated beam metrics reported in the CSI/beam report-higher (or lower) than a threshold could be used as (1) the indicator(s) as specified herein in the present disclosure to trigger or initiate TCI state(s)/beam(s) change/switch (i.e., resource indicators for TCI state(s)/beam(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)). The threshold value could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the resource indicators SSBRIs/CRIs reported in the first (or last) K (1≤K≤L) CSI fields, e.g., among the CSI fields or the CSI fields that comprise/indicate at least resource indicators SSBRIs/CRIs in the CSI/beam report, could be used as (1) the indicator(s) as specified herein in the present disclosure to trigger or initiate TCI state(s)/beam(s) change/switch (i.e., resource indicators for TCI state(s)/beam(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)). In the present disclosure, the value of K could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the reported resource indicators SSBRIs/CRIs corresponding to the lowest/first (or highest/last) K (1≤K≤L) CSI report numbers, e.g., among the CSI reports/CSI report numbers or the CSI reports/CSI report numbers corresponding to at least resource indicators SSBRIs/CRIs in the CSI/beam report, could be used as (1) the indicator(s) as specified herein in the present disclosure to trigger or initiate TCI state(s)/beam(s) change/switch (i.e., resource indicators for TCI state(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)). In the present disclosure, the value of K could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, K reported resource indicators SSBRIs/CRIs, e.g., among the resource indicators SSBRIs/CRIs or the components comprising/indicating at least the resource indicators and their corresponding/associated beam metrics reported in the CSI/beam report, could be used as (1) the indicator(s) as specified herein in the present disclosure to trigger or initiate TCI state(s)/beam(s) change/switch (i.e., resource indicators for TCI state(s)/beam(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)), wherein which K out of the L reported resource indicators (e.g., in terms of their positions/orderings among the L reported resource indicators and/or in the beam/CSI report) and/or the value of K could be: (i) configured/indicated by the network, e.g., via higher layer RRC signaling/parameter and/or MAC CE command and/or dynamic DCI based L1 signaling (e.g., by one or more indicators/bitmaps/etc.), (ii) fixed in system specification(s), and/or (iii) autonomously determined/selected by the UE, and/or reported to the network, e.g., in part of a/the CSI/beam report and/or UE capability signaling.
In yet another example, each of one or more of the reported resource indicators SSBRIs/CRIs in the CSI/beam report could be associated with/to an indicator, wherein the indicator(s) could also be reported in the same CSI/beam report. For instance, when/if a reported indicator is set to ‘1’ (or ‘0’) or ‘enabled’ (or ‘disabled’) or ‘on’ (or ‘off’), the resource indicator SSBRI/CRI associated/corresponding to the reported indicator could be used as (1) the indicator as specified herein in the present disclosure to trigger or initiate a TCI state/beam change/switch (i.e., a resource indicator for TCI state(s)/beam(s) switching/change), (2) a resource indicator among one or more resource indicators for beam(s)/TCI state(s) reporting, (3) a resource indicator among one or more resource indicators for beam(s)/TCI state(s) activation/sub-selection, and/or (4) a candidate resource indicator among one or more candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)).
In yet another example, a bitmap (e.g., of length L) with each entry/bit position corresponding/associated to a reported resource indicator SSBRI/CRI could be included in the same CSI/beam report. For instance, the first entry/bit position of the reported bitmap could correspond to the first (or last) reported resource indicator SSBRI/CRI, e.g., among the resource indicators SSBRIs/CRIs or the components comprising/indicating at least the resource indicators and their corresponding/associated beam metrics reported in the CSI/beam report, or the resource indicator SSBRI/CRI reported in the first (or last) CSI field, e.g., among the CSI fields or the CSI fields that comprise/indicate at least resource indicators SSBRIs/CRIs in the CSI/beam report, or the reported resource indicator SSBRI/CRI corresponding to the lowest/first (or highest/last) CSI report number, e.g., among the CSI reports/CSI report numbers or the CSI reports/CSI report numbers corresponding to at least resource indicators SSBRIs/CRIs in the CSI/beam report, the second entry/bit position of the reported bitmap could correspond to the second (or second last) reported resource indicator SSBRI/CRI, e.g., among the resource indicators SSBRIs/CRIs or the components comprising/indicating at least the resource indicators and their corresponding/associated beam metrics reported in the CSI/beam report, or the resource indicator SSBRI/CRI reported in the second (or second last) CSI field, e.g., among the CSI fields or the CSI fields that comprise/indicate at least resource indicators SSBRIs/CRIs in the CSI/beam report, or the reported resource indicator SSBRI/CRI corresponding to the second lowest/second (or second highest/second last) CSI report number, e.g., among the CSI reports/CSI report numbers or the CSI reports/CSI report numbers corresponding to at least resource indicators SSBRIs/CRIs in the CSI/beam report, and so on. For this case, when/if an entry/bit position of the bitmap is set to ‘1’ (or ‘0’), the resource indicator SSBRI/CRI associated/corresponding to the entry/bit position could be used as (1) the indicator as specified herein in the present disclosure to trigger or initiate a TCI state/beam change/switch (i.e., a resource indicator for TCI state(s)/beam(s) switching/change), (2) a resource indicator among one or more resource indicators for beam(s)/TCI state(s) reporting, (3) a resource indicator among one or more resource indicators for beam(s)/TCI state(s) activation/sub-selection, and/or (4) a candidate resource indicator among one or more candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)).
In yet another example, the UE could send to the network, e.g., in the CSI/beam report, one or more (e.g., Ng≥1) groups of resource indicators such as SSBRIs and/or CRIs with each group comprising Mg≥1 resource indicators SSBRIs/CRIs and/or the Ng groups comprising the total L resource indicators SSBRIs/CRIs consecutively. For this example, L=Ng×Mg. The beam metrics such as the L1-RSRPs/L1-SINRs corresponding/associated to the resource indicators could also be reported in the same CSI/beam report. The number Ng of the reported groups and/or the number Mg of the reported resource indicators in each group could be: (i) configured/provided/indicated by the network, e.g., via higher layer RRC signaling(s)/parameter(s) and/or MAC CE command and/or dynamic DCI based L1 signaling, (ii) determined based on/according to fixed rule(s) in system specification(s), and/or (iii) autonomously determined by the UE, and/or reported by the UE to the network, e.g., in part of the CSI/beam report and/or UE capability signaling. For this case, the first (or last) or n-th (n∈{1, . . . , Ng}) reported group of Mg resource indicators SSBRIs/CRIs, the reported group of Mg resource indicators SSBRIs/CRIs with the highest (or lowest) or n-th (n∈{1, . . . , Ng}) highest (or lowest) measured beam metrics (or measured total/sum/average beam metrics) such as L1-RSRPs/L1-SINRs and/or etc. among the Ng reported groups of resource indicators could be used as (1) the indicator(s) as specified herein in the present disclosure to trigger or initiate TCI state(s)/beam(s) change/switch (i.e., resource indicators for TCI state(s)/beam(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)). In the present disclosure, the value of n could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the UE could send to the network, e.g., in the CSI/beam report, one or more (e.g., Ng≥1) groups of resource indicators such as SSBRIs and/or CRIs with each group comprising Mg≥1 resource indicators SSBRIs/CRIs and/or the Ng groups comprising the total L resource indicators SSBRIs/CRIs consecutively. For this example, L=Ng×Mg. The beam metrics such as the L1-RSRPs/L1-SINRs corresponding/associated to the resource indicators could also be reported in the same CSI/beam report. The number Ng of the reported groups and/or the number Mg of the reported resource indicators in each group could be: (i) configured/provided/indicated by the network, e.g., via higher layer RRC signaling(s)/parameter(s) and/or MAC CE command and/or dynamic DCI based L1 signaling, (ii) determined based on/according to fixed rule(s) in system specification(s), and/or (iii) autonomously determined by the UE, and/or reported by the UE to the network, e.g., in part of the CSI/beam report and/or UE capability signaling. For this case, the first (or last) Kg (Kg∈{1, . . . , Ng}) reported groups of resource indicators SSBRIs/CRIs, the reported groups of resource indicators SSBRIs/CRIs with the highest (or lowest) Kg (Kg∈{1, . . . , Ng}) measured beam metrics (or measured total/sum/average beam metrics) such as L1-RSRPs/L1-SINRs and/or etc. among the Ng reported groups of resource indicators could be used as (1) the indicator(s) as specified herein in the present disclosure to trigger or initiate TCI state(s)/beam(s) change/switch (i.e., resource indicators for TCI state(s)/beam(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)). In the present disclosure, the value of Kg could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the UE could send to the network, e.g., in the CSI/beam report, one or more (e.g., Ng≥1) groups of resource indicators such as SSBRIs and/or CRIs with each group comprising Mg≥1 resource indicators SSBRIs/CRIs and/or the Ng groups comprising the total L resource indicators SSBRIs/CRIs consecutively. For this example, L=Ng×Mg. The beam metrics such as the L1-RSRPs/L1-SINRs corresponding/associated to the resource indicators could also be reported in the same CSI/beam report. The number Ng of the reported groups and/or the number Mg of the reported resource indicators in each group could be: (i) configured/provided/indicated by the network, e.g., via higher layer RRC signaling(s)/parameter(s) and/or MAC CE command and/or dynamic DCI based L1 signaling, (ii) determined based on/according to fixed rule(s) in system specification(s), and/or (iii) autonomously determined by the UE, and/or reported by the UE to the network, e.g., in part of the CSI/beam report and/or UE capability signaling. For this case, Kg (Kg∈{1, . . . , Ng}) reported groups of resource indicators SSBRIs/CRIs among the Ng reported groups of resource indicators could be used as (1) the indicator(s) as specified herein in the present disclosure to trigger or initiate TCI state(s)/beam(s) change/switch (i.e., resource indicators for TCI state(s)/beam(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)). For this case, which Kg out of the Ng reported groups of resource indicators (e.g., in terms of their positions/orderings among the Ng reported groups of resource indicators and/or in the beam/CSI report) and/or the value of Kg could be: (i) configured/indicated by the network, e.g., via higher layer RRC signaling/parameter and/or MAC CE command and/or dynamic DCI based L1 signaling (e.g., by one or more indicators/bitmaps/etc.), (ii) fixed in system specification(s), and/or (iii) autonomously determined/selected by the UE, and/or reported to the network, e.g., in part of a/the CSI/beam report and/or UE capability signaling.
In yet another example, the UE could send to the network, e.g., in the CSI/beam report, one or more (e.g., Ng≥1) groups of resource indicators such as SSBRIs and/or CRIs with each group comprising Mg≥1 resource indicators SSBRIs/CRIs and/or the Ng groups comprising the total L resource indicators SSBRIs/CRIs consecutively. For this example, L=Ng×Mg. The beam metrics such as the L1-RSRPs/L1-SINRs corresponding/associated to the resource indicators could also be reported in the same CSI/beam report. The number Ng of the reported groups and/or the number Mg of the reported resource indicators in each group could be: (i) configured/provided/indicated by the network, e.g., via higher layer RRC signaling(s)/parameter(s) and/or MAC CE command and/or dynamic DCI based L1 signaling, (ii) determined based on/according to fixed rule(s) in system specification(s), and/or (iii) autonomously determined by the UE, and/or reported by the UE to the network, e.g., in part of the CSI/beam report and/or UE capability signaling. For this case, each of one or more of the reported groups of resource indicators SSBRIs/CRIs in the CSI/beam report could be associated with/to an indicator, wherein the indicator(s) could also be reported in the same CSI/beam report. For instance, when/if a reported indicator is set to ‘1’ (or ‘0’) or ‘enabled’ (or ‘disabled’) or ‘on’ (or ‘off’), the group of Mg resource indicators SSBRIs/CRIs associated/corresponding to the reported indicator could be used as (1) the indicator(s) as specified herein in the present disclosure to trigger or initiate TCI state(s)/beam(s) change/switch (i.e., resource indicators for TCI state(s)/beam(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)).
In yet another example, the UE could send to the network, e.g., in the CSI/beam report, one or more (e.g., Ng≥1) groups of resource indicators such as SSBRIs and/or CRIs with each group comprising Mg≥1 resource indicators SSBRIs/CRIs and/or the Ng groups comprising the total L resource indicators SSBRIs/CRIs consecutively. For this example, L=Ng×Mg. The beam metrics such as the L1-RSRPs/L1-SINRs corresponding/associated to the resource indicators could also be reported in the same CSI/beam report. The number Ng of the reported groups and/or the number Mg of the reported resource indicators in each group could be: (i) configured/provided/indicated by the network, e.g., via higher layer RRC signaling(s)/parameter(s) and/or MAC CE command and/or dynamic DCI based L1 signaling, (ii) determined based on/according to fixed rule(s) in system specification(s), and/or (iii) autonomously determined by the UE, and/or reported by the UE (e.g., the UE 116) to the network, e.g., in part of the CSI/beam report and/or UE capability signaling. For this case, a bitmap (e.g., of length Ng) with each entry/bit position corresponding/associated to a reported group of resource indicators SSBRIs/CRIs could be included in the same CSI/beam report. For instance, the first entry/bit position of the reported bitmap could correspond to the first (or last) reported group of resource indicators SSBRIs/CRIs, e.g., among the Ng reported groups of resource indicators SSBRIs/CRIs in the CSI/beam report, the second entry/bit position of the reported bitmap could correspond to the second (or second last) reported group of resource indicators SSBRIs/CRIs, e.g., among the Ng reported groups of resource indicators in the CSI/beam report, and so on. For this case, when/if an entry/bit position of the bitmap is set to ‘1’ (or ‘0’), the reported group of Mg resource indicators SSBRIs/CRIs associated/corresponding to the entry/bit position could be used as (1) the indicator(s) as specified herein in the present disclosure to trigger or initiate TCI state(s)/beam(s) change/switch (i.e., resource indicators for TCI state(s)/beam(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)).
In yet another example, the UE could send to the network (e.g., the network 130) the CSI/beam report in two parts (i.e., a two-part UCI). Part 1 of the two-part CSI/beam report or UCI could be of fixed payload size, and could indicate/provide at least one or more or one or more groups of first resource indicators SSBRIs/CRIs and their corresponding/associated beam metrics L1-RSRPs/L1-SINRs; furthermore, part 1 of the two-part CSI/beam report or UCI could also indicate/provide payload size of part 2 of the two-part CSI/beam report or UCI including, e.g., number of resource indicators/beam metrics indicated/provided in part 2. Part 2 of the two-part CSI/beam report or UCI could indicate/provide at least one or more or one or more groups of second resource indicators SSBRIs/CRIs and their corresponding/associated beam metrics L1-RSRPs/L1-SINRs. For this design example, the reported first resource indicator(s) SSBRI(s)/CRI(s) in part 1 of the two-part CSI/beam report or UCI and/or the reported second resource indicator(s) SSBRI(s)/CRI(s) in part 2 of the two-part CSI/beam report or UCI could be used as (1) the indicator(s) as specified herein in the present disclosure to trigger or initiate TCI state(s)/beam(s) change/switch (i.e., resource indicators for TCI state(s)/beam(s) switching/change), (2) resource indicators for beam(s)/TCI state(s) reporting, (3) resource indicators for beam(s)/TCI state(s) activation/sub-selection, and/or (4) candidate resource indicators from which one or more resource indicators-used as the indicator(s) as specified herein in the present disclosure to trigger or initiate TCI state(s)/beam(s) change/switch (i.e., for TCI state(s)/beam(s) switching/change/update)—can be selected and reported, according to those specified herein in the present disclosure (e.g., based on/according to fixed rule(s)/value(s) in system specification(s) and/or network's configuration(s)/indication(s)/signaling(s), e.g., via higher layer RRC signaling(s)/parameter(s) and/or MAC CE command(s) and/or dynamic DCI based L1 signaling, and/or UE's autonomous determination/selection, which could be further reported to the network, e.g., via/in part of a/the CSI/beam report and/or UE's capability signaling(s)).

The UE could send to the network, e.g., in a/the CSI/beam report, one or more resource indicators determined/selected from (one or more groups of) Lg (Lg≥1) reported candidate resource indicators according to those specified herein in the present disclosure, wherein the one or more resource indicators could be used as the indicator(s) as specified herein in the present disclosure, to trigger or initiate TCI state(s)/beam(s) change/switch. The UE could follow those specified herein in the present disclosure (e.g., according to one or more examples described herein) to determine/select and report the one or more resource indicators—from the Lg candidate resource indicators—to trigger or initiate TCI state(s)/beam(s) change/switch. Specifically, for (one or more groups of) Lg (Lg≥1) reported candidate resource indicators SSBRIs/CRIs:
In one example, the first (or last) or k′-th reported resource indicator SSBRI/CRI, e.g., among the Lg candidate resource indicators SSBRIs/CRIs or the components comprising/indicating at least the Lg candidate resource indicators and their corresponding/associated beam metrics reported in the CSI/beam report, could be used as the indicator(s) as specified herein in the present disclosure to trigger or initiate a TCI state/beam change/switch (i.e., used as a resource indicator for TCI state(s)/beam(s) switching/change/update). In the present disclosure, the value of k′ could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In another example, the reported resource indicator SSBRI/CRI with the highest (or lowest) measured beam metric L1-RSRP/L1-SINR, e.g., among the Lg candidate resource indicators SSBRIs/CRIs or the components comprising/indicating at least the Lg candidate resource indicators and their corresponding/associated beam metrics reported in the CSI/beam report, could be used as the indicator(s) as specified herein in the present disclosure to trigger or initiate a TCI state/beam change/switch (i.e., used as a resource indicator for TCI state(s)/beam(s) switching/change/update).
In yet another example, the reported resource indicator SSBRI/CRI with the k′-th highest (or lowest) measured beam metric L1-RSRP/L1-SINR, e.g., among the Lg candidate resource indicators SSBRIs/CRIs or the components comprising/indicating at least the Lg candidate resource indicators and their corresponding/associated beam metrics reported in the CSI/beam report, could be used as the indicator(s) as specified herein in the present disclosure to trigger or initiate a TCI state/beam change/switch (i.e., used as a resource indicator for TCI state(s)/beam(s) switching/change/update). In the present disclosure, the value of k′ could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In another example, the resource indicator SSBRI/CRI reported in the first (or last) or k′-th CSI field, e.g., among the CSI fields that comprise/indicate at least the Lg candidate resource indicators in the CSI/beam report, could be used as the indicator(s) as specified herein in the present disclosure to trigger or initiate a TCI state/beam change/switch (i.e., used as a resource indicator for TCI state(s)/beam(s) switching/change/update). In the present disclosure, the value of k′ could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the reported resource indicator SSBRI/CRI corresponding to the lowest/first (or highest/last) or k′-th or k′-th lowest/highest CSI report number, e.g., among the CSI reports/CSI report numbers corresponding to at least the Lg candidate resource indicators SSBRIs/CRIs in the CSI/beam report, could be used as the indicator(s) as specified herein in the present disclosure to trigger or initiate a TCI state/beam change/switch (i.e., used as a resource indicator for TCI state(s)/beam(s) switching/change/update). In the present disclosure, the value of k′ could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the first (or last) lg (1≤lg≤Lg) reported resource indicators SSBRIs/CRIs, e.g., among the Lg candidate resource indicators SSBRIs/CRIs or the components comprising/indicating at least the Lg candidate resource indicators and their corresponding/associated beam metrics reported in the CSI/beam report, could be used as the indicator(s) as specified herein in the present disclosure to trigger or initiate TCI state(s)/beam(s) change/switch (i.e., used as resource indicators for TCI state(s)/beam(s) switching/change/update). In the present disclosure, the value of lg could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the lg (1≤lg≤Lg) reported resource indicators SSBRIs/CRIs with the highest (or lowest) lg measured beam metrics L1-RSRPs/L1-SINRs, e.g., among the Lg candidate resource indicators SSBRIs/CRIs or the components comprising/indicating at least the Lg candidate resource indicators and their corresponding/associated beam metrics reported in the CSI/beam report, could be used as the indicator(s) as specified herein in the present disclosure to trigger or initiate TCI state(s)/beam(s) change/switch (i.e., used as resource indicators for TCI state(s)/beam(s) switching/change/update). In the present disclosure, the value of lg could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the reported resource indicators SSBRIs/CRIs with the measured beam metrics L1-RSRPs/L1-SINRs—e.g., among the Lg candidate resource indicators SSBRIs/CRIs or the components comprising/indicating at least the Lg candidate resource indicators and their corresponding/associated beam metrics reported in the CSI/beam report-higher (or lower) than a threshold could be used as the indicator(s) as specified herein in the present disclosure to trigger or initiate TCI state(s)/beam(s) change/switch (i.e., used as resource indicators for TCI state(s)/beam(s) switching/change/update). The threshold value could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the resource indicators SSBRIs/CRIs reported in the first (or last) lg (1≤lg≤Lg) CSI fields, e.g., among the CSI fields that comprise/indicate at least the Lg candidate resource indicators SSBRIs/CRIs in the CSI/beam report, could be used as the indicator(s) as specified herein in the present disclosure to trigger or initiate TCI state(s)/beam(s) change/switch (i.e., used as resource indictors for TCI state(s)/beam(s) switching/change/update). In the present disclosure, the value of lg could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, the reported resource indicators SSBRIs/CRIs corresponding to the lowest/first (or highest/last) lg (1≤lg≤Lg) CSI report numbers, e.g., among the CSI reports/CSI report numbers corresponding to at least the Lg candidate resource indicators SSBRIs/CRIs in the CSI/beam report, could be used as the indicator(s) as specified herein in the present disclosure to trigger or initiate TCI state(s)/beam(s) change/switch (i.e., used as resource indicators for TCI state(s)/beam(s) switching/change/update). In the present disclosure, the value of lg could be: (i) configured/indicated by the network, e.g., via higher layer RRC signaling/parameter and/or MAC CE command and/or dynamic DCI based L1 signaling, (ii) fixed in system specification(s), and/or (iii) autonomously determined/selected by the UE, and/or reported to the network, e.g., in part of a/the CSI/beam report and/or UE capability signaling.
In yet another example, lg (1≤lg≤Lg) reported resource indicators SSBRIs/CRIs, e.g., among the Lg candidate resource indicators SSBRIs/CRIs or the components comprising/indicating at least the Lg candidate resource indicators and their corresponding/associated beam metrics reported in the CSI/beam report, could be used as the indicator(s) as specified herein in the present disclosure to trigger or initiate TCI state(s)/beam(s) change/switch (i.e., used as resource indicators for TCI state(s)/beam(s) switching/change/update), wherein which lg out of the Lg reported candidate resource indicators (e.g., in terms of their positions/orderings among the Lg reported candidate resource indicators and/or in the beam/CSI report) and/or the value of lg could be: (i) configured/indicated by the network, e.g., via higher layer RRC signaling/parameter and/or MAC CE command and/or dynamic DCI based L1 signaling (e.g., by one or more indicators/bitmaps/etc.), (ii) fixed in system specification(s), and/or (iii) autonomously determined/selected by the UE, and/or reported to the network, e.g., in part of a/the CSI/beam report and/or UE capability signaling.
In yet another example, each of one or more of the Lg reported candidate resource indicators SSBRIs/CRIs in the CSI/beam report could be associated with/to an indicator, wherein the indicator(s) could also be reported in the same CSI/beam report. For instance, when/if a reported indicator is set to ‘1’ (or ‘0’) or ‘enabled’ (or ‘disabled’) or ‘on’ (or ‘off’), the candidate resource indicator SSBRI/CRI associated/corresponding to the reported indicator could be used as the indicator as specified herein in the present disclosure to trigger or initiate a TCI state/beam change/switch (i.e., used as a resource indicator for TCI state(s)/beam(s) switching/change/update).
In yet another example, a bitmap (e.g., of length Lg) with each entry/bit position corresponding/associated to a reported candidate resource indicator SSBRI/CRI could be included in the same CSI/beam report. For instance, the first entry/bit position of the reported bitmap could correspond to the first (or last) reported resource indicator SSBRI/CRI, e.g., among the Lg candidate resource indicators SSBRIs/CRIs or the components comprising/indicating at least the Lg candidate resource indicators and their corresponding/associated beam metrics reported in the CSI/beam report, or the resource indicator SSBRI/CRI reported in the first (or last) CSI field, e.g., among the CSI fields that comprise/indicate at least the Lg candidate resource indicators SSBRIs/CRIs in the CSI/beam report, or the reported resource indicator SSBRI/CRI corresponding to the lowest/first (or highest/last) CSI report number, e.g., among the CSI reports/CSI report numbers corresponding to at least the Lg candidate resource indicators SSBRIs/CRIs in the CSI/beam report, the second entry/bit position of the reported bitmap could correspond to the second (or second last) reported resource indicator SSBRI/CRI, e.g., among the Lg candidate resource indicators SSBRIs/CRIs or the components comprising/indicating at least the Lg candidate resource indicators and their corresponding/associated beam metrics reported in the CSI/beam report, or the resource indicator SSBRI/CRI reported in the second (or second last) CSI field, e.g., among the CSI fields that comprise/indicate at least the Lg candidate resource indicators SSBRIs/CRIs in the CSI/beam report, or the reported resource indicator SSBRI/CRI corresponding to the second lowest/second (or second highest/second last) CSI report number, e.g., among the CSI reports/CSI report numbers corresponding to at least the Lg candidate resource indicators SSBRIs/CRIs in the CSI/beam report, and so on. For this case, when/if an entry/bit position of the bitmap is set to ‘1’ (or ‘0’), the candidate resource indicator SSBRI/CRI associated/corresponding to the entry/bit position could be used as the indicator as specified herein in the present disclosure to trigger or initiate a TCI state/beam change/switch (i.e., used as a resource indicator for TCI state(s)/beam(s) switching/change/update).
In yet another example, the UE could send to the network the CSI/beam report in two parts (i.e., a two-part UCI). Part 1 of the two-part CSI/beam report or UCI could be of fixed payload size, and could indicate/provide at least one or more or one or more groups of first resource indicators SSBRIs/CRIs and their corresponding/associated beam metrics L1-RSRPs/L1-SINRs; furthermore, part 1 of the two-part CSI/beam report or UCI could also indicate/provide payload size of part 2 of the two-part CSI/beam report or UCI including, e.g., number of resource indicators/beam metrics indicated/provided in part 2. Part 2 of the two-part CSI/beam report or

UCI could indicate/provide at least one or more or one or more groups of second resource indicators SSBRIs/CRIs and their corresponding/associated beam metrics L1-RSRPs/L1-SINRs. For this design example, the reported first resource indicator(s) SSBRI(s)/CRI(s) in part 1 of the two-part CSI/beam report or UCI and/or the reported second resource indicator(s) SSBRI(s)/CRI(s) in part 2 of the two-part CSI/beam report or UCI could be from the reported Lg candidate resource indicators and used as the indicator(s) as specified herein in the present disclosure to trigger or initiate TCI state(s)/beam(s) change/switch (i.e., used as resource indicator(s) for TCI state(s)/beam(s) switching/change/update).

For the described/specified design examples in the present disclosure (e.g., according to one or more examples described herein), the UE could be indicated/provided/configured by the network, e.g., via higher layer RRC signaling(s)/parameter(s) and/or MAC CE command(s) and/or dynamic DCI based L1 signaling(s), whether the CSI/beam report(s)—and therefore, the resource indicator(s) and the corresponding/associated beam metric(s) provided/indicated therein-could be for beam(s)/TCI state(s) reporting and/or beam(s)/TCI state(s) activation/deactivation and/or beam(s)/TCI state(s) switching/change according to those specified herein in the present disclosure, and/or whether the CSI/beam report(s) could comprise/include/contain/provide/indicate resource indicator(s) for beam(s)/TCI state(s) reporting and/or beam(s)/TCI state(s) activation/deactivation and/or beam(s)/TCI state(s) switching/change according to those specified herein in the present disclosure.
In one example, the UE could be indicated/provided/configured by the network, e.g., via higher layer RRC signaling(s)/parameter(s) and/or MAC CE command(s) and/or dynamic DCI based L1 signaling(s), an indicator (e.g., a one-bit indicator) to indicate whether the CSI/beam report(s)—and therefore, the resource indicator(s) and the corresponding/associated beam metric(s) provided/indicated therein-could be for beam(s)/TCI state(s) reporting and/or beam(s)/TCI state(s) activation/deactivation and/or beam(s)/TCI state(s) switching/change according to those specified herein in the present disclosure, and/or whether the CSI/beam report(s) could comprise/include/contain/provide/indicate resource indicator(s) for beam(s)/TCI state(s) reporting and/or beam(s)/TCI state(s) activation/deactivation and/or beam(s)/TCI state(s) switching/change according to those specified herein in the present disclosure. For instance, when/if the (one-bit) indicator is set to ‘1’ (or ‘0’) or ‘enabled’ (or ‘disabled’) or ‘on’ (or ‘off’), the CSI/beam report(s) could be for or one or more of the resource indicator(s) and the associated/corresponding beam metric(s) in the CSI/beam report(s) could be for:
   TCI state(s)/beam(s) reporting,
   TCI state(s)/beam(s) activation/deactivation, and/or
   TCI state(s)/beam(s) switching/change/update.
For example, when/if the CSI/beam report(s) or one or more of the resource indicator(s) and the associated/corresponding beam metric(s) in the CSI/beam report(s) is for TCI state(s)/beam(s) reporting according to those specified herein in the present disclosure when/if the (one-bit) indicator is set to ‘1’ (or ‘0’) or ‘enabled’ (or ‘disabled’) or ‘on’ (or ‘off’), when/if the (one-bit) indicator is set to ‘0’ (or ‘1’) or ‘disabled’ (or ‘enabled’) or ‘off’ (or ‘on’), the CSI/beam report(s) could be for or one or more of the resource indicator(s) and the associated/corresponding beam metric(s) in the CSI/beam report(s) could be for TCI state(s)/beam(s) activation/deactivation and/or TCI state(s)/beam(s) switching/change/update. For another example, when/if the CSI/beam report(s) or one or more of the resource indicator(s) and the associated/corresponding beam metric(s) in the CSI/beam report(s) is for TCI state(s)/beam(s) activation/deactivation according to those specified herein in the present disclosure when/if the (one-bit) indicator is set to ‘1’ (or ‘0’) or ‘enabled’ (or ‘disabled’) or ‘on’ (or ‘off’), when/if the (one-bit) indicator is set to ‘0’ (or ‘1’) or ‘disabled’ (or ‘enabled’) or ‘off’ (or ‘on’), the CSI/beam report(s) could be for or one or more of the resource indicator(s) and the associated/corresponding beam metric(s) in the CSI/beam report(s) could be for TCI state(s)/beam(s) reporting and/or TCI state(s)/beam(s) switching/change/update. Yet for another example, when/if the CSI/beam report(s) or one or more of the resource indicator(s) and the associated/corresponding beam metric(s) in the CSI/beam report(s) is for TCI state(s)/beam(s) switching/change/update according to those specified herein in the present disclosure when/if the (one-bit) indicator is set to ‘1’ (or ‘0’) or ‘enabled’ (or ‘disabled’) or ‘on’ (or ‘off’), when/if the (one-bit) indicator is set to ‘0’ (or ‘1’) or ‘disabled’ (or ‘enabled’) or ‘off’ (or ‘on’), the CSI/beam report(s) could be for or one or more of the resource indicator(s) and the associated/corresponding beam metric(s) in the CSI/beam report(s) could be for TCI state(s)/beam(s) activation/deactivation and/or TCI state(s)/beam(s) reporting.
In another example, the UE could be indicated/provided/configured by the network, e.g., via higher layer RRC signaling(s)/parameter(s) and/or MAC CE command(s) and/or dynamic DCI based L1 signaling(s), an indicator (e.g., a two-bit indicator) to indicate whether the CSI/beam report(s)—and therefore, the resource indicator(s) and the corresponding/associated beam metric(s) provided/indicated therein-could be for beam(s)/TCI state(s) reporting and/or beam(s)/TCI state(s) activation/deactivation and/or beam(s)/TCI state(s) switching/change according to those specified herein in the present disclosure, and/or whether the CSI/beam report(s) could comprise/include/contain/provide/indicate resource indicator(s) for beam(s)/TCI state(s) reporting and/or beam(s)/TCI state(s) activation/deactivation and/or beam(s)/TCI state(s) switching/change according to those specified herein in the present disclosure. For instance, when/if the (two-bit) indicator is set to ‘00’ or ‘01’ or ‘10’ or ‘11’, the CSI/beam report(s) could be for or one or more of the resource indicator(s) and the associated/corresponding beam metric(s) in the CSI/beam report(s) could be for:
   TCI state(s)/beam(s) reporting,
   TCI state(s)/beam(s) activation/deactivation, and/or
   TCI state(s)/beam(s) switching/change/update.
For instance, when/if the (two-bit) indicator is set to ‘00’ (or ‘01’, ‘10’ or ‘11’), the CSI/beam report(s) could be for or one or more of the resource indicator(s) and the associated/corresponding beam metric(s) in the CSI/beam report(s) could be for TCI state(s)/beam(s) reporting according to those specified herein in the present disclosure, and/or when/if the (two-bit) indicator is set to ‘01’ (or ‘00’ or ‘10’ or ‘11’), the CSI/beam report(s) could be for or one or more of the resource indicator(s) and the associated/corresponding beam metric(s) in the CSI/beam report(s) could be for TCI state(s)/beam(s) activation/deactivation according to those specified herein in the present disclosure, and/or when/if the (two-bit) indicator is set to ‘10’ (or ‘00’ or ‘01’ or ‘11’), the CSI/beam report(s) could be for or one or more of the resource indicator(s) and the associated/corresponding beam metric(s) in the CSI/beam report(s) could be for TCI state(s)/beam(s) switching/change/update according to those specified herein in the present disclosure.
In yet another example, the UE could be indicated/provided/configured by the network, e.g., via higher layer RRC signaling(s)/parameter(s) and/or MAC CE command(s) and/or dynamic DCI based L1 signaling(s), a bitmap to indicate whether the CSI/beam report(s)—and therefore, the resource indicator(s) and the corresponding/associated beam metric(s) provided/indicated therein
could be for beam(s)/TCI state(s) reporting and/or beam(s)/TCI state(s) activation/deactivation and/or beam(s)/TCI state(s) switching/change according to those specified herein in the present disclosure, and/or whether the CSI/beam report(s) could comprise/include/contain/provide/indicate resource indicator(s) for beam(s)/TCI state(s) reporting and/or beam(s)/TCI state(s) activation/deactivation and/or beam(s)/TCI state(s) switching/change according to those specified herein in the present disclosure. For instance, a first entry/bit position of the bitmap could correspond to or indicate beam(s)/TCI state(s) reporting, a second entry/bit position of the bitmap could correspond to or indicate beam(s)/TCI state(s) activation/deactivation and a third entry/bit position of the bitmap could correspond to or indicate beam(s)/TCI state(s) switching/change/update. For this design example, when/if the first entry/bit position is set to ‘1’ (or ‘0’), the CSI/beam report(s) could be for or one or more of the resource indicator(s) and the associated/corresponding beam metric(s) in the CSI/beam report(s) could be for TCI state(s)/beam(s) reporting according to those specified herein in the present disclosure, and/or when/if the second entry/bit position is set to ‘1’ (or ‘0’), the CSI/beam report(s) could be for or one or more of the resource indicator(s) and the associated/corresponding beam metric(s) in the CSI/beam report(s) could be for TCI state(s)/beam(s) activation/deactivation according to those specified herein in the present disclosure, and/or when/if the third entry/bit position is set to ‘1’ (or ‘0’), the CSI/beam report(s) could be for or one or more of the resource indicator(s) and the associated/corresponding beam metric(s) in the CSI/beam report(s) could be for TCI state(s)/beam(s) switching/change/update according to those specified herein in the present disclosure.
In yet another example, the UE could be provided/indicated/configured by the network, e.g., in the higher layer parameter CSI-ReportConfig, the higher layer parameter ‘reportQuantity’ set to one or more particular values to indicate that the CSI/beam report(s) could be for or one or more of the resource indicator(s) and the associated/corresponding beam metric(s) in the CSI/beam report(s) could be for TCI state(s)/beam(s) reporting and/or TCI state(s)/beam(s) activation/deactivation/sub-selection and/or TCI state(s)/beam(s) switching/change according to those specified herein in the present disclosure.
   For example, when/if the higher layer parameter ‘reportQuantity’ is set to ‘beamReporting’ and/or one or more of: cri-RSRP, ssb-index-RSRP, cri-SINR, ssb-index-SINR, the CSI/beam report(s) could be for or one or more of the resource indicator(s) and the associated/corresponding beam metric(s) in the CSI/beam report(s) could be for TCI state(s)/beam(s) reporting according to those specified herein in the present disclosure.
   For another example, when/if the higher layer parameter ‘reportQuantity’ is set to ‘beamActivation’ and/or ‘none’ and/or a higher layer parameter, e.g., provided/configured in CSI-ReportConfig, that configures/enables using reported resource indicator(s) for TCI state(s)/beam(s) activation/deactivation/sub-selection according to those specified herein in the present disclosure—e.g., denoted by resourceIndicatorForBeamActivation—is set to ‘enabled’ and/or other relevant parameter(s)/signaling(s) is configured/enabled/disabled, the CSI/beam report(s) could be for or one or more of the resource indicator(s) and the associated/corresponding beam metric(s) in the CSI/beam report(s) could be for TCI state(s)/beam(s) activation/deactivation according to those specified herein in the present disclosure.
   Yet for another example, when/if the higher layer parameter ‘reportQuantity’ is set to ‘beamSwitching’ and/or ‘none’ and/or a higher layer parameter, e.g., provided/configured in CSI-ReportConfig, that configures/enables using reported resource indicator(s) for TCI state(s)/beam(s) switching/change according to those specified herein in the present disclosure—e.g., denoted by resourceIndicatorForBeamSwitching—is set to ‘enabled’ and/or other relevant parameter(s)/signaling(s) is configured/enabled/disabled, the CSI/beam report(s) could be for or one or more of the resource indicator(s) and the associated/corresponding beam metric(s) in the CSI/beam report(s) could be for TCI state(s)/beam(s) switching/change according to those specified herein in the present disclosure.

For the described/specified design examples in the present disclosure (e.g., according to one or more examples described herein), the UE (e.g., the UE 116) could send to the network (e.g., the network 130), e.g., in a/the CSI/beam report(s) (e.g., via PUSCH MAC CE and/or UCI), whether the CSI/beam report(s)—and therefore, the resource indicator(s) and the corresponding/associated beam metric(s) provided/indicated therein-could be for beam(s)/TCI state(s) reporting and/or beam(s)/TCI state(s) activation/deactivation and/or beam(s)/TCI state(s) switching/change according to those specified herein in the present disclosure, and/or whether the CSI/beam report(s) could comprise/include/contain/provide/indicate resource indicator(s) for beam(s)/TCI state(s) reporting and/or beam(s)/TCI state(s) activation/deactivation and/or beam(s)/TCI state(s) switching/change according to those specified herein in the present disclosure.
In one example, the UE could send to the network, e.g., via/in the CSI/beam report(s) (e.g., through PUSCH MAC CE and/or UCI), an indicator (e.g., a one-bit indicator) to indicate whether the CSI/beam report(s)—and therefore, the resource indicator(s) and the corresponding/associated beam metric(s) provided/indicated therein-could be for beam(s)/TCI state(s) reporting and/or beam(s)/TCI state(s) activation/deactivation and/or beam(s)/TCI state(s) switching/change according to those specified herein in the present disclosure, and/or whether the CSI/beam report(s) could comprise/include/contain/provide/indicate resource indicator(s) for beam(s)/TCI state(s) reporting and/or beam(s)/TCI state(s) activation/deactivation and/or beam(s)/TCI state(s) switching/change according to those specified herein in the present disclosure. For instance, when/if the (one-bit) indicator in the CSI/beam report(s) is set to ‘1’ (or ‘0’) or ‘enabled’ (or ‘disabled’) or ‘on’ (or ‘off’), the CSI/beam report(s) could be for or one or more of the resource indicator(s) and the associated/corresponding beam metric(s) in the CSI/beam report(s) could be for:
   TCI state(s)/beam(s) reporting,
   TCI state(s)/beam(s) activation/deactivation, and/or
   TCI state(s)/beam(s) switching/change/update.
For example, when/if the CSI/beam report(s) or one or more of the resource indicator(s) and the associated/corresponding beam metric(s) in the CSI/beam report(s) is for TCI state(s)/beam(s) reporting according to those specified herein in the present disclosure when/if the (one-bit) indicator in the CSI/beam report(s) is set to ‘1’ (or ‘0’) or ‘enabled’ (or ‘disabled’) or ‘on’ (or ‘off’), when/if the (one-bit) indicator in the CSI/beam report(s) is set to ‘0’ (or ‘1’) or ‘disabled’ (or ‘enabled’) or ‘off’ (or ‘on’), the CSI/beam report(s) could be for or one or more of the resource indicator(s) and the associated/corresponding beam metric(s) in the CSI/beam report(s) could be for TCI state(s)/beam(s) activation/deactivation and/or TCI state(s)/beam(s) switching/change/update. For another example, when/if the CSI/beam report(s) or one or more of the resource indicator(s) and the associated/corresponding beam metric(s) in the CSI/beam report(s) is for TCI state(s)/beam(s) activation/deactivation according to those specified herein in the present disclosure when/if the (one-bit) indicator in the CSI/beam report(s) is set to ‘1’ (or ‘0’) or ‘enabled’ (or ‘disabled’) or ‘on’ (or ‘off’), when/if the (one-bit) indicator in the CSI/beam report(s) is set to ‘0’ (or ‘1’) or ‘disabled’ (or ‘enabled’) or ‘off’ (or ‘on’), the CSI/beam report(s) could be for or one or more of the resource indicator(s) and the associated/corresponding beam metric(s) in the CSI/beam report(s) could be for TCI state(s)/beam(s) reporting and/or TCI state(s)/beam(s) switching/change/update. Yet for another example, when/if the CSI/beam report(s) or one or more of the resource indicator(s) and the associated/corresponding beam metric(s) in the CSI/beam report(s) is for TCI state(s)/beam(s) switching/change/update according to those specified herein in the present disclosure when/if the (one-bit) indicator in the CSI/beam report(s) is set to ‘1’ (or ‘0’) or ‘enabled’ (or ‘disabled’) or ‘on’ (or ‘off’), when/if the (one-bit) indicator in the CSI/beam report(s) is set to ‘0’ (or ‘1’) or ‘disabled’ (or ‘enabled’) or ‘off’ (or ‘on’), the CSI/beam report(s) could be for or one or more of the resource indicator(s) and the associated/corresponding beam metric(s) in the CSI/beam report(s) could be for TCI state(s)/beam(s) activation/deactivation and/or TCI state(s)/beam(s) reporting.
In another example, the UE could send to the network, e.g., via/in the CSI/beam report(s) (e.g., through PUSCH MAC CE and/or UCI), an indicator (e.g., a two-bit indicator) to indicate whether the CSI/beam report(s)—and therefore, the resource indicator(s) and the corresponding/associated beam metric(s) provided/indicated therein-could be for beam(s)/TCI state(s) reporting and/or beam(s)/TCI state(s) activation/deactivation and/or beam(s)/TCI state(s) switching/change according to those specified herein in the present disclosure, and/or whether the CSI/beam report(s) could comprise/include/contain/provide/indicate resource indicator(s) for beam(s)/TCI state(s) reporting and/or beam(s)/TCI state(s) activation/deactivation and/or beam(s)/TCI state(s) switching/change according to those specified herein in the present disclosure. For instance, when/if the (two-bit) indicator in the CSI/beam report(s) is set to ‘00’ or ‘01’ or ‘10’ or ‘11’, the CSI/beam report(s) could be for or one or more of the resource indicator(s) and the associated/corresponding beam metric(s) in the CSI/beam report(s) could be for:
   TCI state(s)/beam(s) reporting,
   TCI state(s)/beam(s) activation/deactivation, and/or
   TCI state(s)/beam(s) switching/change/update.
For instance, when/if the (two-bit) indicator in the CSI/beam report(s) is set to ‘00’ (or ‘01’, ‘10’ or ‘11’), the CSI/beam report(s) could be for or one or more of the resource indicator(s) and the associated/corresponding beam metric(s) in the CSI/beam report(s) could be for TCI state(s)/beam(s) reporting according to those specified herein in the present disclosure, and/or when/if the (two-bit) indicator in the CSI/beam report(s) is set to ‘01’ (or ‘00’ or ‘10’ or ‘11’), the CSI/beam report(s) could be for or one or more of the resource indicator(s) and the associated/corresponding beam metric(s) in the CSI/beam report(s) could be for TCI state(s)/beam(s) activation/deactivation according to those specified herein in the present disclosure, and/or when/if the (two-bit) indicator in the CSI/beam report(s) is set to ‘10’ (or ‘00’ or ‘01’ or ‘11’), the CSI/beam report(s) could be for or one or more of the resource indicator(s) and the associated/corresponding beam metric(s) in the CSI/beam report(s) could be for TCI state(s)/beam(s) switching/change/update according to those specified herein in the present disclosure.
In yet another example, the UE could send to the network, e.g., via/in the CSI/beam report(s) (e.g., through PUSCH MAC CE and/or UCI), a bitmap to indicate whether the CSI/beam report(s)—and therefore, the resource indicator(s) and the corresponding/associated beam metric(s) provided/indicated therein-could be for beam(s)/TCI state(s) reporting and/or beam(s)/TCI state(s) activation/deactivation and/or beam(s)/TCI state(s) switching/change according to those specified herein in the present disclosure, and/or whether the CSI/beam report(s) could comprise/include/contain/provide/indicate resource indicator(s) for beam(s)/TCI state(s) reporting and/or beam(s)/TCI state(s) activation/deactivation and/or beam(s)/TCI state(s) switching/change according to those specified herein in the present disclosure. For instance, a first entry/bit position of the bitmap in the CSI/beam report(s) could correspond to or indicate beam(s)/TCI state(s) reporting, a second entry/bit position of the bitmap in the CSI/beam report(s) could correspond to or indicate beam(s)/TCI state(s) activation/deactivation and a third entry/bit position of the bitmap in the CSI/beam report(s) could correspond to or indicate beam(s)/TCI state(s) switching/change/update. For this design example, when/if the first entry/bit position of the bitmap in the CSI/beam report(s) is set to ‘1’ (or ‘0’), the CSI/beam report(s) could be for or one or more of the resource indicator(s) and the associated/corresponding beam metric(s) in the CSI/beam report(s) could be for TCI state(s)/beam(s) reporting according to those specified herein in the present disclosure, and/or when/if the second entry/bit position of the bitmap in the CSI/beam report(s) is set to ‘1’ (or ‘0’), the CSI/beam report(s) could be for or one or more of the resource indicator(s) and the associated/corresponding beam metric(s) in the CSI/beam report(s) could be for TCI state(s)/beam(s) activation/deactivation according to those specified herein in the present disclosure, and/or when/if the third entry/bit position of the bitmap in the CSI/beam report(s) is set to ‘1’ (or ‘0’), the CSI/beam report(s) could be for or one or more of the resource indicator(s) and the associated/corresponding beam metric(s) in the CSI/beam report(s) could be for TCI state(s)/beam(s) switching/change/update according to those specified herein in the present disclosure.

For the described/specified design examples in the present disclosure (e.g., according to one or more examples described herein), the UE/network could determine/identify, e.g., based on or according to one or more beam metric thresholds (e.g., one or more L1-RSRP thresholds and/or one or more L1-SINR thresholds), whether the CSI/beam report(s)—and therefore, the resource indicator(s) and the corresponding/associated beam metric(s) provided/indicated therein-could be for beam(s)/TCI state(s) reporting and/or beam(s)/TCI state(s) activation/deactivation and/or beam(s)/TCI state(s) switching/change according to those specified herein in the present disclosure, and/or whether the CSI/beam report(s) could comprise/include/contain/provide/indicate resource indicator(s) for beam(s)/TCI state(s) reporting and/or beam(s)/TCI state(s) activation/deactivation and/or beam(s)/TCI state(s) switching/change according to those specified herein in the present disclosure. The one or more beam metric thresholds could be (i) configured/indicated/provided by the network, e.g., via higher layer RRC signaling(s)/parameter(s) and/or MAC CE command(s) and/or dynamic DCI based L1 signaling(s), (ii) fixed value(s) provided/specified in system specification(s), and/or (iii) autonomously determined by the UE, and/or reported to the network, e.g., in part of the CSI/beam report and/or UE's capability signaling(s).
In one example, the UE could send to the network, e.g., in the CSI/beam report(s), one or more resource indicators SSBRIs/CRIs for TCI state(s)/beam(s) reporting when/if the beam metric(s) L1-RSRP(s)/L1-SINR(s) associated/corresponding to the one or more resource indicators is greater (or less) than a first beam metric L1-RSRP/L1-SINR threshold and/or/but less (or greater) than a second beam metric L1-RSRP/L1-SINR threshold; otherwise, the UE may not send to the network, e.g., in the CSI/beam report(s), any resource indicator(s) for TCI state(s)/beam(s) reporting. That is, when/if the beam metric(s) L1-RSRP(s)/L1-SINR(s) associated/corresponding to one or more resource indicators SSBRIs/CRIs reported in the CSI/beam report is greater (or less) than a first beam metric L1-RSRP/L1-SINR threshold and/or/but less (or greater) than a second beam metric L1-RSRP/L1-SINR threshold, the one or more resource indicators SSBRIs/CRIs could be used for beam(s)/TCI state(s) reporting according to those specified herein in the present disclosure; otherwise, none of the reported resource indicator(s) in the CSI/beam report(s) could be used for TCI state(s)/beam(s) reporting. For this design example, the first and/or second beam metric threshold(s) could be (i) configured/indicated/provided by the network, e.g., via higher layer RRC signaling(s)/parameter(s) and/or MAC CE command(s) and/or dynamic DCI based L1 signaling(s), (ii) fixed value(s) provided/specified in system specification(s), and/or (iii) autonomously determined by the UE, and/or reported to the network, e.g., in part of the CSI/beam report and/or UE's capability signaling(s).
In another example, the UE could send to the network, e.g., in the CSI/beam report(s), one or more resource indicators SSBRIs/CRIs for TCI state(s)/beam(s) activation/deactivation when/if the beam metric(s) L1-RSRP(s)/L1-SINR(s) associated/corresponding to the one or more resource indicators is greater (or less) than a third beam metric L1-RSRP/L1-SINR threshold and/or/but less (or greater) than a fourth beam metric L1-RSRP/L1-SINR threshold; otherwise, the UE may not send to the network, e.g., in the CSI/beam report(s), any resource indicator(s) for TCI state(s)/beam(s) activation/deactivation. That is, when/if the beam metric(s) L1-RSRP(s)/L1-SINR(s) associated/corresponding to one or more resource indicators SSBRIs/CRIs reported in the CSI/beam report is greater (or less) than a third beam metric L1-RSRP/L1-SINR threshold and/or/but less (or greater) than a fourth beam metric L1-RSRP/L1-SINR threshold, the one or more resource indicators SSBRIs/CRIs could be used for beam(s)/TCI state(s) activation/deactivation according to those specified herein in the present disclosure; otherwise, none of the reported resource indicator(s) in the CSI/beam report(s) could be used for beam(s)/TCI state(s) activation/deactivation. For this design example, the third and/or fourth beam metric threshold(s) could be (i) configured/indicated/provided by the network, e.g., via higher layer RRC signaling(s)/parameter(s) and/or MAC CE command(s) and/or dynamic DCI based L1 signaling(s), (ii) fixed value(s) provided/specified in system specification(s), and/or (iii) autonomously determined by the UE, and/or reported to the network, e.g., in part of the CSI/beam report and/or UE's capability signaling(s).
In yet another example, the UE could send to the network, e.g., in the CSI/beam report(s), one or more resource indicators SSBRIs/CRIs for TCI state(s)/beam(s) switching/change/update when/if the beam metric(s) L1-RSRP(s)/L1-SINR(s) associated/corresponding to the one or more resource indicators is greater (or less) than a fifth beam metric L1-RSRP/L1-SINR threshold and/or/but less (or greater) than a sixth beam metric L1-RSRP/L1-SINR threshold; otherwise, the UE may not send to the network, e.g., in the CSI/beam report(s), any resource indicator(s) for TCI state(s)/beam(s) switching/change/update. That is, when/if the beam metric(s) L1-RSRP(s)/L1-SINR(s) associated/corresponding to one or more resource indicators SSBRIs/CRIs reported in the CSI/beam report is greater (or less) than a fifth beam metric L1-RSRP/L1-SINR threshold and/or/but less (or greater) than a sixth beam metric L1-RSRP/L1-SINR threshold, the one or more resource indicators SSBRIs/CRIs could be used for beam(s)/TCI state(s) switching/change/update according to those specified herein in the present disclosure; otherwise, none of the reported resource indicator(s) in the CSI/beam report(s) could be used for TCI state(s)/beam(s) switching/change/update. For this design example, the fifth and/or sixth beam metric threshold(s) could be (i) configured/indicated/provided by the network, e.g., via higher layer RRC signaling(s)/parameter(s) and/or MAC CE command(s) and/or dynamic DCI based L1 signaling(s), (ii) fixed value(s) provided/specified in system specification(s), and/or (iii) autonomously determined by the UE, and/or reported to the network, e.g., in part of the CSI/beam report and/or UE's capability signaling(s).

The first beam metric threshold, and/or the second beam metric threshold, and/or the third beam metric threshold, and/or the fourth beam metric threshold, and/or the fifth beam metric threshold, and/or the sixth beam metric could be the same/identical and/or different. That is, one or more of the resource indicators reported in the CSI/beam report(s) could be for TCI state(s)/beam(s) reporting and/or TCI state(s)/beam(s) activation/deactivation and/or TCI state(s)/beam(s) change/switching/update, e.g., based on/according to relation(s) between their associated/corresponding beam metric(s) L1-RSRP(s)/L1-SINR(s) and the first, second, third, fourth, fifth and/or sixth beam metric threshold(s) as specified herein in the present disclosure.

For the described/specified design examples in the present disclosure (e.g., according to one or more examples described herein), the UE/network could determine/identify, e.g., based on or according to one or more resource groups, whether the CSI/beam report(s)—and therefore, the resource indicator(s) and the corresponding/associated beam metric(s) provided/indicated therein—could be for beam(s)/TCI state(s) reporting and/or beam(s)/TCI state(s) activation/deactivation and/or beam(s)/TCI state(s) switching/change according to those specified herein in the present disclosure, and/or whether the CSI/beam report(s) could comprise/include/contain/provide/indicate resource indicator(s) for beam(s)/TCI state(s) reporting and/or beam(s)/TCI state(s) activation/deactivation and/or beam(s)/TCI state(s) switching/change according to those specified herein in the present disclosure. Each of the one or more resource groups could comprise/include/contain/provide/configure/indicate one or more reference signal (RS) resources including SSB resource(s) and/or CSI-RS resource(s). The one or more resource groups—and therefore, the RS resource(s) provided/included/contained/comprised therein—could be (i) configured/indicated/provided by the network, e.g., via higher layer RRC signaling(s)/parameter(s) and/or MAC CE command(s) and/or dynamic DCI based L1 signaling(s), (ii) determined according to fixed rule(s)/value(s) provided/specified in system specification(s), and/or (iii) autonomously determined by the UE, and/or reported to the network, e.g., in part of the CSI/beam report and/or UE's capability signaling(s).
In one example, the UE could send to the network, e.g., in the CSI/beam report(s), one or more resource indicators SSBRIs/CRIs determined from/according to a first group of RS resources SSBs/CSI-RSs for TCI state(s)/beam(s) reporting. That is, when/if one or more resource indicators SSBRIs/CRIs are determined from/according to a first group of RS resources SSBs/CSI-RSs, they could be used for beam(s)/TCI state(s) reporting according to those specified herein in the present disclosure. When/if the UE could not determine/identify any resource indicator(s) for TCI state(s)/beam(s) reporting, none of the reported resource indicator(s) in the CSI/beam report(s) could be from the first group of RS resources SSBs/CSI-RSs. For this design example, the first resource group—and therefore, the RS resource(s) provided/included/contained/comprised therein—could be (i) configured/indicated/provided by the network, e.g., via higher layer RRC signaling(s)/parameter(s) and/or MAC CE command(s) and/or dynamic DCI based L1 signaling(s), (ii) determined according to fixed rule(s)/value(s) provided/specified in system specification(s), and/or (iii) autonomously determined by the UE, and/or reported to the network, e.g., in part of the CSI/beam report and/or UE's capability signaling(s).
In another example, the UE could send to the network, e.g., in the CSI/beam report(s), one or more resource indicators SSBRIs/CRIs determined from/according to a second group of RS resources SSBs/CSI-RSs for TCI state(s)/beam(s) activation/deactivation. That is, when/if one or more resource indicators SSBRIs/CRIs are determined from/according to a second group of RS resources SSBs/CSI-RSs, they could be used for beam(s)/TCI state(s) activation/deactivation according to those specified herein in the present disclosure. When/if the UE could not determine/identify any resource indicator(s) for TCI state(s)/beam(s) activation/deactivation, none of the reported resource indicator(s) in the CSI/beam report(s) could be from the second group of RS resources SSBs/CSI-RSs. For this design example, the second resource group—and therefore, the RS resource(s) provided/included/contained/comprised therein—could be (i) configured/indicated/provided by the network, e.g., via higher layer RRC signaling(s)/parameter(s) and/or MAC CE command(s) and/or dynamic DCI based L1 signaling(s), (ii) determined according to fixed rule(s)/value(s) provided/specified in system specification(s), and/or (iii) autonomously determined by the UE, and/or reported to the network, e.g., in part of the CSI/beam report and/or UE's capability signaling(s).
In yet another example, the UE could send to the network, e.g., in the CSI/beam report(s), one or more resource indicators SSBRIs/CRIs determined from/according to a third group of RS resources SSBs/CSI-RSs for TCI state(s)/beam(s) switching/change/update. That is, when/if one or more resource indicators SSBRIs/CRIs are determined from/according to a third group of RS resources SSBs/CSI-RSs, they could be used for beam(s)/TCI state(s) switching/change/update according to those specified herein in the present disclosure. When/if the UE could not determine/identify any resource indicator(s) for TCI state(s)/beam(s) switching/change/update, none of the reported resource indicator(s) in the CSI/beam report(s) could be from the third group of RS resources SSBs/CSI-RSs. For this design example, the third resource group—and therefore, the RS resource(s) provided/included/contained/comprised therein—could be (i) configured/indicated/provided by the network, e.g., via higher layer RRC signaling(s)/parameter(s) and/or MAC CE command(s) and/or dynamic DCI based L1 signaling(s), (ii) determined according to fixed rule(s)/value(s) provided/specified in system specification(s), and/or (iii) autonomously determined by the UE, and/or reported to the network, e.g., in part of the CSI/beam report and/or UE's capability signaling(s).

The first resource group, and/or the second resource group, and/or the third resource group could be the same/identical and/or different. That is, one or more of the resource indicators reported in the CSI/beam report(s) could be for TCI state(s)/beam(s) reporting and/or TCI state(s)/beam(s) activation/deactivation and/or TCI state(s)/beam(s) change/switching/update according to those specified herein in the present disclosure, e.g., based on/according to which of the first, second and/or third resource groups the resource indicator(s) is determined/selected from/according to.

For the described/specified design examples in the present disclosure (e.g., according to one or more examples described herein), the UE/network could determine/identify, e.g., based on or according to one or more groups of resource indicators, whether the CSI/beam report(s)—and therefore, the resource indicator(s) and the corresponding/associated beam metric(s) provided/indicated therein—could be for beam(s)/TCI state(s) reporting and/or beam(s)/TCI state(s) activation/deactivation and/or beam(s)/TCI state(s) switching/change according to those specified herein in the present disclosure, and/or whether the CSI/beam report(s) could comprise/include/contain/provide/indicate resource indicator(s) for beam(s)/TCI state(s) reporting and/or beam(s)/TCI state(s) activation/deactivation and/or beam(s)/TCI state(s) switching/change according to those specified herein in the present disclosure. Each of the one or more groups of resource indicators could comprise/include/contain/provide/configure/indicate one or more SSBRIs and/or CRIs. The one or more groups of resource indicators—and therefore, the resource indicator(s) SSBRI(s)/CRI(s) provided/included/contained/comprised therein—could be (i) configured/indicated/provided by the network, e.g., via higher layer RRC signaling(s)/parameter(s) and/or MAC CE command(s) and/or dynamic DCI based L1 signaling(s), (ii) determined according to fixed rule(s)/value(s) provided/specified in system specification(s), and/or (iii) autonomously determined by the UE, and/or reported to the network, e.g., in part of the CSI/beam report and/or UE's capability signaling(s).
In one example, the UE could send to the network, e.g., in the CSI/beam report(s), one or more resource indicators SSBRIs/CRIs from a first group of resource indicators SSBRIs/CRIs for TCI state(s)/beam(s) reporting. That is, when/if one or more resource indicators SSBRIs/CRIs are determined from/according to a first group of resource indicators SSBRIs/CRIs, they could be used for beam(s)/TCI state(s) reporting according to those specified herein in the present disclosure. When/if the UE could not determine/identify any resource indicator(s) for TCI state(s)/beam(s) reporting, none of the reported resource indicator(s) in the CSI/beam report(s) could be from the first group of resource indicators SSBRIs/CRIs. For this design example, the first group of resource indicators—and therefore, the resource indicator(s) provided/included/contained/comprised therein—could be (i) configured/indicated/provided by the network, e.g., via higher layer RRC signaling(s)/parameter(s) and/or MAC CE command(s) and/or dynamic DCI based L1 signaling(s), (ii) determined according to fixed rule(s)/value(s) provided/specified in system specification(s), and/or (iii) autonomously determined by the UE, and/or reported to the network, e.g., in part of the CSI/beam report and/or UE's capability signaling(s).
In another example, the UE could send to the network, e.g., in the CSI/beam report(s), one or more resource indicators SSBRIs/CRIs from a second group of resource indicators SSBRIs/CRIs for TCI state(s)/beam(s) activation/deactivation. That is, when/if one or more resource indicators SSBRIs/CRIs are determined from/according to a second group of resource indicators SSBRIs/CRIs, they could be used for beam(s)/TCI state(s) activation/deactivation according to those specified herein in the present disclosure. When/if the UE could not determine/identify any resource indicator(s) for TCI state(s)/beam(s) activation/deactivation, none of the reported resource indicator(s) in the CSI/beam report(s) could be from the second group of resource indicators SSBRIs/CRIs. For this design example, the second group of resource indicators—and therefore, the resource indicator(s) provided/included/contained/comprised therein—could be (i) configured/indicated/provided by the network, e.g., via higher layer RRC signaling(s)/parameter(s) and/or MAC CE command(s) and/or dynamic DCI based L1 signaling(s), (ii) determined according to fixed rule(s)/value(s) provided/specified in system specification(s), and/or (iii) autonomously determined by the UE, and/or reported to the network, e.g., in part of the CSI/beam report and/or UE's capability signaling(s).
In yet another example, the UE could send to the network, e.g., in the CSI/beam report(s), one or more resource indicators SSBRIs/CRIs from a third group of resource indicators SSBRIs/CRIs for TCI state(s)/beam(s) switching/update/change. That is, when/if one or more resource indicators SSBRIs/CRIs are determined from/according to a third group of resource indicators SSBRIs/CRIs, they could be used for beam(s)/TCI state(s) switching/change/update according to those specified herein in the present disclosure. When/if the UE (e.g., the UE 116) could not determine/identify any resource indicator(s) for TCI state(s)/beam(s) switching/change/update, none of the reported resource indicator(s) in the CSI/beam report(s) could be from the third group of resource indicators SSBRIs/CRIs. For this design example, the third group of resource indicators—and therefore, the resource indicator(s) provided/included/contained/comprised therein—could be (i) configured/indicated/provided by the network, e.g., via higher layer RRC signaling(s)/parameter(s) and/or MAC CE command(s) and/or dynamic DCI based L1 signaling(s), (ii) determined according to fixed rule(s)/value(s) provided/specified in system specification(s), and/or (iii) autonomously determined by the UE, and/or reported to the network, e.g., in part of the CSI/beam report and/or UE's capability signaling(s).

The first group of resource indicators, and/or the second group of resource indicators, and/or the third group of resource indicators could be the same/identical and/or different. That is, one or more of the resource indicators reported in the CSI/beam report(s) could be for TCI state(s)/beam(s) reporting and/or TCI state(s)/beam(s) activation/deactivation and/or TCI state(s)/beam(s) change/switching/update according to those specified herein in the present disclosure, e.g., based on/according to which of the first, second and/or third groups of resource indicators the resource indicator(s) is determined/selected from/according to.

According to those specified herein in the present disclosure, the UE could send to the network (e.g., the network 130), e.g., in a beam/CSI report, one or more resource indicators (and their corresponding beam metrics) for TCI state(s)/beam(s) reporting according to those specified herein in the present disclosure and/or one or more resource indicators (and their corresponding beam metrics) for TCI state(s)/beam(s) activation/deactivation according to those specified herein in the present disclosure and/or one or more resource indicators (and their corresponding beam metrics) for TCI state(s)/beam(s) switching/change/update according to those specified herein in the present disclosure.
In one example, the position(s)/ordering(s) of the CSI field(s) used to carry/indicate/provide the resource indicators (and their corresponding beam metrics), in a CSI/beam report, for TCI state(s)/beam(s) reporting and/or TCI state(s)/beam(s) activation/deactivation and/or TCI state(s)/beam(s) switching/change as specified herein in the present disclosure could be fixed, e.g., in system specification(s).
   For example, the K0 first/last CSI fields or the CSI fields corresponding to the K0 lowest/highest CSI report numbers, e.g., among the CSI fields or the CSI fields that provide/indicate (candidate) resource indicators in the CSI/beam report, could provide/carry/indicate resource indicators for TCI state(s)/beam(s) reporting (or TCI state(s)/beam(s) activation/deactivation or TCI state(s)/beam(s) switching/change), if any, according to those specified herein in the present disclosure, preceded/followed by K1 second/second last CSI fields or the CSI fields corresponding to the K1 second lowest/second highest CSI report numbers, e.g., among the CSI fields or the CSI fields that provide/indicate (candidate) resource indicators in the CSI/beam report, used to provide/carry/indicate resource indicators for TCI state(s)/beam(s) activation/deactivation (or TCI state(s)/beam(s) reporting or TCI state(s)/beam(s) switching/change), if any, according to those specified herein in the present disclosure, preceded/followed by K2 third/third last CSI fields or the CSI fields corresponding to the K2 third lowest/third highest CSI report numbers, e.g., among the CSI fields or the CSI fields that provide/indicate (candidate) resource indicators in the CSI/beam report, used to provide/carry/indicate resource indicators for TCI state(s)/beam(s) switching/change (or TCI state(s)/beam(s) reporting or TCI state(s)/beam(s) activation/deactivation), if any, according to those specified herein in the present disclosure. For instance, the first K0 CSI fields or the CSI fields corresponding to the K0 lowest CSI report numbers, e.g., among the CSI fields or the CSI fields that provide/indicate (candidate) resource indicators in the CSI/beam report, could provide/carry/indicate resource indicators for TCI state(s)/beam(s) reporting (or TCI state(s)/beam(s) activation/deactivation or TCI state(s)/beam(s) switching/change), if any, according to those specified herein in the present disclosure, followed by K1 CSI fields or the CSI fields corresponding to the K1 CSI report numbers higher than the K0 lowest CSI report numbers, e.g., among the CSI fields or the CSI fields that provide/indicate (candidate) resource indicators in the CSI/beam report, used to provide/carry/indicate resource indicators for TCI state(s)/beam(s) activation/deactivation (or TCI state(s)/beam(s) reporting or TCI state(s)/beam(s) switching/change), if any, according to those specified herein in the present disclosure, followed by K2 CSI fields or the CSI fields corresponding to the K2 CSI report numbers higher than the K0 and the K1 lowest CSI report numbers, e.g., among the CSI fields or the CSI fields that provide/indicate (candidate) resource indicators in the CSI/beam report, used to provide/carry/indicate resource indicators for TCI state(s)/beam(s) switching/change (or TCI state(s)/beam(s) reporting or TCI state(s)/beam(s) activation/deactivation), if any, according to those specified herein in the present disclosure. The value(s) of K0 and/or K1 and/or K2 could be: (i) fixed in system specification(s), (ii) configured/provided/indicated by the network, e.g., via higher layer RRC signaling(s)/parameter(s) and/or MAC CE command(s) and/or dynamic DCI based L1 signaling(s), and/or (iii) autonomously determined by the UE, and/or reported to the network via/in part of a/the CSI/beam report and/or UE's capability signaling(s).
   For another example, the odd CSI field(s) or the CSI field(s) corresponding to the odd CSI report numbers, e.g., among the CSI fields or the CSI fields that provide/indicate (candidate) resource indicators in the CSI/beam report, could be used to provide/carry/indicate resource indicators for TCI state(s)/beam(s) switching/change (or TCI state(s)/beam(s) reporting or TCI state(s)/beam(s) activation/deactivation), if any, according to those specified herein in the present disclosure, and the even CSI field(s) or the CSI field(s) corresponding to the even CSI report numbers, e.g., among the CSI fields or the CSI fields that provide/indicate (candidate) resource indicators in the CSI/beam report, could be used to provide/carry/indicate resource indicators for TCI state(s)/beam(s) activation/deactivation (or TCI state(s)/beam(s) reporting or TCI state(s)/beam(s) switching/change), if any, according to those specified herein in the present disclosure. For this case, the UE could be indicated/provided/configured by the network, e.g., via higher layer RRC signaling(s)/parameter(s) and/or MAC CE command(s) and/or dynamic DCI based L1 signaling(s), whether to use the odd and/or even CSI field(s) or the CSI field(s) corresponding to the odd and/or even CSI report numbers, e.g., among the CSI fields or the CSI fields that provide/indicate (candidate) resource indicators in the CSI/beam report, to provide/indicate/carry resource indicators for TCI state(s)/beam(s) reporting and/or TCI state(s)/beam(s) activation/deactivation and/or TCI state(s)/beam(s) switching/change, if any, according to those specified herein in the present disclosure. For instance, the UE could be indicated/provided/configured by the network, e.g., via higher layer RRC signaling(s)/parameter(s) and/or MAC CE command(s) and/or dynamic DCI based L1 signaling(s), to use the odd CSI field(s) or the CSI field(s) corresponding to the odd CSI report numbers, e.g., among the CSI fields or the CSI fields that provide/indicate (candidate) resource indicators in the CSI/beam report, to provide/indicate/carry resource indicators for TCI state(s)/beam(s) activation/deactivation (or TCI state(s)/beam(s) reporting or TCI state(s)/beam(s) switching/change), if any, according to those specified herein in the present disclosure, and the even CSI field(s) or the CSI field(s) corresponding to the even CSI report numbers, e.g., among the CSI fields or the CSI fields that provide/indicate (candidate) resource indicators in the CSI/beam report, to provide/indicate/carry resource indicators for TCI state(s)/beam(s) switching/change (or TCI state(s)/beam(s) reporting or TCI state(s)/beam(s) activation/deactivation), if any, according to those specified herein in the present disclosure.
   Yet for another example, the UE could follow fixed rule(s)/value(s) provided/specified in system specification(s) to determine which of the CSI field(s) in the beam/CSI report to use for providing/indicating/carrying resource indicators for TCI state(s)/beam(s) reporting and/or TCI state(s)/beam(s) activation/deactivation and/or TCI state(s)/beam(s) switching/change according to those specified herein in the present disclosure. The fixed rule(s)/value(s) could correspond to ID(s)/index(es) of CSI field(s) in the beam/CSI report, value(s) of CSI report number(s) in the beam/CSI report, bitmap(s) with each bit position/entry corresponding to a CSI field/CSI report number in the beam/CSI report and/or etc. For instance, the fixed rule(s)/value(s) could correspond to a first set of ID(s)/index(es) of CSI field(s) and/or value(s) of CSI report number(s) in the beam/CSI report, wherein the corresponding CSI field(s) could be used for providing/indicating/carrying resource indicator(s) for TCI state(s)/beam(s) reporting according to those specified herein in the present disclosure, and a second set of ID(s)/index(es) of CSI field and/or value(s) of CSI report number(s) in the beam/CSI report, wherein the corresponding CSI field(s) could be used for providing/indicating/carrying resource indicator(s) for TCI state(s)/beam(s) activation/deactivation according to those specified herein in the present disclosure, and a third set of ID(s)/index(es) of CSI field and/or value(s) of CSI report number(s) in the beam/CSI report, wherein the corresponding CSI field(s) could be used for providing/indicating/carrying resource indicator(s) for TCI state(s)/beam(s) switching/change according to those specified herein in the present disclosure. Alternatively, the fixed rule(s)/value(s) could correspond to a first bitmap with each entry/bit position in the first bitmap associated/corresponding to a CSI field in the beam/CSI report-when/if a bit position/entry in the first bitmap is set to ‘1’ (or ‘0’), the corresponding/associated CSI field in the beam/CSI report could be used to carry/indicate/provide resource indicator(s) for TCI state(s)/beam(s) reporting according to those specified herein in the present disclosure, and/or a second bitmap with each entry/bit position in the bitmap associated/corresponding to a CSI field in the beam/CSI report—when/if a bit position/entry in the second bitmap is set to ‘1’ (or ‘0’), the corresponding/associated CSI field in the beam/CSI report could be used to carry/indicate/provide resource indicator(s) for TCI state(s)/beam(s) activation/deactivation according to those specified herein in the present disclosure, and/or a third bitmap with each entry/bit position in the bitmap associated/corresponding to a CSI field in the beam/CSI report—when/if a bit position/entry in the third bitmap is set to ‘1’ (or ‘0’), the corresponding/associated CSI field in the beam/CSI report could be used to carry/provide/indicate resource indicator(s) for TCI state(s)/beam(s) switching/change according to those specified herein in the present disclosure.
   Yet for another example, one or more of the CSI fields in the beam/CSI report could be used to carry/provide/indicate resource indicator(s) for TCI state(s)/beam(s) reporting, according to fixed rule(s)/value(s) specified/provided herein in the present disclosure (e.g., K0 first CSI field(s) in the beam/CSI report, odd/even CSI field(s) in the beam/CSI report, CSI field(s) in the beam/CSI report corresponding to fixed index(s)/ID(s) of the CSI field(s) and/or CSI field(s) in the beam/CSI report indicated/provided by bitmap(s) according to those specified in the design examples in the present disclosure); the remaining/rest of the CSI fields in the beam/CSI report could be used to carry/provide/indicate resource indicator(s) for TCI state(s)/beam(s) activation/deactivation and/or TCI state(s)/beam(s) switching/change according to (i) fixed rule(s)/value(s) according to those specified herein in the present disclosure, and/or (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could also be reported to the network, e.g., in/via part of a/the CSI/beam report and/or UE's capability signaling(s). Alternatively, one or more of the CSI fields in the beam/CSI report could be used to carry/provide/indicate resource indicator(s) for TCI state(s)/beam(s) activation/deactivation, according to fixed rule(s)/value(s) specified/provided herein in the present disclosure (e.g., K0 first CSI field(s) in the beam/CSI report, odd/even CSI field(s) in the beam/CSI report, CSI field(s) in the beam/CSI report corresponding to fixed index(s)/ID(s) of the CSI field(s) and/or CSI field(s) in the beam/CSI report indicated/provided by bitmap(s) according to those specified in the design examples in the present disclosure); the remaining/rest of the CSI fields in the beam/CSI report could be used to carry/provide/indicate resource indicator(s) for TCI state(s)/beam(s) reporting and/or TCI state(s)/beam(s) switching/change according to (i) fixed rule(s)/value(s) according to those specified herein in the present disclosure, and/or (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could also be reported to the network, e.g., in/via part of a/the CSI/beam report and/or UE's capability signaling(s). Optionally, one or more of the CSI fields in the beam/CSI report could be used to carry/provide/indicate resource indicator(s) for TCI state(s)/beam(s) switching/change, according to fixed rule(s)/value(s) specified/provided herein in the present disclosure (e.g., K0 first CSI field(s) in the beam/CSI report, odd/even CSI field(s) in the beam/CSI report, CSI field(s) in the beam/CSI report corresponding to fixed index(s)/ID(s) of the CSI field(s) and/or CSI field(s) in the beam/CSI report indicated/provided by bitmap(s) according to those specified in the design examples in the present disclosure); the remaining/rest of the CSI fields in the beam/CSI report could be used to carry/provide/indicate resource indicator(s) for TCI state(s)/beam(s) reporting and/or TCI state(s)/beam(s) activation/deactivation according to (i) fixed rule(s)/value(s) according to those specified herein in the present disclosure, and/or (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could also be reported to the network, e.g., in/via part of a/the CSI/beam report and/or UE's capability signaling(s).
In another example, the UE could be indicated/configured/provided by the network, e.g., via higher layer RRC signaling(s)/parameter(s) and/or MAC CE command(s) and/or dynamic DCI based L1 signaling(s), the position(s)/ordering(s) of the CSI field(s) used to carry/indicate/provide the resource indicators (and their corresponding beam metrics), in a CSI/beam report, for TCI state(s)/beam(s) reporting and/or TCI state(s)/beam(s) activation/deactivation and/or TCI state(s)/beam(s) switching/change as specified herein in the present disclosure.
   For example, the UE could be provided/indicated/configured by the network, e.g., via higher layer RRC signaling(s)/parameter(s) and/or MAC CE command(s) and/or dynamic DCI based L1 signaling(s), one or more indicators each associated/corresponding to a CSI field in the beam/CSI report. For instance, when/if an indicator is set to ‘00’ (or ‘01’ or ‘10’ or ‘11’), the corresponding/associated CSI field in the beam/CSI report could be for TCI state(s)/beam(s) reporting (and/or TCI state(s)/beam(s) activation/deactivation and/or TCI state(s)/beam(s) switching/change) according to those specified herein in the present disclosure, and/or when/if an indicator is set to ‘01’ (or ‘00’ or ‘10’ or ‘11’), the corresponding/associated CSI field in the beam/CSI report could be for TCI state(s)/beam(s) activation/deactivation (and/or TCI state(s)/beam(s) reporting and/or TCI state(s)/beam(s) switching/change) according to those specified herein in the present disclosure, and/or when/if an indicator is set to ‘10’ or ‘11’ (or ‘00’ or ‘01’), the corresponding/associated CSI field in the beam/CSI report could be for TCI state(s)/beam(s) switching/change (and/or TCI state(s)/beam(s) reporting and/or TCI state(s)/beam(s) activation/deactivation) according to those specified herein in the present disclosure.
   For another example, the UE could be provided/indicated/configured by the network, e.g., via higher layer RRC signaling(s)/parameter(s) and/or MAC CE command(s) and/or dynamic DCI based L1 signaling(s), one or more first indicators each associated/corresponding to a CSI field in the beam/CSI report. For instance, when/if a first indicator is set to ‘1’ (or ‘0’), the corresponding/associated CSI field in the beam/CSI report could be for TCI state(s)/beam(s) reporting according to those specified herein in the present disclosure. In addition, the UE could be provided/indicated/configured by the network, e.g., via higher layer RRC signaling(s)/parameter(s) and/or MAC CE command(s) and/or dynamic DCI based L1 signaling(s), one or more second indicators each associated/corresponding to a CSI field in the beam/CSI report. For instance, when/if a second indicator is set to ‘1’ (or ‘0’), the corresponding/associated CSI field in the beam/CSI report could be for TCI state(s)/beam(s) activation/deactivation according to those specified herein in the present disclosure. Furthermore, the UE could be provided/indicated/configured by the network, e.g., via higher layer RRC signaling(s)/parameter(s) and/or MAC CE command(s) and/or dynamic DCI based L1 signaling(s), one or more third indicators each associated/corresponding to a CSI field in the beam/CSI report. For instance, when/if a third indicator is set to ‘1’ (or ‘0’), the corresponding/associated CSI field in the beam/CSI report could be for TCI state(s)/beam(s) switching/change according to those specified herein in the present disclosure.
   Yet for another example, the UE could be provided/indicated/configured by the network, e.g., via higher layer RRC signaling(s)/parameter(s) and/or MAC CE command(s) and/or dynamic DCI based L1 signaling(s), a first set of ID(s)/index(es) of one or more CSI fields in the beam/CSI report—the CSI field(s) with the ID(s)/index(es) in the first set could be used to provide/indicate/carry resource indicator(s) for TCI state(s) reporting according to those specified herein in the present disclosure, and/or a second set of ID(s)/index(es) of one or more CSI fields in the beam/CSI report—the CSI field(s) with the ID(s)/index(es) in the second set could be used to provide/indicate/carry resource indicator(s) for TCI state(s) activation/deactivation according to those specified herein in the present disclosure, and/or a third set of ID(s)/index(es) of one or more CSI fields in the beam/CSI report—the CSI field(s) with the ID(s)/index(es) in the third set could be used to provide/indicate/carry resource indicator(s) for TCI state(s) switching/change according to those specified herein in the present disclosure.
   Yet for another example, the UE could be provided/indicated/configured by the network, e.g., via higher layer RRC signaling(s)/parameter(s) and/or MAC CE command(s) and/or dynamic DCI based L1 signaling(s), a first bitmap with each entry/bit position in the first bitmap corresponding/associated to a CSI field in the CSI/beam report-when/if a bit position/entry in the first bitmap is set to ‘1’ (or ‘0’), the corresponding/associated CSI field in the beam/CSI report could be used to carry/indicate/provide resource indicator(s) for TCI state(s)/beam(s) reporting according to those specified herein in the present disclosure, and/or a second bitmap with each entry/bit position in the second bitmap corresponding/associated to a CSI field in the CSI/beam report-when/if a bit position/entry in the second bitmap is set to ‘1’ (or ‘0’), the corresponding/associated CSI field in the beam/CSI report could be used to carry/indicate/provide resource indicator(s) for TCI state(s)/beam(s) activation/deactivation according to those specified herein in the present disclosure, and/or a third bitmap with each entry/bit position in the third bitmap corresponding/associated to a CSI field in the CSI/beam report-when/if a bit position/entry in the third bitmap is set to ‘1’ (or ‘0’), the corresponding/associated CSI field in the beam/CSI report could be used to carry/indicate/provide resource indicator(s) for TCI state(s)/beam(s) switching/change according to those specified herein in the present disclosure.
   Yet for another example, the UE could be indicated/configured/provided by the network, e.g., via higher layer RRC signaling(s)/parameter(s) and/or MAC CE command(s) and/or dynamic DCI based L1 signaling(s), to use one or more of the CSI fields in the beam/CSI report to carry/provide/indicate resource indicator(s) for TCI state(s)/beam(s) reporting, according to those specified herein in the present disclosure; the remaining/rest of the CSI fields in the beam/CSI report could be used to carry/provide/indicate resource indicator(s) for TCI state(s)/beam(s) activation/deactivation and/or TCI state(s)/beam(s) switching/change according to (i) fixed rule(s)/value(s) according to those specified herein in the present disclosure, and/or (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could also be reported to the network, e.g., in/via part of a/the CSI/beam report and/or UE's capability signaling(s). Alternatively, the UE could be indicated/configured/provided by the network, e.g., via higher layer RRC signaling(s)/parameter(s) and/or MAC CE command(s) and/or dynamic DCI based L1 signaling(s), to use one or more of the CSI fields in the beam/CSI report carry/provide/indicate resource indicator(s) for TCI state(s)/beam(s) activation/deactivation/sub-selection, according to those specified herein in the present disclosure; the remaining/rest of the CSI fields in the beam/CSI report could be used to carry/provide/indicate resource indicator(s) for TCI state(s)/beam(s) reporting and/or TCI state(s)/beam(s) switching/change according to (i) fixed rule(s)/value(s) according to those specified herein in the present disclosure, and/or (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could also be reported to the network, e.g., in/via part of a/the CSI/beam report and/or UE's capability signaling(s). Optionally, the UE could be indicated/configured/provided by the network, e.g., via higher layer RRC signaling(s)/parameter(s) and/or MAC CE command(s) and/or dynamic DCI based L1 signaling(s), to use one or more of the CSI fields in the beam/CSI report to carry/provide/indicate resource indicator(s) for TCI state(s)/beam(s) switching/change/update, according to according to those specified herein in the present disclosure; the remaining/rest of the CSI fields in the beam/CSI report could be used to carry/provide/indicate resource indicator(s) for TCI state(s)/beam(s) activation/deactivation/sub-selection and/or TCI state(s)/beam(s) reporting according to (i) fixed rule(s)/value(s) according to those specified herein in the present disclosure, and/or (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could also be reported to the network, e.g., in/via part of a/the CSI/beam report and/or UE's capability signaling(s).
In yet another example, the UE could send to the network, e.g., in/via part of the beam/CSI report, information related to the position(s)/ordering(s) of the CSI field(s) used to carry/indicate/provide the resource indicators (and their corresponding beam metrics), in a CSI/beam report, for TCI state(s)/beam(s) reporting and/or TCI state(s)/beam(s) activation/deactivation and/or TCI state(s)/beam(s) switching/change as specified herein in the present disclosure.
   For example, the UE could send to the network, e.g., in the CSI/beam report, one or more indicators each associated/corresponding to a CSI field in the (same) beam/CSI report. For instance, when/if an indicator is set to ‘00’ (or ‘01’ or ‘10’ or ‘11’), the corresponding/associated CSI field in the beam/CSI report could be for TCI state(s)/beam(s) reporting (and/or TCI state(s)/beam(s) activation/deactivation and/or TCI state(s)/beam(s) switching/change) according to those specified herein in the present disclosure, and/or when/if an indicator is set to ‘01’ (or ‘00’ or ‘10’ or ‘11’), the corresponding/associated CSI field in the beam/CSI report could be for TCI state(s)/beam(s) activation/deactivation (and/or TCI state(s)/beam(s) reporting and/or TCI state(s)/beam(s) switching/change) according to those specified herein in the present disclosure, and/or when/if an indicator is set to ‘10’ or ‘11’ (or ‘00’ or ‘01’), the corresponding/associated CSI field in the beam/CSI report could be for TCI state(s)/beam(s) switching/change (and/or TCI state(s)/beam(s) reporting and/or TCI state(s)/beam(s) activation/deactivation) according to those specified herein in the present disclosure.
   For another example, the UE could send to the network, e.g., in the CSI/beam report, one or more first indicators each associated/corresponding to a CSI field in the (same) beam/CSI report. For instance, when/if a first indicator is set to ‘1’ (or ‘0’), the corresponding/associated CSI field in the beam/CSI report could be for TCI state(s)/beam(s) reporting according to those specified herein in the present disclosure. In addition, the UE send to the network, e.g., in the CSI/beam report, one or more second indicators each associated/corresponding to a CSI field in the (same) beam/CSI report. For instance, when/if a second indicator is set to ‘1’ (or ‘0’), the corresponding/associated CSI field in the beam/CSI report could be for TCI state(s)/beam(s) activation/deactivation according to those specified herein in the present disclosure. Furthermore, the UE could send to the network, e.g., in the CSI/beam report, one or more third indicators each associated/corresponding to a CSI field in the (same) beam/CSI report. For instance, when/if a third indicator is set to ‘1’ (or ‘0’), the corresponding/associated CSI field in the beam/CSI report could be for TCI state(s)/beam(s) switching/change according to those specified herein in the present disclosure.
   Yet for another example, the UE could send to the network, e.g., in the CSI/beam report, a first set of ID(s)/index(es) of one or more CSI fields in the beam/CSI report—the CSI field(s) with the ID(s)/index(es) in the first set could be used to provide/indicate/carry resource indicator(s) for TCI state(s) reporting according to those specified herein in the present disclosure, and/or a second set of ID(s)/index(es) of one or more CSI fields in the beam/CSI report—the CSI field(s) with the ID(s)/index(es) in the second set could be used to provide/indicate/carry resource indicator(s) for TCI state(s) activation/deactivation according to those specified herein in the present disclosure, and/or a third set of ID(s)/index(es) of one or more CSI fields in the beam/CSI report—the CSI field(s) with the ID(s)/index(es) in the third set could be used to provide/indicate/carry resource indicator(s) for TCI state(s) switching/change according to those specified herein in the present disclosure.
   Yet for another example, the UE could send to the network, e.g., in the CSI/beam report, a first bitmap with each entry/bit position in the first bitmap corresponding/associated to a CSI field in the (same) CSI/beam report-when/if a bit position/entry in the first bitmap is set to ‘1’ (or ‘0’), the corresponding/associated CSI field in the beam/CSI report could be used to carry/indicate/provide resource indicator(s) for TCI state(s)/beam(s) reporting according to those specified herein in the present disclosure, and/or a second bitmap with each entry/bit position in the second bitmap corresponding/associated to a CSI field in the (same) CSI/beam report-when/if a bit position/entry in the second bitmap is set to ‘1’ (or ‘0’), the corresponding/associated CSI field in the beam/CSI report could be used to carry/indicate/provide resource indicator(s) for TCI state(s)/beam(s) activation/deactivation according to those specified herein in the present disclosure, and/or a third bitmap with each entry/bit position in the third bitmap corresponding/associated to a CSI field in the (same) CSI/beam report-when/if a bit position/entry in the third bitmap is set to ‘1’ (or ‘0’), the corresponding/associated CSI field in the beam/CSI report could be used to carry/indicate/provide resource indicator(s) for TCI state(s)/beam(s) switching/change according to those specified herein in the present disclosure.
   Yet for another example, the UE (e.g., the UE 116) could indicate/send to the network (e.g., the network 130), e.g., in/via part of the beam/CSI report, to use one or more of the CSI fields in the beam/CSI report to carry/provide/indicate resource indicator(s) for TCI state(s)/beam(s) reporting, according to those specified herein in the present disclosure; the remaining/rest of the CSI fields in the beam/CSI report could be used to carry/provide/indicate resource indicator(s) for TCI state(s)/beam(s) activation/deactivation and/or TCI state(s)/beam(s) switching/change according to (i) fixed rule(s)/value(s) according to those specified herein in the present disclosure, and/or (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could also be reported to the network, e.g., in/via part of a/the CSI/beam report and/or UE's capability signaling(s). Alternatively, the UE could indicate/send to the network, e.g., in/via part of the beam/CSI report, to use one or more of the CSI fields in the beam/CSI report to carry/provide/indicate resource indicator(s) for TCI state(s)/beam(s) activation/deactivation/sub-selection, according to those specified herein in the present disclosure; the remaining/rest of the CSI fields in the beam/CSI report could be used to carry/provide/indicate resource indicator(s) for TCI state(s)/beam(s) reporting and/or TCI state(s)/beam(s) switching/change according to (i) fixed rule(s)/value(s) according to those specified herein in the present disclosure, and/or (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could also be reported to the network, e.g., in/via part of a/the CSI/beam report and/or UE's capability signaling(s). Optionally, the UE could indicate/send to the network, e.g., in/via part of the beam/CSI report, to use one or more of the CSI fields in the beam/CSI report to carry/provide/indicate resource indicator(s) for TCI state(s)/beam(s) switching/change/update, according to according to those specified herein in the present disclosure; the remaining/rest of the CSI fields in the beam/CSI report could be used to carry/provide/indicate resource indicator(s) for TCI state(s)/beam(s) activation/deactivation/sub-selection and/or TCI state(s)/beam(s) reporting according to (i) fixed rule(s)/value(s) according to those specified herein in the present disclosure, and/or (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could also be reported to the network, e.g., in/via part of a/the CSI/beam report and/or UE's capability signaling(s).

Throughout the present disclosure, a CSI field in a CSI/beam report could also be referred to as an entry, a position, an ordering, a CSI report number and/or etc. in a CSI/beam report. Furthermore, a CSI field could correspond to any CSI field in a beam/CSI report, or a CSI field that carries/provides/indicates resource indicator(s) such as SSBRI(s)/CRI(s) and/or beam metric(s) such as L1-RSRP(s)/L1-SINR(s) in a beam/CSI report.

For the described/specified design examples in the present disclosure (e.g., according to one or more examples described herein), when/if a CSI/beam report and/or one or more resource indicators in a CSI/beam report is/are for TCI state(s)/beam(s) reporting and/or TCI state(s)/beam(s) activation/deactivation and/or TCI state(s)/beam(s) switching/change/update according to those specified herein in the present disclosure, the CSI/beam report may not contain/comprise/include/provide beam metric(s) such as L1-RSRP(s)/L1-SINR(s) for the one or more resource indicators—or equivalently, beam metric(s) such as L1-RSRP(s)/L1-SINR(s) for the one or more resource indicators may be absent in the CSI/beam report. That is, the UE may not send to the network, e.g., in a beam/CSI report, beam metric(s) such as L1-RSRP(s)/L1-SINR(s) for one or more resource indicators reported in the beam/CSI report when/if the beam/CSI report and/or the one or more resource indicators SSBRIs/CRIs in the beam/CSI report is/are for TCI state(s)/beam(s) reporting and/or TCI state(s)/beam(s) activation/deactivation and/or TCI state(s)/beam(s) switching/change/update according to those specified herein in the present disclosure. Alternatively, the UE could be indicated/provided/configured by the network, e.g., via higher layer RRC signaling(s)/parameter(s) and/or MAC CE command(s) and/or dynamic DCI based L1 signaling(s), whether or not to report/include/provide beam metric(s) such as L1-RSRP(s)/L1-SINR(s) for one or more resource indicators in the beam/CSI report, wherein the beam/CSI report and/or the one or more resource indicators SSBRIs/CRIs in the beam/CSI report could be for TCI state(s)/beam(s) reporting and/or TCI state(s)/beam(s) activation/deactivation and/or TCI state(s)/beam(s) switching/change/update according to those specified herein in the present disclosure.

The described/specified design examples herein of using the reported resource indicator(s) such as SSBRI(s) and/or CRI(s) in one or more CSI/beam reports for beam(s) reporting, TCI state(s)/beam(s) activation and/or TCI state(s)/beam(s) switching/change could be extended/applied to using the reported beam metric(s) such as L1-RSRP(s) and/or L1-SINR(s) in the one or more CSI/beam reports for beam(s) reporting, TCI state(s)/beam(s) activation and/or TCI state(s)/beam(s) switching/change, e.g., by replacing the resource indicator(s), group(s) of resource indicators and/or candidate resource indicator(s) in one or more examples described herein with the beam metric(s), group(s) of beam metrics and/or candidate beam metric(s).

The CSI/beam report(s) as specified herein in the present disclosure that provide/indicate/contain/include/comprise one or more resource indicators for TCI state(s)/beam(s) reporting and/or TCI state(s)/beam(s) activation/deactivation and/or TCI state(s)/beam(s) switching/change according to those specified herein in the present disclosure may not include/comprise/provide/contain beam metric(s) such as L1-RSRP(s) and/or L1-SINR(s).
In one example, when/if a beam/CSI report provides/contains/indicates/includes one or more resource indicators for TCI state(s)/beam(s) reporting and/or TCI state(s)/beam(s) activation/deactivation and/or TCI state(s)/beam(s) switching/change according to those specified herein in the present disclosure, the beam/CSI report may not include/comprise/contain/provide any beam metric(s) such as L1-RSRP(s) and/or L1-SINR(s).
In another example, when/if a beam/CSI report provides/contains/indicates/includes one or more resource indicators for TCI state(s)/beam(s) reporting according to those specified herein in the present disclosure, the one or more resource indicators may not be associated/corresponding to any beam metric(s) such as L1-RSRP(s)/L1-SINR(s) in the beam/CSI report—or there may not be any beam metric(s) such as L1-RSRP(s)/L1-SINR(s) reported in the beam/CSI report associated/corresponding to the one or more resource indicators for TCI state(s)/beam(s) reporting. Additionally, when/if a beam/CSI report provides/contains/indicates/includes one or more resource indicators for TCI state(s)/beam(s) activation/deactivation according to those specified herein in the present disclosure, the one or more resource indicators may not be associated/corresponding to any beam metric(s) such as L1-RSRP(s)/L1-SINR(s) in the beam/CSI report—or there may not be any beam metric(s) such as L1-RSRP(s)/L1-SINR(s) reported in the beam/CSI report associated/corresponding to the one or more resource indicators for TCI state(s)/beam(s) activation/deactivation. Furthermore, when/if a beam/CSI report provides/contains/indicates/includes one or more resource indicators for TCI state(s)/beam(s) switching/change according to those specified herein in the present disclosure, the one or more resource indicators may not be associated/corresponding to any beam metric(s) such as L1-RSRP(s)/L1-SINR(s) in the beam/CSI report—or there may not be any beam metric(s) such as L1-RSRP(s)/L1-SINR(s) reported in the beam/CSI report associated/corresponding to the one or more resource indicators for the TCI state(s)/beam(s) switching/change. For instance, a beam/CSI report could contain/include/provide/indicate/comprise one or more first resource indicators for TCI state(s)/beam(s) reporting and/or one or more second resource indicators for TCI state(s)/beam(s) activation/deactivation, according to those specified herein in the present disclosure. For this case, the beam/CSI report could provide/contain/include/comprise/indicate one or more beam metrics such as L1-RSRPs/L1-SINRs associated/corresponding to the one or more first resource indicators, but may not provide/contain/include/comprise/indicate any beam metric(s) such as L1-RSRP(s)/L1-SINR(s) for the one or more second resource indicators. Optionally, whether or not beam metric(s) such as L1-RSRP(s)/L1-SINR(s) and/or beam metric(s) such as L1-RSRP(s)/L1-SINR(s) associated/corresponding to one or more resource indicators in a CSI/beam report could be provided/indicated/comprised/contained/included in the beam/CSI report could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous decision/determination/selection, which could be further reported to the network, e.g., via/in part of the CSI/beam report and/or UE's capability signaling(s).

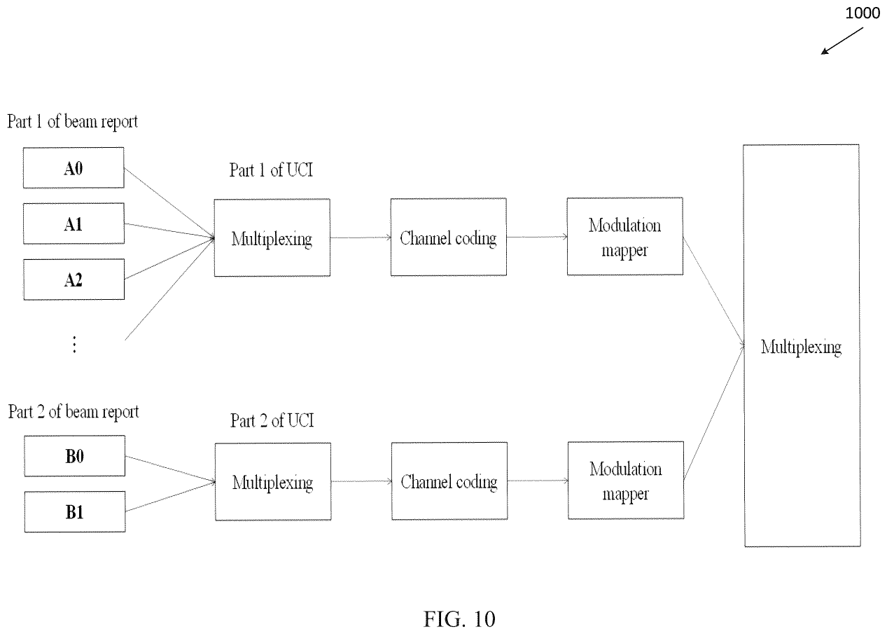

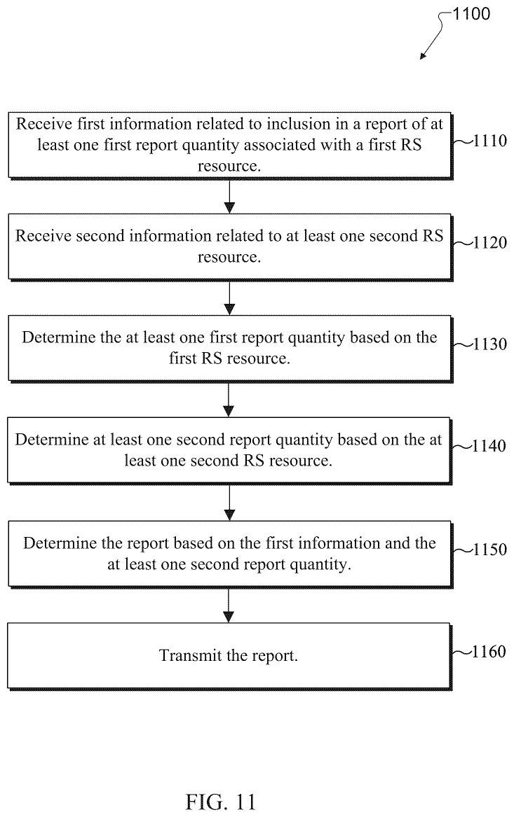

FIG. 10 illustrates a diagram of an example two-part CSI/beam report 1000 for indicating/providing first and second resource indicators according to embodiments of the present disclosure. For example, two-part CSI/beam report 1000 for indicating/providing first and second resource indicators can be transmitted by any of the UEs 111-116 of FIG. 1, such as the UE 114. This example is for illustration only and other embodiments can be used without departing from the scope of the present disclosure.

The CSI/beam report as specified herein in the present disclosure—e.g., that comprises/contains/includes/indicates/provides one or more resource indicators for TCI state(s)/beam(s) reporting and/or TCI state(s)/beam(s) activation/deactivation and/or TCI state(s)/beam(s) switching/change—could be in/of form of two-part UCI comprising part 1 and part 2. Part 1 of the two-part CSI/beam report could be of fixed payload size, and could indicate/provide payload size or information related to payload size of part 2 of the two-part CSI/beam report. Part 2 of the two-part CSI/beam report could be of flexible payload size. Specifically, part 1 of the two-part CSI/beam report could comprise or include/contain/provide/indicate at least one of:
One or more resource indicators such as SSBRIs/CRIs for TCI state(s)/beam(s) reporting and/or TCI state(s)/beam(s) activation/deactivation and/or TCI state(s)/beam(s) switching/change according to those specified herein in the present disclosure
One or more resource indicators such as SSBRIs/CRIs for TCI state(s)/beam(s) reporting according to those specified herein in the present disclosure.
One or more resource indicators such as SSBRIs/CRIs for TCI state(s)/beam(s) activation/deactivation according to those specified herein in the present disclosure
One or more resource indicators such as SSBRIs/CRIs for TCI state(s)/beam(s) switching/change according to those specified herein in the present disclosure
One or more beam metrics such as L1-RSRPs/L1-SINRs associated/corresponding to resource indicator(s) for TCI state(s)/beam(s) reporting and/or TCI state(s)/beam(s) activation/deactivation and/or TCI state(s)/beam(s) switching/change according to those specified herein in the present disclosure
One or more beam metrics such as L1-RSRPs/L1-SINRs associated/corresponding to resource indicator(s) for TCI state(s)/beam(s) reporting according to those specified herein in the present disclosure
One or more beam metrics such as L1-RSRPs/L1-SINRs associated/corresponding to resource indicator(s) for TCI state(s)/beam(s) activation/deactivation according to those specified herein in the present disclosure
One or more beam metrics such as L1-RSRPs/L1-SINRs associated/corresponding to resource indicator(s) for TCI state(s)/beam(s) switching/change according to those specified herein in the present disclosure.
Information/indication(s) related to which one or more of the CSI fields in the beam/CSI report (part 1 and/or part 2) to use for carrying/indicating/providing resource indicator(s) for TCI state(s)/beam(s) reporting and/or TCI state(s)/beam(s) activation/deactivation and/or TCI state(s)/beam(s) switching/change according to those specified herein in the present disclosure
Information/indication(s) related to which one or more of the CSI fields in the beam/CSI report (part 1 and/or part 2) to use for carrying/indicating/providing resource indicator(s) for TCI state(s)/beam(s) reporting according to those specified herein in the present disclosure
Information/indication(s) related to which one or more of the CSI fields in the beam/CSI report (part 1 and/or part 2) to use for carrying/indicating/providing resource indicator(s) for TCI state(s)/beam(s) activation/deactivation according to those specified herein in the present disclosure
Information/indication(s) related to which one or more of the CSI fields in the beam/CSI report (part 1 and/or part 2) to use for carrying/indicating/providing resource indicator(s) for TCI state(s)/beam(s) switching/change according to those specified herein in the present disclosure
Information/indication(s) related to whether beam metric(s) such as L1-RSRP(s)/L1-SINR(s) is in the beam/CSI report (part 1 and/or part 2)
Information/indication(s) related to whether beam metric(s) such as L1-RSRP(s)/L1-SINR(s) associated/corresponding to resource indicator(s) for TCI state(s)/beam(s) reporting and/or TCI state(s)/beam(s) activation/deactivation and/or TCI state(s)/beam(s) switching/change as specified herein in the present disclosure is in the beam/CSI report (part 1 and/or part 2), and/or which one or more of the CSI fields in the beam/CSI report (part 1 and/or part 2) to use for carrying/indicating/providing beam metric(s), if present in part 1 and/or part 2 of the beam/CSI report, associated/corresponding to the resource indicator(s) for TCI state(s)/beam(s) reporting and/or TCI state(s)/beam(s) activation/deactivation and/or TCI state(s)/beam(s) switching/change according to those specified herein in the present disclosure
Information/indication(s) related to whether beam metric(s) such as L1-RSRP(s)/L1-SINR(s) associated/corresponding to resource indicator(s) for TCI state(s)/beam(s) reporting as specified herein in the present disclosure is in the beam/CSI report (part 1 and/or part 2), and/or which one or more of the CSI fields in the beam/CSI report (part 1 and/or part 2) to use for carrying/indicating/providing beam metric(s), if present in part 1 and/or part 2 of the beam/CSI report, associated/corresponding to the resource indicator(s) for TCI state(s)/beam(s) reporting according to those specified herein in the present disclosure
Information/indication(s) related to whether beam metric(s) such as L1-RSRP(s)/L1-SINR(s) associated/corresponding to resource indicator(s) for TCI state(s)/beam(s) activation/deactivation as specified herein in the present disclosure is in the beam/CSI report (part 1 and/or part 2), and/or which one or more of the CSI fields in the beam/CSI report (part 1 and/or part 2) to use for carrying/indicating/providing beam metric(s), if present in part 1 and/or part 2 of the beam/CSI report, associated/corresponding to the resource indicator(s) for TCI state(s)/beam(s) activation/deactivation according to those specified herein in the present disclosure
Information/indication(s) related to whether beam metric(s) such as L1-RSRP(s)/L1-SINR(s) associated/corresponding to resource indicator(s) for TCI state(s)/beam(s) switching/change as specified herein in the present disclosure is in the beam/CSI report (part 1 and/or part 2), and/or which one or more of the CSI fields in the beam/CSI report (part 1 and/or part 2) to use for carrying/indicating/providing beam metric(s), if present in part 1 and/or part 2 of the beam/CSI report, associated/corresponding to the resource indicator(s) for TCI state(s)/beam(s) switching/change according to those specified herein in the present disclosure
Number of resource indicators (and/or their corresponding/associated beam metrics) in part 1 and/or part 2 of the beam/CSI report
Number of resource indicators (and/or their corresponding/associated beam metrics) in part 1 and/or part 2 of the beam/CSI report for TCI state(s)/beam(s) reporting and/or TCI state(s)/beam(s) activation/deactivation and/or TCI state(s)/beam(s) switching/change according to those specified herein in the present disclosure
Number of resource indicators (and/or their corresponding/associated beam metrics) in part 1 and/or part 2 of the beam/CSI report for TCI state(s)/beam(s) reporting according to those specified herein in the present disclosure
Number of resource indicators (and/or their corresponding/associated beam metrics) in part 1 and/or part 2 of the beam/CSI report for TCI state(s)/beam(s) activation/deactivation according to those specified herein in the present disclosure
Number of resource indicators (and/or their corresponding/associated beam metrics) in part 1 and/or part 2 of the beam/CSI report for TCI state(s)/beam(s) switching/change/update according to those specified herein in the present disclosure
Information/indication(s) related to whether part 2 is present in the beam/CSI report
Information/indication(s) related to whether part 1 and/or part 2 of the beam/CSI report is for TCI state(s) reporting and/or TCI state(s)/beam(s) activation/deactivation and/or TCI state(s)/beam(s) switching/change according to those specified herein in the present disclosure
Information/indication(s) related to whether part 1 and/or part 2 of the beam/CSI report comprises/contains/includes/provides/indicates resource indicator(s) for TCI state(s) reporting and/or TCI state(s)/beam(s) activation/deactivation and/or TCI state(s)/beam(s) switching/change according to those specified herein in the present disclosure
Information/indication(s) related to payload size of part 2 of the beam/CSI report 2

Part 2 of the two-part CSI/beam report, if present, could comprise or include/contain/provide/indicate at least one of:
One or more resource indicators such as SSBRIs/CRIs for TCI state(s)/beam(s) reporting and/or TCI state(s)/beam(s) activation/deactivation and/or TCI state(s)/beam(s) switching/change according to those specified herein in the present disclosure
One or more resource indicators such as SSBRIs/CRIs for TCI state(s)/beam(s) reporting according to those specified herein in the present disclosure.
One or more resource indicators such as SSBRIs/CRIs for TCI state(s)/beam(s) activation/deactivation according to those specified herein in the present disclosure
One or more resource indicators such as SSBRIs/CRIs for TCI state(s)/beam(s) switching/change according to those specified herein in the present disclosure
One or more beam metrics such as L1-RSRPs/L1-SINRs associated/corresponding to resource indicator(s) for TCI state(s)/beam(s) reporting and/or TCI state(s)/beam(s) activation/deactivation and/or TCI state(s)/beam(s) switching/change according to those specified herein in the present disclosure.
One or more beam metrics such as L1-RSRPs/L1-SINRs associated/corresponding to resource indicator(s) for TCI state(s)/beam(s) reporting according to those specified herein in the present disclosure
One or more beam metrics such as L1-RSRPs/L1-SINRs associated/corresponding to resource indicator(s) for TCI state(s)/beam(s) activation/deactivation according to those specified herein in the present disclosure
One or more beam metrics such as L1-RSRPs/L1-SINRs associated/corresponding to resource indicator(s) for TCI state(s)/beam(s) switching/change according to those specified herein in the present disclosure
Information/indication(s) related to which one or more of the CSI fields in part 2 of the beam/CSI report to use for carrying/indicating/providing resource indicator(s) for TCI state(s)/beam(s) reporting and/or TCI state(s)/beam(s) activation/deactivation and/or TCI state(s)/beam(s) switching/change/update according to those specified herein in the present disclosure
Information/indication(s) related to which one or more of the CSI fields in part 2 of the beam/CSI report to use for carrying/indicating/providing resource indicator(s) for TCI state(s)/beam(s) reporting according to those specified herein in the present disclosure.
Information/indication(s) related to which one or more of the CSI fields in part 2 of the beam/CSI report to use for carrying/indicating/providing resource indicator(s) for TCI state(s)/beam(s) activation/deactivation according to those specified herein in the present disclosure
Information/indication(s) related to which one or more of the CSI fields in part 2 of the beam/CSI report to use for carrying/indicating/providing resource indicator(s) for TCI state(s)/beam(s) switching/change according to those specified herein in the present disclosure
Information/indication(s) related to whether beam metric(s) such as L1-RSRP(s)/L1-SINR(s) associated/corresponding to resource indicator(s) for TCI state(s)/beam(s) reporting and/or TCI state(s)/beam(s) activation/deactivation and/or TCI state(s)/beam(s) switching/change as specified herein in the present disclosure is in part 2 of the beam/CSI report, and/or which one or more of the CSI fields in part 2 of the beam/CSI report to use for carrying/indicating/providing beam metric(s), if present in part 2 of the beam/CSI report, associated/corresponding to the resource indicator(s) for TCI state(s)/beam(s) reporting and/or TCI state(s)/beam(s) activation/deactivation and/or TCI state(s)/beam(s) switching/change according to those specified herein in the present disclosure
Information/indication(s) related to whether beam metric(s) such as L1-RSRP(s)/L1-SINR(s) associated/corresponding to resource indicator(s) for TCI state(s)/beam(s) reporting as specified herein in the present disclosure is in part 2 of the beam/CSI report, and/or which one or more of the CSI fields in part 2 of the beam/CSI report to use for carrying/indicating/providing beam metric(s), if present in part 2 of the beam/CSI report, associated/corresponding to the resource indicator(s) for TCI state(s)/beam(s) reporting according to those specified herein in the present disclosure
Information/indication(s) related to whether beam metric(s) such as L1-RSRP(s)/L1-SINR(s) associated/corresponding to resource indicator(s) for TCI state(s)/beam(s) activation/deactivation as specified herein in the present disclosure is in part 2 of the beam/CSI report, and/or which one or more of the CSI fields in part 2 of the beam/CSI report to use for carrying/indicating/providing beam metric(s), if present in part 2 of the beam/CSI report, associated/corresponding to the resource indicator(s) for TCI state(s)/beam(s) activation/deactivation according to those specified herein in the present disclosure
Information/indication(s) related to whether beam metric(s) such as L1-RSRP(s)/L1-SINR(s) associated/corresponding to resource indicator(s) for TCI state(s)/beam(s) switching/change as specified herein in the present disclosure is in part 2 of the beam/CSI report, and/or which one or more of the CSI fields in part 2 of the beam/CSI report to use for carrying/indicating/providing beam metric(s), if present in part 2 of the beam/CSI report, associated/corresponding to the resource indicator(s) for TCI state(s)/beam(s) switching/change according to those specified herein in the present disclosure
Information/indication(s) related to whether part 2 of the beam/CSI report is for TCI state(s) reporting and/or TCI state(s)/beam(s) activation/deactivation and/or TCI state(s)/beam(s) switching/change according to those specified herein in the present disclosure.
Information/indication(s) related to whether part 2 of the beam/CSI report comprises/contains/includes/provides/indicates resource indicator(s) for TCI state(s) reporting and/or TCI state(s)/beam(s) activation/deactivation and/or TCI state(s)/beam(s) switching/change according to those specified herein in the present disclosure

In the specified/described design examples herein, part 1 and/or part 2 of the beam/CSI report and/or UCI could be separately encoded (see FIG. 10) and reported in a single reporting instance/CSI report. Components A0, A1, A2, . . . , B0, B1 in part 1 and/or part 2 of the two-part CSI/beam report or UCI as illustrated in FIG. 10 could correspond to one or more of those specified/provided herein in the present disclosure. Furthermore, for any given two-part CSI/beam report or two-part UCI design as specified herein in the present disclosure, the payload size of part 1 of the CSI/beam report could be fixed for a given RRC configuration. The payload size of part 2 of the CSI/beam report, however, could vary, and part 1 of the two-part CSI/beam report or UCI could provide/indicate and/or the contents in part 1 of the two-part CSI/beam report or UCI could be used to indicate/identify the payload size of part 2 of the CSI/beam report.

The CSI/beam report as specified herein in the present disclosure—e.g., to provide/indicate one or more resource indicators for TCI state(s)/beam(s) reporting and/or TCI state(s)/beam(s) activation/deactivation and/or TCI state(s)/beam(s) switching/change according to those specified herein in the present disclosure—could be via a one-part UCI (e.g., part 2 is not present) or a two-part UCI (both part 1 and part 2 as specified herein in the present disclosure) depending on one or more conditions. The one or more conditions could be according to (i) fixed rule(s)/value(s) specified/provided in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further reported to the network, e.g., in/via part of a/the CSI/beam report and/or UE's capability signaling(s). Specifically:
In one example, the CSI/beam report(s) as specified herein in the present disclosure could be via a one-part UCI or a two-part UCI depending on a signaling from the NW. This signaling could be semi-static via higher layer RRC signaling (using a dedicated parameter or with a joint configuration parameter) or more dynamic via MAC CE or DCI based signaling (using a dedicated indication or with a joint indication).
In another example, as specified herein in the present disclosure, the UE (e.g., the UE 116) could provide/indicate in part 1 of the CSI/beam report whether part 2 of the CSI/beam report according to those specified herein in the present disclosure is present (i.e., a two-part UCI) or not (i.e., a one-part UCI).
In yet another example, the CSI/beam report(s) as specified herein in the present disclosure could be via a one-part UCI or a two-part UCI depending on a value N_x and a threshold x. For instance, when N_x<=x, the one-part UCI could be used for the CSI/beam report(s) as specified herein in the present disclosure-comprising/providing/indicating/containing one or more resource indicators for TCI state(s)/beam(s) reporting and/or TCI state(s)/beam(s) activation/deactivation and/or TCI state(s)/beam(s) switching/change according to those specified herein in the present disclosure. When N_x>x, the two-part UCI is used for the CSI/beam report(s) as specified herein in the present disclosure. The value of the threshold x could be according to: (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further reported to the network (e.g., the network 130), e.g., in/via part of a/the CSI/beam report and/or UE's capability signaling(s). The value N_x could be or could correspond to one or more of the following.
   The number of resource indicators and/or beam metrics (to be) reported in the CSI/beam report (e.g., in part 1 and/or part 2 of the CSI/beam report)
   The number of resource indicators and/or beam metrics (to be) reported in the CSI/beam report (e.g., in part 1 and/or part 2 of the CSI/beam report) for TCI state(s)/beam(s) reporting and/or TCI state(s)/beam(s) activation/deactivation and/or TCI state(s)/beam(s) switching/change according to those specified herein in the present disclosure
   The number of resource indicators and/or beam metrics (to be) reported in the CSI/beam report (e.g., in part 1 and/or part 2 of the CSI/beam report) for TCI state(s)/beam(s) reporting according to those specified herein in the present disclosure
   The number of resource indicators and/or beam metrics (to be) reported in the CSI/beam report (e.g., in part 1 and/or part 2 of the CSI/beam report) for TCI state(s)/beam(s) activation/deactivation according to those specified herein in the present disclosure
   The number of resource indicators and/or beam metrics (to be) reported in the CSI/beam report (e.g., in part 1 and/or part 2 of the CSI/beam report) for TCI state(s)/beam(s) switching/change according to those specified herein in the present disclosure
In yet another example, the CSI/beam report(s) as specified herein in the present disclosure—e.g., carrying/providing/indicating/comprising/containing one or more resource indicators for TCI state(s)/beam(s) reporting and/or TCI state(s)/beam(s) activation/deactivation and/or TCI state(s)/beam(s) switching/change according to those specified herein in the present disclosure-could be multiplexed with other types of CSI or beam reports, wherein whether one-part or two-part UCI is used for the CSI/beam report(s) as specified herein in the present disclosure could depend on the other CSI or beam reports. For example, the two-part UCI is used only when at least one of the other CSI or beam reports is configured with a two-part UCI.

The UL channel(s)/signaling medium(s) for carrying/providing/indicating the CSI/beam report(s)—e.g., via two-part UCI—as specified herein in the present disclosure could be or could correspond to one or more of the following.
Fixed to PUSCH(s)—e.g., configured grant (CG) PUSCH(s) (MAC CE(s))—Type-1 and/or Type-2, and/or dynamic grant (DG) PUSCH(s) (MAC CE(s))
Fixed to PUCCH(s)
Configured/configurable from PUCCH(s) to PUSCH(s), and/or configured/configurable from PUSCH(s) to PUCCH(s), wherein the PUSCH(s) could be Type-1/Type-2 CG PUSCH(s) (MAC CE(s)) and/or DG PUSCH(s) (MAC CE(s))

Furthermore, the UL channel(s)/signaling medium(s) for carrying/providing/indicating the CSI/beam report(s)—e.g., via two-part UCI—as specified herein in the present disclosure could be configured via higher layer RRC signaling, and/or triggered via a code point in DCI (UL-related or DL-related DCI). Throughout the present disclosure, a PUSCH or an UL MAC CE or a PUSCH MAC CE could be or could correspond to a Type-1/Type-2 CG PUSCH (MAC CE) or a DG PUSCH (MAC CE).

Throughout the present disclosure, a resource indicator such as SSBRI/CRI reported in a beam/CSI report for TCI state(s)/beam(s) reporting according to those specified herein in the present disclosure could also/additionally be used for TCI state(s)/beam(s) activation/deactivation/sub-selection and/or TCI state(s)/beam(s) switching/change according to those specified herein in the present disclosure, e.g., based on: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further reported to the network, e.g., via/in part of a/the CSI/beam report and/or UE's capability signaling(s). In addition, a resource indicator such as SSBRI/CRI reported in a beam/CSI report for TCI state(s)/beam(s) activation/deactivation/sub-selection according to those specified herein in the present disclosure could also/additionally be used for TCI state(s)/beam(s) reporting and/or TCI state(s)/beam(s) switching/change according to those specified herein in the present disclosure, e.g., based on: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further reported to the network, e.g., via/in part of a/the CSI/beam report and/or UE's capability signaling(s). Furthermore, a resource indicator such as SSBRI/CRI reported in a beam/CSI report for TCI state(s)/beam(s) switching/change according to those specified herein in the present disclosure could also/additionally be used for TCI state(s)/beam(s) activation/deactivation/sub-selection and/or TCI state(s)/beam(s) reporting according to those specified herein in the present disclosure, e.g., based on: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further reported to the network, e.g., via/in part of a/the CSI/beam report and/or UE's capability signaling(s).

Throughout the present disclosure, a CSI/beam report can also be referred to as or equivalent to a UE-initiated (UEI) report of (report-) type (A), (report-) type (B) and/or (report-) type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

In one embodiment, the UEI report could comprise (1) report content(s)/quantity(s) including resource indicators including SSBRI(s) and/or CRI(s) and the corresponding beam metric(s) including L1-RSRP(s)/L1-SINR(s) for current serving beam(s) only, (2) report content(s)/quantity(s) including resource indicators including SSBRI(s) and/or CSI(s) and the corresponding beam metric(s) including L1-RSRP(s)/L1-SINR(s) for candidate beam(s) only, and/or (3) report quantity(s)/content(s) including resource indicators including SSBRI(s) and/or CSI(s) and the corresponding beam metric(s) including L1-RSRP(s)/L1-SINR(s) for both current serving beam(s) and candidate beam(s).
For example, the UE could be provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, whether or not the UEI report should or could comprise (1), (2) and/or (3) as described herein; for instance, when/if a higher by layer RRC signaling/parameter denoted ‘servBeamInclusion’/enableCurrentBeamInReport is provided or configured and/or set to ‘enabled’, the UEI report could or should comprise (1) and/or (3); otherwise, the UEI report could or should comprise (2). Optionally, when/if a higher layer RRC signaling/parameter denoted by ‘servBeamInclusion’/enable CurrentBeamInReport is provided or configured or present and/or set to ‘enabled’, the UEI report could or should comprise (3); otherwise, i.e., when/if the higher layer RRC signaling/parameter denoted by ‘servBeamInclusion’/enableCurrentBeamInReport is not provided/configured/present or is absent or is provided/configured/present but set to ‘disabled’, the UEI report could or should comprise (2) and/or (3). Alternatively, when/if a higher layer RRC signaling/parameter, e.g., denoted by ueiReportContent is set to ‘servBeamOnly’, the UEI report could or should comprise (1), when/if the higher layer RRC signaling/parameter ueiReportContent is set to ‘candBeamOnly’, the UEI report could or should comprise (2), and/or when/if the higher layer RRC signaling/parameter ueiReportContent is set to ‘bothServAndCandBeam’, the UEI report could or should comprise (3). In this case, for (3), i.e., when/if the UE is configured to send a UEI report comprising report quantity(s)/content(s)—including resource indicator(s) such as SSBRI(s)/CRI(s) and/or beam metric(s) such as L1-RSRP(s)/L1-SINR(s)—for both the current serving beam(s) and the candidate beam(s), the UE could be further provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, the position(s)/ordering(s)/CSI report number(s)/CSI report index(es)/CSI report field(s) of the report content(s)/quantity(s) for the current serving beam(s) and/or the report content(s)/quantity(s) for the candidate beam(s) in the UEI report(s).
For another example, the UE could autonomously determine, select or decide whether or not the UEI report should or could comprise (1), (2) and/or (3) as described herein, and indicate to the network, e.g., in/by part of the UEI report including the PN message, their determination or selection or decision.
   In one example, the UE could send to the network a/the PN message to indicate to the network whether or not the UEI report comprises (1), (2) and/or (3) as described herein. For instance, the PN message could be or could comprise a one-bit indicator; when/if the one-bit indicator is set to ‘0’ (or ‘1’), the UEI report comprises (1) and/or (3); otherwise, the UEI report comprises (2). Alternatively, the PN message could be or could comprise a multi-bit indicator (e.g., a two-bit indicator); when/if the two-bit indicator is set to ‘00’ (‘01’, ‘10’ or ‘11’), the UEI report comprise (1), when/if the two-bit indicator is set to ‘01’ (‘00’, ‘10’ or ‘11’), the UEI report comprises (2), and/or when/if the two-bit indicator is set to ‘10’ or ‘11’ (‘00’ or ‘01’), the UEI report comprises (3).
   In another example, the PN message could be or could comprise a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
   In another example, each of the report content(s)/quantity(s) including a resource indicator such as a SSBRI/CRI or a beam metric such as a L1-RSRP/L1-SINR in a UEI report could be associated with an indicator provided in the same UEI report. In this case, the indicator could be a one-bit indicator; when/if the one-bit indicator is set to ‘0’ (or ‘1’), the resource indicator (including SSBRI and/or CRI) and/or the beam metric (including L1-RSRP and/or L1-SINR) associated/corresponding to the one-bit indicator could correspond to a current serving beam, and/or when/if the one-bit indicator is set to ‘1’ (or ‘0’), the resource indicator (including SSBRI and/or CRI) and/or the beam metric (including L1-RSRP and/or L1-SINR) associated/corresponding to the one-bit indicator could correspond to a candidate beam.
   In another example, each of the report content(s)/quantity(s) including a resource indicator such as a SSBRI/CRI or a beam metric such as a L1-RSRP/L1-SINR in a UEI report could be associated with an on/off indicator provided in the same UEI report. In this case, when/if the indicator is on or present in the UEI report or set to ‘on’, the resource indicator (including SSBRI and/or CRI) and/or the beam metric (including L1-RSRP and/or L1-SINR) associated/corresponding to the indicator could correspond to a current serving beam, and/or when/if the indicator is off or absent from the UEI report or set to ‘off’, the resource indicator (including SSBRI and/or CRI) and/or the beam metric (including L1-RSRP and/or L1-SINR) associated/corresponding to the indicator could correspond to a candidate beam.
   In another example, for (3), position(s)/ordering(s)/CSI report number(s)/CSI report index(es)/CSI report field(s) of the report content(s)/quantity(s) including resource indicator(s) such as SSBRI(s)/CRI(s) and/or beam metric(s) such as L1-RSRP(s)/L1-SINR(s) corresponding to current serving beam(s) and/or candidate beam(s) in the UEI report(s) could be fixed/predetermined/predefined. For instance, denote the number of the report content(s)/quantity(s) including resource indicator(s) such as SSBRI(s)/CRI(s) and/or beam metric(s) such as L1-RSRP(s)/L1-SINR(s) corresponding to current serving beam(s) by Nserv, the first (or last) Nserv position(s)/ordering(s)/CSI report number(s)/CSI report index(es)/CSI report field(s) in a/the UEI report could be used to carry or convey the report content(s)/quantity(s) for the current serving beam(s), and the rest of the position(s)/ordering(s)/CSI report number(s)/CSI report index(es)/CSI report field(s) in the same UEI report could be used to carry or convey the report content(s)/quantity(s) for the candidate beam(s). Alternatively, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) by Ncand, the first (or last) Ncand position(s)/ordering(s)/CSI report number(s)/CSI report index(es)/CSI report field(s) in a/the UEI report could be used to carry or convey the report content(s)/quantity(s) for the candidate beam(s), and the rest of the position(s)/ordering(s)/CSI report number(s)/CSI report index(es)/CSI report field(s) in the same UEI report could be used to carry or convey the report content(s)/quantity(s) for the serving beam(s).
   In another example, the UEI report could comprise, include, provide, contain or indicate a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
   In another example, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a first (RSRP/SINR) threshold. In this case, when/if a beam metric such as a L1-RSRP or a L1-SINR reported in the UEI report is below (or beyond) the first threshold, the report content(s)/quantity(s) including a resource indicator such as a SSBRI or a CRI associated/corresponding to the beam metric could be or could correspond to a serving beam. Optionally, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a second (RSRP/SINR) threshold. In this case, when/if a beam metric such as a L1-RSRP or a L1-SINR reported in the UEI report is beyond (or below) the second threshold, the report content(s)/quantity(s) including a resource indicator such as a SSBRI or a CRI associated/corresponding to the beam metric could be or could correspond to a candidate beam.

In one example, the UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, whether or not differential RSRP/SINR reporting is enabled for a UEI report comprising (1), (2) and/or (3) as described herein in the present disclosure. For example, when/if a higher layer parameter diffUeiReporting is provided or configured or set to ‘enabled’, the differential L1-RSRP/L1-SINR based reporting could be enabled/used, where a reference L1-RSRP/L1-SINR value could be quantized to a 7-bit value in the range [−140, −44] dBm for differential RSRP reporting/[−23, 40] dB for differential SINR reporting with 1 dB step size for differential RSRP reporting/0.5 dB step size for differential SINR reporting. The differential L1-RSRP/L1-SINR could be quantized to a 4-bit value. The differential L1-RSRP/L1-SINR value could be computed with 2 dB step size for differential RSRP reporting/1 dB step size for differential SINR reporting with a reference to the reference L1-RSRP/L1-SINR value which is part of the same UEI report or in a different but linked/associated UEI report. In this case, the reference L1-RSRP/L1-SINR value could correspond to the largest measured L1-RSRP/L1-SINR value or the largest measured L1-RSRP/SINR value of a current serving beam or the measured L1-RSRP/L1-SINR value of the serving beam. Otherwise, the differential L1-RSRP/L1-SINR based reporting could be disabled or may not be used, where the measured L1-RSRP/L1-SINR value(s) could be quantized to a 7-bit value in the range [−140, −44] dBm with 1 dB step size.

In one example, whether or not differential RSRP/SINR reporting is enabled for a UEI report comprising (1), (2) and/or (3) as described herein in the present disclosure could depend on the number of report content(s)/quantity(s)—including resource indicator(s) such as SSBRI(s)/CRI(s) and/or beam metric(s) such as L1-RSRP(s)/L1-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s). For example, when/if the number of report content(s)/quantity(s)—including resource indicator(s) such as SSBRI(s)/CRI(s) and/or beam metric(s) such as L1-RSRP(s)/L1-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s), is greater than or equal to 1, the differential L1-RSRP/L1-SINR based reporting could be enabled/used, where a reference L1-RSRP/L1-SINR value could be quantized to a 7-bit value in the range [−140, −44] dBm with 1 dB step size. The differential L1-RSRP/L1-SINR could be quantized to a 4-bit value. The differential L1-RSRP/L1-SINR value could be computed with 2 dB step size with a reference to the reference L1-RSRP/L1-SINR value which is part of the same UEI report or in a different but linked/associated UEI report. In this case, the reference L1-RSRP/L1-SINR value could correspond to the largest measured L1-RSRP/L1-SINR value or the largest measured L1-RSRP/SINR value of a current serving beam or the measured L1-RSRP/L1-SINR value of the serving beam in the same/current UEI report or a different UEI report associated/linked to the current UEI report, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals. Otherwise, the differential L1-RSRP/L1-SINR based reporting could be disabled or may not be used, where the measured L1-RSRP/L1-SINR value(s) could be quantized to a 7-bit value in the range [−140, −44] dBm with 1 dB step size. The UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, the number of report content(s)/quantity(s)—including resource indicator(s) such as SSBRI(s)/CRI(s) and/or beam metric(s) such as L1-RSRP(s)/L1-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s); alternatively, the UE could autonomous determine the number of report content(s)/quantity(s)—including resource indicator(s) such as SSBRI(s)/CRI(s) and/or beam metric(s) such as L1-RSRP(s)/L1-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s), and report their determined number(s)—e.g., by/in part of the UEI report and/or via the PN message—to the network.

In one example, for (1), i.e., when/if a UEI report could only comprise report content(s)/quantity(s) including resource indicator(s) such as SSBRI(s)/CRI(s) and beam metric(s) such as L1-RSRP(s)/L1-SINR(s) for the current serving beam(s), and/or when/if the differential RSRP/SINR based reporting is enabled/used according to those specified herein in the present disclosure, the reference L1-RSRP/L1-SINR value could correspond to one or more of the following, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a candidate beam in a different/previous/earlier UEI report
the measured L1-RSRP/L1-SINR value of the candidate beam in a different/previous/earlier UEI report
   where the different/previous/earlier UEI report could be the last UEI report sent prior to the current UEI report, or alternatively, the different/previous/earlier UEI report and the current UEI report could be associated/linked to each other, e.g., when/if a same value of an indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the current serving beam(s) and the first threshold as specified herein in the present disclosure. For instance, if a measured L1-RSRP/L1-SINR value for a current serving beam is x dBm, and the first threshold is y dBm, the difference delta_serv=|x−y| dBm could be reported in the UEI report as a report content/quantity, and a corresponding one-bit sign indicator indicating either positive or negative of the difference could also be reported in the same UEI report. The value of delta_serv in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s), if reported, and a third threshold. For instance, if a differential L1-RSRP/L1-SINR value is x dBm, and the third threshold is y dBm, the difference delta_diff=|x−y| dBm could be reported in the UEI report as a report content/quantity, and a corresponding one-bit sign indicator indicating either positive or negative of the difference could also be reported in the same UEI report. The value of delta_diff in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. A UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, the third (RSRP/SINR) threshold.

In another example, for (2), i.e., when/if a UEI report could only comprise report content(s)/quantity(s) including resource indicator(s) such as SSBRI(s)/CRI(s) and beam metric(s) such as L1-RSRP(s)/L1-SINR(s) for the candidate beam(s), and/or when/if the differential RSRP/SINR based reporting is enabled/used according to those specified herein in the present disclosure, the reference L1-RSRP/L1-SINR value could correspond to one or more of the following, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a serving beam in a different/previous/earlier UEI report
the measured L1-RSRP/L1-SINR value of the serving beam in a different/previous/earlier UEI report
   where the different/previous/earlier UEI report could be the last UEI report sent prior to the current UEI report, or alternatively, the different/previous/earlier UEI report and the current UEI report could be associated/linked to each other, e.g., when/if a same value of indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the candidate beam(s) and the second threshold as specified herein in the present disclosure. For instance, if a measured L1-RSRP/L1-SINR value for a candidate beam is x′ dBm, and the second threshold is y′ dBm, the difference delta_cand=|x′−y′| dBm could be reported in the UEI report as a report content/quantity, and a corresponding one-bit sign indicator indicating either positive or negative of the difference could also be reported in the same UEI report. The value of delta_cand in the UEI report could be quantized to a A′-bit value in the range [B′, C′] dBm with D′dB step size, wherein the value(s) of A′, B′, C′ and/or D′ in this example could be fixed in system specifications (similar to those specified for the differential RSRP/SINR reporting) and/or configured/provided by the network (e.g., the network 130), e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s), if reported, and a fourth threshold. For instance, if a differential L1-RSRP/L1-SINR value is x′ dBm, and the fourth threshold is y′ dBm, the difference delta_diff′=|x′−y′| dBm could be reported in the UEI report as a report content/quantity, and a corresponding one-bit sign indicator indicating either positive or negative of the difference could also be reported in the same UEI report. The value of delta_diff′ in the UEI report could be quantized to a A′-bit value in the range [B′, C′] dBm with D′dB step size, wherein the value(s) of A′, B′, C′ and/or D′ in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. A UE (e.g., the UE 116) could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, the fourth (RSRP/SINR) threshold.

In another example, for (3), i.e., when/if a UEI report could comprise report content(s)/quantity(s) including resource indicator(s) such as SSBRI(s)/CRI(s) and beam metric(s) such as L1-RSRP(s)/L1-SINR(s) for the current serving beam(s) and report content(s)/quantity(s) including resource indicator(s) such as SSBRI(s)/CRI(s) and beam metric(s) such as L1-RSRP(s)/L1-SINR(s) for the candidate beam(s), and/or when/if the differential RSRP/SINR based reporting is enabled/used, e.g., for the serving beam(s) in the current UEI report, according to those specified herein in the present disclosure, the reference L1-RSRP/L1-SINR value for the current serving beam(s) in the current UEI report could correspond to one or more of the following, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a candidate beam in a different/previous/earlier UEI report
the measured L1-RSRP/L1-SINR value of the candidate beam in a different/previous/earlier UEI report
the largest measured L1-RSRP/L1-SINR value of a candidate beam in the same/current UEI report
the measured L1-RSRP/L1-SINR value of the candidate beam in the same/current UEI report
   where the different/previous/earlier UEI report could be the last UEI report sent prior to the current UEI report. Alternatively, the different/previous/earlier UEI report and the current UEI report could be associated/linked to each other, e.g., when/if a same value of an indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the current serving beam(s) and the first threshold as specified herein in the present disclosure. For instance, if a measured L1-RSRP/L1-SINR value for a current serving beam is x dBm, and the first threshold is y dBm, the difference delta_serv=|x−y| dBm could be reported in the UEI report as a report content/quantity, and a corresponding one-bit sign indicator indicating either positive or negative of the difference could also be reported in the same UEI report. The value of delta_serv in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s) computed with respect to or regarding or for the current serving beam(s), if reported, and the third threshold as specified/described herein in the present disclosure. For instance, if a differential L1-RSRP/L1-SINR value computed with respect to or regarding or for a current serving beam is x dBm, and the third threshold is y dBm, the difference delta_diff=|x−y| dBm could be reported in the UEI report as a report content/quantity, and a corresponding one-bit sign indicator indicating either positive or negative of the difference could also be reported in the same UEI report. The value of delta_diff in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. In addition, when/if the differential RSRP/SINR based reporting, e.g., for the candidate beam(s) in the current UEI report, is enabled/used according to those specified herein in the present disclosure, the reference L1-RSRP/L1-SINR value for the candidate beam(s) in the current UEI report could correspond to one or more of the following, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a serving beam in a different/previous/earlier UEI report
the measured L1-RSRP/L1-SINR value of the serving beam in a different/previous/earlier UEI report
the largest measured L1-RSRP/L1-SINR value of a serving beam in the same/current UEI report
the measured L1-RSRP/L1-SINR value of the serving beam in the same/current UEI report
   where the different/previous/earlier UEI report could be the last UEI report sent prior to the current UEI report. Alternatively, the different/previous/earlier UEI report and the current UEI report could be associated/linked to each other, e.g., when/if a same value of indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the candidate beam(s) and the second threshold as specified herein in the present disclosure. For instance, if a measured L1-RSRP/L1-SINR value for a candidate beam is x′ dBm, and the second threshold is y′ dBm, the difference delta_cand=|x′−y′| dBm could be reported in the UEI report as a report content/quantity, and a corresponding one-bit sign indicator indicating either positive or negative of the difference could also be reported in the same UEI report. The value of delta_cand in the UEI report could be quantized to a A′-bit value in the range [B′, C′] dBm with D′dB step size, wherein the value(s) of A′, B′, C′ and/or D′ in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s) computed with respect to or regarding or for a candidate beam, if reported, and the fourth threshold. For instance, if a differential L1-RSRP/L1-SINR value computed with respect to or regarding or for a candidate beam is x′ dBm, and the fourth threshold is y′ dBm, the difference delta_diff′=|x′−y′| dBm could be reported in the UEI report as a report content/quantity, and a corresponding one-bit sign indicator indicating either positive or negative of the difference could also be reported in the same UEI report. The value of delta_diff′ in the UEI report could be quantized to a A′-bit value in the range [B′, C′] dBm with D′dB step size, wherein the value(s) of A′, B′, C′ and/or D′ in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling.

Furthermore, the resource indicator(s) including SSBRI(s) and/or CRI(s) for the current serving beam(s) and the resource indicator(s) including SSBRI(s) and/or CRI(s) for the candidate beam(s), reported in the same UEI report or in different/separate UEI reports, could be determined/selected from the same RS resource set (e.g., the same SSB resource set or the same NZP CSI-RS resource set). Alternatively, the resource indicator(s) including SSBRI(s) and/or CRI(s) for the current serving beam(s) could be determined/selected from a first RS resource set (e.g., a first SSB resource set or a first NZP CSI-RS resource set) configured for reporting the serving beam(s), and the resource indicator(s) including SSBRI(s) and/or CRI(s) for the candidate beam(s), could be determined/selected from a second RS resource set (e.g., a second SSB resource set or a second NZP CSI-RS resource set) configured for reporting the candidate beam(s), wherein the resource indicators for the serving beam(s) and the candidate beam(s) could be reported in the same UEI report or in different/separate UEI reports, and the first and second RS resource sets could be the same/identical or different. If the first and second RS resource sets are different, (1) in one example, the bitwidth of the RS indexes in the first RS resource set is computed with respect to the total number K of RS resources configured in the first set, i.e., log 2(K) or floor (log 2(K)) or ceil (log 2(K)) bit(s), and the bitwidth of the RS indexes in the second RS resource set is computed with respect to the total number L of RS resources configured in the second set, i.e., log 2(L) or floor (log 2(L)) or ceil (log 2(L)) bit(s), and/or (2) in another example, the bitwidth of the RS indexes in the first RS resource set is computed with respect to the total number (K+L) of RS resources configured in both the first and second sets, i.e., log 2(K+L) or floor (log 2(K+L)) or ceil (log 2(K+L)) bit(s), and the bitwidth of the RS indexes in the second RS resource set is computed with respect to the total number (K+L) of RS resources configured in both the first and second sets, i.e., log 2(K+L) or floor (log 2(K+L)) or ceil (log 2(K+L)) bit(s).

Throughout the present disclosure, a current serving beam can also be referred to as/represented by a current serving beam RS or RS resource or RS resource configuration or RS resource index or RS resource configuration index; or, a current serving beam can be referred to as/represented by a RS or RS resource or RS resource configuration or RS resource index or RS resource configuration index of/for a current serving beam. Furthermore, a candidate beam could also be referred to as/represented by a candidate/new beam RS or RS resource or RS resource configuration or RS resource index or RS resource configuration index; or, a candidate beam can be referred to as/represented by a RS or RS resource or RS resource configuration or RS resource index or RS resource configuration index of/for a candidate/new beam.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or all of dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

The RS(s) or RS resource(s) or RS resource index(es) of/for a current serving beam-denoted by current serving beam RS(s) or RS resource(s) or RS resource index(es)—could be identified or determined according to one or more of:
(implicit determination example-1): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example—2): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example—1): a set s̅₀ of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of (periodic) CSI-RS resource configuration indexes could be provided in higher layer parameter(s) CSI-ReportConfig, CSI-ResourceConfig, nzp-CSI-RS-ResourceSet and/or higher layer parameter(s) UEI-ReportConfig, UEI-ResourceConfig and/or etc. dedicated/configured for the UEI reporting as specified herein in the present disclosure.
(explicit configuration example—2): a set s̅₀ of SS/PBCH block indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure.

In one example, when/if the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to ‘on’), the UE could follow those specified in the implicit determination example—1 in the present disclosure to determine or identify the current serving beam RS(s)/RS resource(s)/RS resource index(es). In another example, when/if the one or more RSs/RS resources/RS resource indexes provided in/by the indicated TCI state (e.g., of QCL-TypeD) correspond to CSI-RS(s) for tracking or tracking reference signal(s)—e.g., CSI-RS(s) configured with trs-Info, the UE may not follow those specified in the implicit determination example—1 in the present disclosure to determine or identify the current serving beam RS(s)/RS resource(s)/RS resource index(es), but instead, the UE could expect to be provided or configured or indicated by the network a/the set s̅₀ of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the explicit configuration example—1 in the present disclosure. Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/L1-SINR(s), of all the RS(s) or RS resource(s) or RS resource index(es) determined (e.g., following those specified/described in the implicit determination example—1 and/or the implicit determination example—2 in the present disclosure) and/or configured (e.g., following those specified/described in the explicit configuration example—1 and/or the explicit configuration example—2 in the present disclosure) for the current serving beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example—1 and/or the implicit determination example—2 in the present disclosure) and/or configured (e.g., following those specified/described in the explicit configuration example—1 and/or the explicit configuration example—2 in the present disclosure) for the current serving beam(s) in the UEI/event-driven beam reporting according to (or that has the same RS(s) or RS resource(s) or RS resource index(es) as to)
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

The RS(s) or RS resource(s) or RS resource index(es) of/for a candidate/new beam—denoted by candidate/new beam RS(s) or RS resource(s) or RS resource index(es)—could be identified or determined according to one or more of:
(explicit configuration example-A): a set s̅₁ of (periodic) CSI-RS resource configuration indexes provided by CandidateBeamRSList or newBeamResourceSet (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes could be provided in higher layer parameter(s) CSI-ReportConfig, CSI-ResourceConfig, nzp-CSI-RS-ResourceSet, and/or higher layer parameter(s) UEI-ReportConfig, UEI-ResourceConfig and/or etc. dedicated/configured for the UEI reporting as specified herein in the present disclosure, and/or higher layer parameter(s) CSI-ResourceConfig and/or nzp-CSI-RS-ResourceSet and/or higher layer parameter(s) UEI-ResourceConfig associated to the higher layer parameter(s) CSI-ReportConfig and/or UEI-ReportConfig configured/provided for the UE-initiated beam reporting.
(explicit configuration example-B): a set s̅₁ of SS/PBCH block indexes provided by Candidate BeamRSList or newBeamResourceSet (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure, and/or higher layer parameter(s) CSI-ResourceConfig and/or CSI-SSB-ResourceSet and/or higher layer parameter(s) UEI-ResourceConfig associated to the higher layer parameter(s) CSI-ReportConfig and/or UEI-ReportConfig configured/provided for the UE-initiated beam reporting.
(implicit determination example-A): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-B): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(implicit determination exampleC): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination exampleD): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In one example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to ‘on’), the UE could follow those specified in the implicit determination example-A/C in the present disclosure to determine or identify the candidate/actual candidate/new beam RS(s)/RS resource(s)/RS resource index(es). In another example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking reference signal(s)—e.g., CSI-RS(s) configured with trs-Info, the UE may not follow those specified in the implicit determination example-A/C in the present disclosure to determine or identify the candidate/actual candidate/new beam RS(s)/RS resource(s)/RS resource index(es), but instead, the UE could expect to be provided or configured or indicated by the network a/the set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the explicit configuration example-A in the present disclosure.

Furthermore, the PN transmission or configuration of the PN transmission or the PN as specified herein in the present disclosure could be similarly configured as a PRACH preamble as in Msg-1 (in the 4-step RACH) or in Msg-A (in the 2-step RACH), and the actual UEI report content(s)/quantity(s) as specified herein in the present disclosure can be sent via the corresponding dedicated PUSCH resource(s)—i.e., Msg-A PUSCH resource(s).

FIG. 11 illustrates an example method 1100 performed by a UE in a wireless communication system according to embodiments of the present disclosure. The method 1100 of FIG. 11 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

The method 1100 begins with the UE receiving first information related to inclusion in a report of at least one first report quantity associated with a first RS resource (1110). For example, in 1110, the UE receives a TCI state, and the first RS resource corresponds to a CSI-RS resource indicated in the TCI state and/or a SSB quasi-co-located with the CSI-RS resource indicated in the TCI state.

The UE then receives second information related to at least one second RS resource (1120). For example, in 1120, each of the at least one second RS resource corresponds to a CSI-RS resource and a SSB. The second information provides at least a number of the at least one second RS resource and at least one identifier (ID) of the at least one second RS resource, respectively. The second information is associated with a CSI reporting setting provided for UE-initiated beam reporting.

The UE then determines the at least one first report quantity based on the first RS resource (1130). The UE further determines at least one second report quantity based on the at least one second RS resource (1140). For example, the at least one first report quantity or the at least one second report quantity corresponds to at least one of a CRI, a SSBRI, an absolute or differential L1-RSRP, and an absolute or differential L1-SINR.

The UE then determines the report based on the first information and the at least one second report quantity (1150). For example, in 1150, the report includes at least one of the at least one second report quantity. In various embodiments, the first information includes a higher layer parameter enable CurrentBeamInReport and when enableCurrentBeamInReport is present or set to ‘enabled’, the report includes the at least one first report quantity. In various embodiments, the first information comprises a higher layer parameter enable CurrentBeamInReport, and when enable CurrentBeamInReport is absent or set to ‘disabled’, the UE determines whether to include the at least one first report quantity in the report. For example, when the report includes the at least one first report quantity, the report further includes at least one indicator associated with the at least one first report quantity, respectively, and when an indicator is present or set to ‘1’ in the report, a report quantity associated with the indicator corresponds to one of the at least one first report quantity. The UE then transmits the report (1160).

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information related to inclusion in a report of at least one first report quantity associated with a first reference signal (RS) resource, and
receive second information related to at least one second RS resource; and
a processor operably coupled with the transceiver, the processor configured to:
determine, based on the first RS resource, the at least one first report quantity,
determine, based on the at least one second RS resource, at least one second report quantity, and
determine, based on (i) the first information and (ii) the at least one second report quantity, the report,
wherein the transceiver is further configured to transmit the report.

2. The UE of claim 1, wherein the report includes at least one of the at least one second report quantity.

3. The UE of claim 1, wherein:
the first information includes a higher layer parameter enable CurrentBeamInReport, and
when enableCurrentBeamInReport is present or set to ‘enabled’, the report includes the at least one first report quantity.

4. The UE of claim 1, wherein:
the first information comprises a higher layer parameter enableCurrentBeamInReport, and
when enableCurrentBeamInReport is absent or set to ‘disabled’, the processor is further configured to determine whether to include the at least one first report quantity in the report.

5. The UE of claim 4, wherein:
when the report includes the at least one first report quantity, the report further includes at least one indicator associated with the at least one first report quantity, respectively, and
when an indicator is present or set to ‘1’ in the report, a report quantity associated with the indicator corresponds to one of the at least one first report quantity.

6. The UE of claim 1, wherein:
the transceiver is further configured to receive a transmission configuration indication (TCI) state, and
the first RS resource corresponds to at least one of:
a channel state information RS (CSI-RS) resource indicated in the TCI state, and
a synchronization signal/physical broadcast channel block (SSB) quasi-co-located with the CSI-RS resource indicated in the TCI state.

7. The UE of claim 1, wherein:
each of the at least one second RS resource corresponds to one or more of:
a channel state information RS (CSI-RS) resource, and
a synchronization signal/physical broadcast channel block (SSB),
the second information provides at least (i) a number of the at least one second RS resource and (ii) at least one identifier (ID) of the at least one second RS resource, respectively, and
the second information is associated with a CSI reporting setting provided for UE-initiated beam reporting.

8. The UE of claim 1, wherein the at least one first report quantity or the at least one second report quantity corresponds to at least one of:
a channel state information reference signal resource indicator (CRI),
a synchronization signal/physical broadcast channel resource indicator (SSBRI),
an absolute or differential layer-1 reference signal receive power (L1-RSRP), and
an absolute or differential L1 signal to interference and noise ratio (L1-SINR).

9. A base station (BS), comprising:
a processor; and
a transceiver operably coupled with the processor, the transceiver configured to:
transmit first information related to inclusion in a report of at least one first report quantity associated with a first reference signal (RS) resource, and
transmit second information related to at least one second RS resource, and
receive the report that is based on (i) the first information and (ii) at least one second report quantity associated with the at least one second RS resource.

10. The BS of claim 9, wherein the report includes at least one of the at least one second report quantity.

11. The BS of claim 9, wherein:
the first information includes a higher layer parameter enable CurrentBeamInReport, and
when enableCurrentBeamInReport is present or set to ‘enabled’, the report includes the at least one first report quantity.

12. The BS of claim 9, wherein:
the first information comprises a higher layer parameter enableCurrentBeamInReport, and
when enableCurrentBeamInReport is absent or set to ‘disabled’, whether the at least one first report quantity is included in the report is based on a user equipment determination.

13. The BS of claim 12, wherein:
when the report includes the at least one first report quantity, the report further includes at least one indicator associated with the at least one first report quantity, respectively, and
when an indicator is present or set to ‘1’ in the report, a report quantity associated with the indicator corresponds to one of the at least one first report quantity.

14. The BS of claim 9, wherein:
the transceiver is further configured to transmit a transmission configuration indication (TCI) state, and
the first RS resource corresponds to at least one of:
a channel state information RS (CSI-RS) resource indicated in the TCI state, and
a synchronization signal/physical broadcast channel block (SSB) quasi-co-located with the CSI-RS resource indicated in the TCI state.

15. The BS of claim 9, wherein:
each of the at least one second RS resource corresponds to one or more of:
a channel state information RS (CSI-RS) resource, and
a synchronization signal/physical broadcast channel block (SSB),
the second information provides at least (i) a number of the at least one second RS resource and (ii) at least one identifier (ID) of the at least one second RS resource, respectively, and
the second information is associated with a CSI reporting setting provided for user equipment-initiated beam reporting.

16. The BS of claim 9, wherein the at least one first report quantity or the at least one second report quantity corresponds to at least one of:
a channel state information reference signal resource indicator (CRI),
a synchronization signal/physical broadcast channel resource indicator (SSBRI),
an absolute or differential layer-1 reference signal receive power (L1-RSRP), and
an absolute or differential L1 signal to interference and noise ratio (L1-SINR).

17. A method performed by a user equipment (UE) is provided, the method comprises:
receiving first information related to inclusion in a report of at least one first report quantity associated with a first reference signal (RS) resource;
receiving second information related to at least one second RS resource;
determining, based on the first RS resource, the at least one first report quantity;
determining, based on the at least one second RS resource, at least one second report quantity;
determining, based on (i) the first information and (ii) the at least one second report quantity, the report; and
transmitting the report.

18. The method of claim 17, wherein the report includes at least one of the at least one second report quantity.

19. The method of claim 17, wherein:
the first information includes a higher layer parameter enable CurrentBeamInReport, and
when enableCurrentBeamInReport is present or set to ‘enabled’, the report includes the at least one first report quantity.

20. The method of claim 17, wherein:
the first information comprises a higher layer parameter enableCurrentBeamInReport, and
the method further comprises, when enable CurrentBeamInReport is absent or set to ‘disabled’, determining whether to include the at least one first report quantity in the report.
